(19) United States
(12) Patent Application Publication
(10) Pub. No.: US 2025/0177868 A1
(43) Pub. Date: Jun. 5, 2025

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Daisuke Sato, Tokyo (JP); Ryohei Matsui, Tokyo (JP); Masayuki Nagata, Tokyo (JP); Seishi Kawasaki, Tokyo (JP); Yuki Sugiura, Tokyo (JP); Kazuhiro Oura, Tokyo (JP); Tatsuki Tsuchiya, Tokyo (JP)

(73) Assignee: CYGAMES, INC., Tokyo (JP)

(21) Appl. No.: 19/050,721

(22) Filed: Feb. 11, 2025

Related U.S. Application Data
(63) Continuation of application No. PCT/JP2023/027240, filed on Jul. 25, 2023.

(30) Foreign Application Priority Data
Aug. 12, 2022 (JP) 2022-129118
Aug. 12, 2022 (JP) 2022-129119

(51) Int. Cl. A63F 13/67

(52) U.S. Cl. CPC A63F 13/67

(57) ABSTRACT

A non-transitory computer readable medium stores a program causing a computer to execute processing of setting, formation information relating to specific content that includes one or more game media, requires setting of the formation information including a predetermined parameter that is calculated based on the one or more game media and that satisfies a minimum condition, and increases in degree of advantage the more the predetermined parameter exceeds the minimum condition; processing of progressing the specific content based on the set formation information; and processing of generating the formation information based on an automatic formation function selected from among a first automatic formation function that prioritizes satisfying the minimum condition by a minimum amount and a second automatic formation function that prioritizes satisfying the minimum condition and increasing the degree of advantage, the first automatic formation function and the second automatic formation function automatically generating the formation information.

### CROSS REFERENCE TO RELATED APPLICATIONS

This application is a continuation application of International Application No. PCT/JP2023/027240, filed on Jul. 25, 2023, which claims priority to Japanese Patent Application No. 2022-129118, filed on Aug. 12, 2022, and Japanese Patent Application No. 2022-129119, filed on Aug. 12, 2022, the entire contents of which are incorporated by reference herein.

### BACKGROUND ART

### Technical Field

The present invention relates to an information processing program, an information processing method, and an information processing system.

As described in Patent Document 1, for example, a game of the genre referred to as idle game has been proposed. In idle games, after a player issues an instruction to execute the game, the game automatically progresses, and when a predetermined period elapses, the user is notified of a result of the automatic progress.

### CITATION LIST

### Patent Literature

Patent Document 1: JP 6748838 B

### SUMMARY OF INVENTION

### Technical Problem

In general, enhancing player-friendliness for the player involved in the game tends to motivate the player to play the game.

An object of the present invention is to provide an information processing program, and information processing method, and an information processing system that can motivate the player to play the game by enhancing player-friendliness.

### Solution to Problem

To solve the problems described above, provided is an information processing program for causing a computer to execute:
processing of setting, based on a player operation, formation information relating to specific content that includes one or more game media, requires setting of the formation information with a predetermined parameter, calculated based on the one or more game media, that satisfies a minimum condition, and increases in degree of advantage the more the predetermined parameter exceeds the minimum condition;
processing of progressing the specific content based on the set formation information; and
processing of generating the formation information based on an automatic formation function selected by a player from among a first automatic formation function that prioritizes satisfying the minimum condition by a minimum amount and a second automatic formation function that prioritizes satisfying the minimum condition and increasing the degree of advantage, the first automatic formation function and the second automatic formation function automatically generating the formation information.

In the processing of progressing the specific content, the specific content may be progressed without requiring a player operation or activation of a game for game progress.

The computer may be further caused to execute processing of allowing progress of the specific content in a case where the set formation information satisfies the minimum condition and processing of not allowing progress of the specific content in a case where the set formation information does not satisfy the minimum condition.

In the processing of progressing the specific content, an amount of time until progress of the specific content ends may be reduced in accordance with a degree of the predetermined parameter exceeding the minimum condition.

To solve the problems described above, provided is an information processing method executed by one or more computers, the information processing method including:
processing, by the one or more computers, of setting, based on a player operation, formation information relating to specific content that includes one or more game media, requires setting of the formation information with a predetermined parameter, calculated based on the one or more game media, that satisfies a minimum condition, and increases in degree of advantage the more the predetermined parameter exceeds the minimum condition;
processing, by the one or more computers, of progressing the specific content based on the set formation information; and
processing, by the one or more computers, of generating the formation information based on an automatic formation function selected by a player from among a first automatic formation function that prioritizes satisfying the minimum condition by a minimum amount and a second automatic formation function that prioritizes satisfying the minimum condition and increasing the degree of advantage, the first automatic formation function and the second automatic formation function automatically generating the formation information.

To solve the problems described above, provided is an information processing system including:
one or more computers, wherein
the one or more computers execute:
processing of setting, based on a player operation, formation information relating to specific content that includes one or more game media, requires setting of the formation information with a predetermined parameter, calculated based on the one or more game media, that satisfies a minimum condition, and increases in degree of advantage the more the predetermined parameter exceeds the minimum condition;
processing of progressing the specific content based on the set formation information; and
processing of generating the formation information based on an automatic formation function selected by a player from among a first automatic formation function that prioritizes satisfying the minimum condition by a minimum amount and a second automatic formation function that prioritizes satisfying the minimum condition and increasing the degree of advantage, the first automatic formation function and the second automatic formation function automatically generating the formation information.

### Effects of Disclosure

According to the present invention, a player can be motivated to play the game by enhancing player-friendliness.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an ally character confirmation screen.

FIG. 4A is a diagram for describing an example of a story screen. FIG. 4B is a diagram for describing an example of a quest screen.

FIG. 5A is a diagram for describing an example of a main quest screen. FIG. 5B is a diagram for describing an example of a main quest selection screen. FIG. 5C is a diagram for describing an example of a party selection screen.

FIG. 6A is a diagram for describing an example of a battle game screen. FIG. 6B is a diagram for describing an example of a first result screen. FIG. 6C is a diagram for describing an example of a second result screen.

FIG. 7A is a diagram for describing an example of an expedition top screen. FIG. 7B is a diagram for describing an example of a dispatch destination selection screen.

FIG. 8A is a diagram for describing an example of a menu screen. FIG. 8B is a first diagram for describing an example of a notification setting screen. FIG. 8C is a second diagram for describing an example of the notification setting screen.

FIG. 9A is a diagram for describing an example of an expedition completion notification. FIG. 9B is a first diagram for describing an example of a priority setting screen. FIG. 9C is a second diagram for describing an example of the priority setting screen.

FIG. 10A is a first diagram for describing an example of a first change priority screen. FIG. 10B is a first diagram for describing an example of a second change priority screen.

FIG. 11A is a second diagram for describing an example of the second change priority screen. FIG. 11B is a second diagram for describing an example of the first change priority screen.

FIG. 12A is a first diagram for describing an example of an automatic formation setting screen. FIG. 12B is a second diagram for describing an example of the automatic formation setting screen.

FIG. 13A is a first diagram for describing an example of a formation screen. FIG. 13B is a second diagram for describing an example of the formation screen. FIG. 13C is a third diagram for describing an example of the formation screen.

FIG. 14A is a diagram for describing an example of the formation screen when a first automatic formation function is used. FIG. 14B is a diagram for describing an example of the formation screen when a second automatic formation function is used.

FIG. 15A is a fourth diagram for describing an example of the formation screen. FIG. 15B is a first diagram for describing an example of a time reduction screen. FIG. 15C is a fifth diagram for describing an example of the formation screen.

FIG. 16A is a diagram for describing an example of a confirmation screen. FIG. 16B is a diagram for describing an example of an expedition start animation screen. FIG. 16C is a first diagram for describing an example of a time reduction animation screen.

FIG. 17A is a diagram for describing an example of the dispatch destination selection screen during execution of an expedition game. FIG. 17B is a diagram for describing an example of the time reduction screen during execution of the expedition game.

FIG. 18A is a diagram for describing an example of a confirmation screen for a player to confirm use of a reduction function during execution of the expedition game.

FIG. 18B is a diagram for describing an example of the dispatch destination selection screen in a case where the reduction function is used during execution of the expedition game.

FIG. 19A is a diagram for describing an example of a withdraw confirmation screen. FIG. 19B is a diagram for describing an example of an expedition withdraw screen.

FIG. 20A is a diagram for describing an example of the dispatch destination selection screen when an expedition is completed. FIG. 20B is a diagram for describing an example of an expedition completion screen.

FIG. 21 is a diagram for describing an example of a redispatch screen.

FIG. 22A is a diagram for describing an example of the expedition top screen when an expedition is completed. FIG. 22B is a diagram for describing an example of an expedition collective completion screen.

FIG. 23 is a diagram for describing an example of a redispatch screen.

FIG. 24A is a first diagram for describing an example of a batch expedition screen. FIG. 24B is a second diagram for describing an example of the batch expedition screen.

FIG. 25 is a diagram for describing an example of a batch expedition confirmation screen.

FIG. 26 is a diagram for describing a configuration of a memory in the player terminal and a function thereof as a computer.

FIG. 27 is a diagram for describing a configuration of a memory in the server and a function thereof as a computer.

FIG. 28 is a sequence diagram for describing basic processing of the player terminal and the server.

FIG. 29 is a first flowchart for describing setting processing in the player terminal.

FIG. 30 is a second flowchart for describing the setting processing in the player terminal.

FIG. 31 is a first flowchart for describing individual dispatch processing in the player terminal.

FIG. 32 is a second flowchart for describing the individual dispatch processing in the player terminal.

FIG. 33 is a third flowchart for describing the individual dispatch processing in the player terminal.

FIG. 34 is a flowchart for describing redispatch processing in the player terminal.

FIG. 35 is a first flowchart for describing batch expedition processing in the player terminal.

FIG. 36 is a second flowchart for describing the batch expedition processing in the player terminal.

FIG. 37 is a third flowchart for describing the batch expedition processing in the player terminal.

FIG. 38 is a flowchart for describing withdraw processing in the player terminal.

FIG. 39 is a flowchart for describing post-expedition-start time reduction processing in the player terminal.

FIG. 40 is a flowchart for describing expedition game progress processing in the server.

FIG. 41 is a flowchart for describing reward management processing in the server.

FIG. 42 is a flowchart for describing expedition completion processing in the player terminal.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In the present description and the drawings, elements having substantially the same function and configuration are denoted by the same reference numerals, and redundant description thereof will be omitted, and elements not directly relating to the present invention will not be illustrated.

### Overall Configuration of Information Processing System S

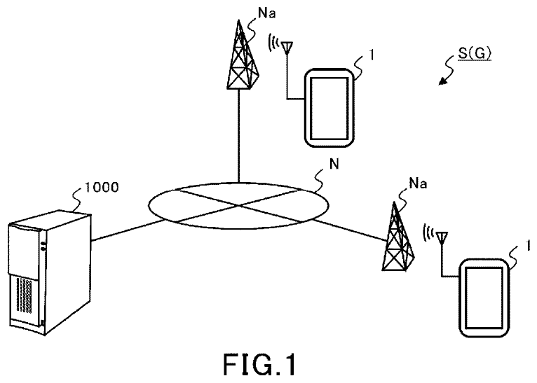

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of a game, and the game can progress via cooperation between the player terminal 1 and the server 1000.

The player terminal 1 can establish communication with the server 1000 via the communication network N. The player terminal 1 widely includes an electronic device capable of establishing a wireless or wired communication connection with the server 1000. Examples of the player terminal 1 include a smartphone, a mobile phone, a tablet device, a personal computer, and a game console, and the like. In the present embodiment, a case where a smartphone is used as the player terminal 1 will be described.

The server 1000 is communicatively connected to a plurality of the player terminals 1. The server 1000 accumulates various types of information for each player who plays the game. In addition, the server 1000 performs processing such as updating the accumulated information and downloading images and various types of information to the player terminal 1 based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and realizes a wireless or wired communication connection between the player terminal 1 and the server 1000.

### Hardware Configuration of Player Terminal 1 and Server 1000

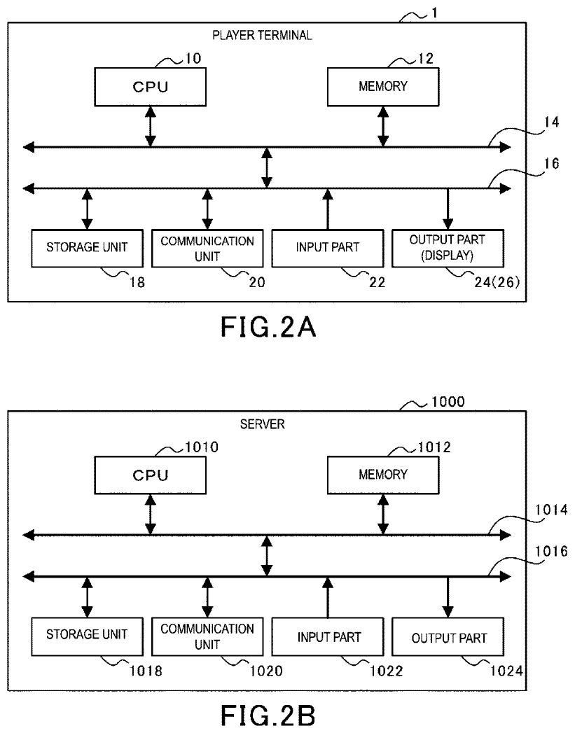

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various types of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various types of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various types of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects speech from the player. That is, the input part 22 widely includes apparatuses capable of input that can identify the intention of the player.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Game Content

Next, content of a game provided by the information processing system S (game apparatus G) of the present embodiment will be described using an example. In the present embodiment, a so-called battle game is provided in which one or more ally characters form a party and fight against an enemy character. Further, in the present embodiment, separate from the battle game described above, a game of the genre referred to as an idle game is provided in which one or more ally characters in a party are dispatched (in the present embodiment, referred to as an “expedition game”). In the game of the present embodiment, a plurality of ally characters are provided from the management side of the game to the player. For example, the player can own a plurality of ally characters obtained through a lottery called a gacha or distributed from the management side.

In the battle game, the player can select one or more ally characters owned by the player to form a party. The player can play the battle game using the formed party. The object of the battle game is for the ally characters in the party to obtain rewards by defeating (clearing) enemy characters. Various types of battle games with different enemy characters and different difficulty levels can be played by the player.

In addition, in the expedition game, the player can select one or more ally characters owned by the player to form a party. The player can play the expedition game using the formed party. In the expedition game, an “expedition” is performed in which ally characters formed into a party are dispatched for a preset required time. When the required time has elapsed, the expedition game is completed (cleared), and the player can obtain a reward. In other words, in order to start the expedition game, it is necessary for the player to perform a player operation and activate the game. However, the started expedition game (specific content) does not require a player operation and activation of the game for the game to progress and has a game property in which the game progresses as time elapses.

The purpose of the expedition game is to obtain a reward by dispatching the ally characters formed into a party for a predetermined required time. As will be described in detail below, in the present embodiment, for example, a plurality of types of expedition games can be played. The difficulty level based on the required time, power of the party, and similar conditions vary depending on the type of the expedition game.

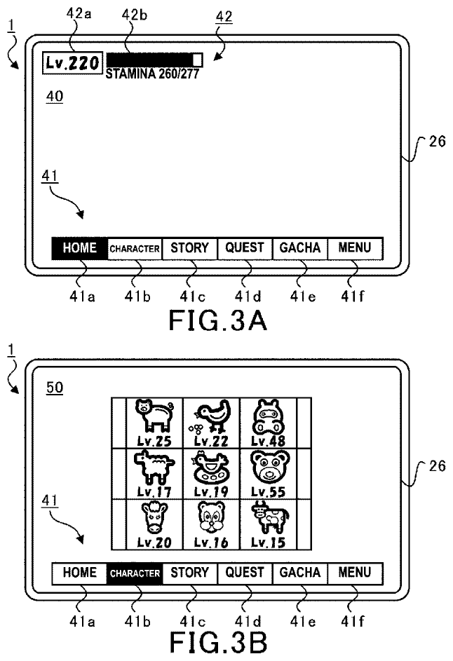

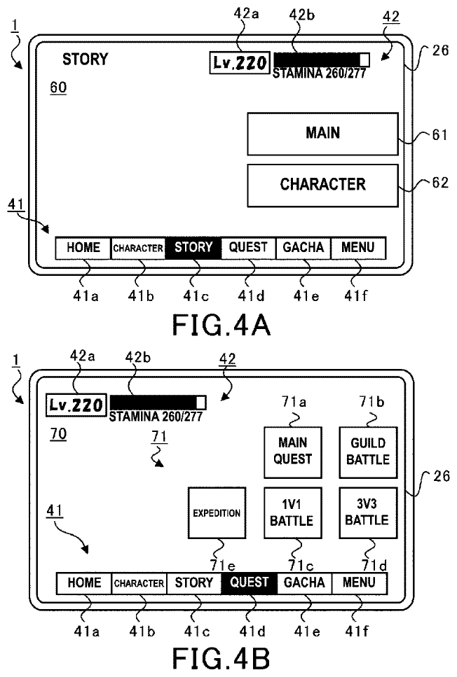

FIG. 3A is a diagram illustrating an example of a home screen 40. FIG. 3B is a diagram illustrating an example of an ally character confirmation screen 50. FIG. 4A is a diagram illustrating an example of a story screen 60. FIG. 4B is a diagram illustrating an example of a quest screen 70.

The home screen 40 illustrated in FIG. 3A is a screen that is first displayed after the player performs a tap operation on the display 26 on a title screen (not illustrated) (that is, after the game is started). As illustrated in FIG. 3A, on the home screen 40, a menu bar 41 is displayed at a lower portion of the display 26. The menu bar 41 is displayed at the lower portion of the display 26 on normal screens other than the title screen (not illustrated).

The menu bar 41 is provided with a plurality of operation portions that can be operated (tapped) by the player. The menu bar 41 is provided with a home screen selection operation portion 41a denoted by “Home”. The menu bar 41 is provided with an ally character confirmation screen selection operation portion 41b denoted by “Characters”. The menu bar 41 is provided with a story screen selection operation portion 41c denoted by “Story”. The menu bar 41 is provided with a quest screen selection operation portion 41d denoted by “Quest”. The menu bar 41 is provided with a gacha screen selection operation portion 41e denoted by “Gacha”. The menu bar 41 is provided with a menu screen selection operation portion 41f denoted by “Menu”. In the menu bar 41, the operation portion corresponding to the screen being displayed is highlighted so that each screen on the display 26 can be identified.

When the home screen selection operation portion 41a is tapped, the home screen 40 illustrated in FIG. 3A is displayed on the display 26. When the ally character confirmation screen selection operation portion 41b is tapped, the ally confirmation character screen 50 illustrated in FIG. 3B is displayed on the display 26. When the story screen selection operation portion 41c is tapped, the story screen 60 illustrated in FIG. 4A is displayed on the display 26. When the quest screen selection operation portion 41d is tapped, the quest screen 70 illustrated in FIG. 4B is displayed on the display 26.

When the gacha screen selection operation portion 41e is tapped, a gacha screen (not illustrated) is displayed on the display 26. When the menu screen selection operation portion 41f is tapped, a menu screen (not illustrated) is displayed on the display 26. Although detailed description is omitted, on the gacha screen, it is possible to perform a gacha lottery in which an ally character can be obtained through a lottery. On the menu screen, game settings and various types of information can be checked.

A header display area 42 is provided in an upper portion of the home screen 40. At least a part of player information associated with a player ID is displayed in the header display area 42. For example, level information 42a indicating the player level and a stamina display bar 42b indicating the stamina of the player are displayed in the header display area 42. Further, as illustrated in FIG. 3A, the stamina of the player is displayed by a numerical value at a lower portion of the stamina display bar 42b.

The player information includes a player ID, ally character identification information (hereinafter referred to as an ally character ID) for identifying an ally character owned by the player, the level information 42a, stamina information displayed on the stamina display bar 42b, story progress information to be described below, battle game clear information, in-game currency information indicating the amount of in-game currency owned by the player, item information indicating the type and amount of items owned by the player, and expedition game information indicating the progress status of the expedition game.

The stamina is a parameter necessary for the player to play the battle game. In the present embodiment, a plurality of types of battle games are provided, and a stamina consumption value required to play, a maximum number of play times per day, and the like are set for each battle game. When a battle game in which the stamina consumption value necessary for play is set is played, a player consumes stamina to play the battle game. Thus, when the stamina is insufficient, the player cannot play the battle game.

Although detailed description is omitted, when the player wins in the battle game, the player can obtain a predetermined value as player experience. Each time the player experience reaches a certain value, the player level increases. For player levels, an upper limit value for stamina is set. As the player level increases, the upper limit value for stamina increases. Stamina is recovered by a predetermined value (for example, one point) at regular time intervals (for example, five minutes) within the range of the upper limit value. In the stamina display bar 42b, the current remaining amount of stamina is displayed so as to be visually recognizable with respect to the upper limit value of stamina. The numerical value of stamina displayed at the lower portion of the stamina display bar 42b is “260/277” in the example of FIG. 3A, where “277” is the upper limit value of stamina displayed as the denominator, and “260” is the current stamina of the player displayed as the numerator.

However, in the present embodiment, the player can play the expedition game without consuming stamina. That is, for example, even when stamina is exhausted by playing the battle game, it is possible to execute the expedition game. However, it may be necessary to consume stamina in order to play the expedition game.

When the ally character confirmation screen selection operation portion 41b of the menu bar 41 is tapped, the ally character confirmation screen 50 illustrated in FIG. 3B is displayed on the display 26. On the ally character confirmation screen 50, all images of the ally characters corresponding to the ally character IDs associated with the player ID are displayed.

In other words, all the ally characters possessed by the player are displayed on the ally character confirmation screen 50. Note that a different ally character ID is assigned to each ally character. When the player obtains a new ally character via, for example, a gacha lottery or the like, the ally character ID of the obtained ally character is associated with the player ID of the player.

Stars (rank), experience, and level are stored in association with the ally character. The experience increases when a player wins in a battle game described below or when a predetermined item is used. The level is set corresponding to the experience, and the level increases each time the experience reaches a predetermined value. An upper limit value of the level is set for each ally character, and the level increases only within a range up to the upper limit value.

In addition, base values of the power of the ally character such as life points, attack power, and defense power are set for the ally character based on the stars (rank) and the level. The player can advantageously progress through the battle game as the power of the ally character increases. Each base value set for the ally character increases as the stars (rank) increase and as the level increases.

On the ally character confirmation screen 50, it is possible to equip (set) the ally character with equipment such as weapons and armors. An additional value for attack power, defense power, and/or the like is set for each piece of equipment. When the equipment is equipped, the additional value of each piece of equipment is added to the base values, and the power of the ally character can be enhanced. The information relating to equipment such as weapons and armor is also associated with the ally character ID and is configured as a part of the player information.

In the present embodiment, a special item for increasing the number of stars (rank) of the ally character is provided. On the ally character confirmation screen 50, the player can increase the number of stars (rank) of the ally character by consuming the special item for the ally character whose number of stars (rank) is to be increased. The player can obtain a special item as a reward when completing (clearing) a battle game or an expedition game to be described below.

When the story screen selection operation portion 41c of the menu bar 41 is tapped, the story screen 60 illustrated in FIG. 4A is displayed on the display 26. As illustrated in FIG. 4A, the menu bar 41, the header display area 42, a main story selection operation portion 61, and a character story selection operation portion 62 are displayed in the story screen 60.

When the main story selection operation portion 61 in the story screen 60 is tapped, a main story screen (not illustrated) is displayed on the display 26. On the main story screen, a plurality of main stories unlock in accordance with the degree of progress of a “main quest” described below are displayed. When a new main story is unlocked as a result of the player proceeding with the main quest described below, the player can view the unlocked main story from a main story screen (not illustrated).

When the character story selection operation portion 62 in the story screen 60 illustrated in FIG. 4A is operated (tapped), a character story (not illustrated) unlocked in accordance with a friendship level of the ally character is displayed on the display 26.

Note that the friendship level of the ally character increases when the ally character wins a battle game described below or when a predetermined item is used. Each time the friendship level reaches a predetermined value, the friendship level rank increases. Note that an upper limit value of the friendship level rank is set for the ally character, and the rank increases only in a range up to the upper limit value. When the friendship level of the ally character increases to the upper limit value, all the character stories for the ally character are unlocked. When a new character story is unlocked, the player can view the unlocked character story from a character story screen (not illustrated).

Returning to FIG. 3A, when the quest screen selection operation portion 41d of the menu bar 41 is tapped, the quest screen 70 illustrated in FIG. 4B is displayed on the display 26. On the quest screen 70, the menu bar 41, the header display area 42, and a plurality of game type selection operation portions 71 displaying the game types provided are displayed. Here, five types of games are provided, and five game type selection operation portions 71 are displayed.

The game type selection operation portion 71 includes a main quest selection operation portion 71a denoted by “Main quest”. The game type selection operation portion 71 includes a guild battle selection operation portion 71b denoted by “Guild battle”. The game type selection operation portion 71 includes a 1V1 battle selection operation portion 71c denoted by “1V1 battle”. The game type selection operation portion 71 includes a 3V3 battle selection operation portion 71d denoted by “3V3 battle”. The game type selection operation portion 71 includes an expedition selection operation portion 71e denoted by “Expedition”.

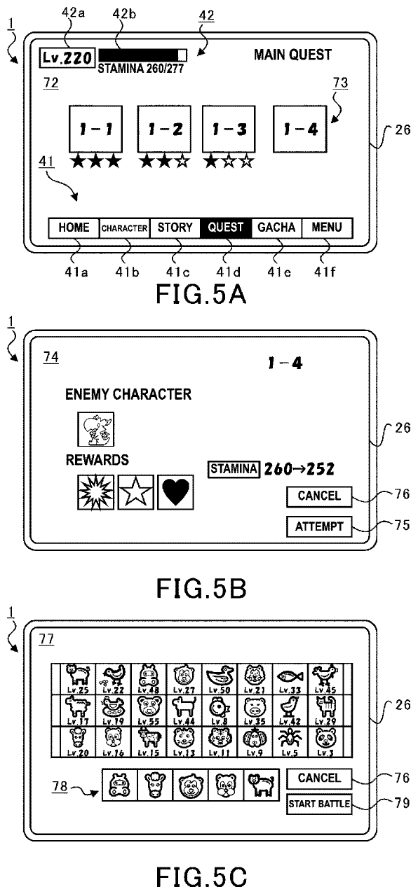

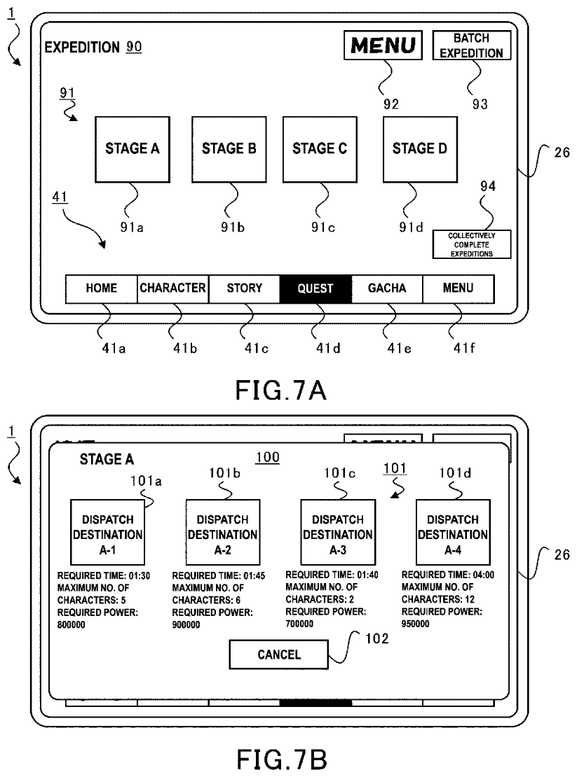

When the main quest selection operation portion 71a is tapped, a main quest screen 72 (FIG. 5A) to be described below is displayed on the display 26. When the guild battle selection operation portion 71b is tapped, a guild battle screen (not illustrated) is displayed on the display 26. Similarly, when the 1V1 battle selection operation portion 71c is tapped, a 1V1 battle screen (not illustrated) is displayed on the display 26. When the 3V3 battle selection operation portion 71d is tapped, a 3V3 battle screen (not illustrated) is displayed on the display 26. In addition, when the expedition selection operation portion 71e is tapped, an expedition top screen 90 (FIG. 7A) described below is displayed on the display 26.

Depending on the game type, an unlock condition may be set. Examples of unlock conditions include the player level being equal to or greater than a predetermined value or another predetermined game being completed (cleared). In addition, each game type includes a plurality of games (stages or rounds). An unlock condition is set for each of these games. When the unlock condition is satisfied, game unlock information included in the player information is updated.

In the player terminal 1, it is determined whether the game is unlocked based on the game unlock information, and only the game type selection operation portion 71 of the game satisfying the unlock condition may receive a player operation (tap). Thus, the player can play only games satisfying the unlock condition.

When the main quest selection operation portion 71a in the quest screen 70 illustrated in FIG. 4B is tapped, the main quest screen 72 illustrated in FIG. 5A is displayed on the display 26.

FIG. 5A is a diagram for describing an example of the main quest screen 72. FIG. 5B is a diagram for describing an example of a main quest selection screen 74. FIG. 5C is a diagram for describing an example of a party selection screen 77.

On the main quest screen 72, the menu bar 41, the header display area 42, and a main quest operation portion 73 for selecting a plurality of battle games (stages) belonging to the main quest are displayed.

Clear information of each battle game is also displayed in the main quest operation portion 73. The clear information is indicated using three stars, for example. In a battle game belonging to the main quest, when the battle game is completed (cleared), stars are obtained in accordance with the number of ally characters whose life points are 0 when the battle game is completed (cleared). For example, when there are no ally characters with 0 life points, three stars are obtained. For example, when there is one ally character with 0 life points, two stars are obtained. For example, when there are two or more ally characters with 0 life points, one star is obtained.

In the example of FIG. 5A, three stars have been obtained in the battle game “1-1”, two stars have been obtained in the battle game “1-2”, and one star has been obtained in the battle game “1-3”. In addition, for the battle game “1-4”, no stars have been obtained, notifying that the battle game has not been completed (cleared).

In the main quest, completion (clearing) of the previous battle game is set as an unlock condition. For example, in the example of FIG. 5A, the battle game “1-3” is completed (cleared), unlocking the battle game “1-4”, but the subsequent battle games (“1-5” and subsequent battle games (not illustrated)) are not unlocked.

In the main quest screen 72, for example, when the main quest operation portion 73 of the battle game “1-4” is operated (tapped), the main quest selection screen 74 illustrated in FIG. 5B is displayed on the display 26. On the main quest selection screen 74, an enemy character appearing in the battle game and an item (reward) obtainable in the battle game are displayed.

In addition, on the main quest selection screen 74, stamina after consumption in a case where stamina is consumed to attempt the battle game is displayed. Here, a change in the current stamina from 260 to 252 after consumption is displayed.

In addition, on the main quest selection screen 74, an attempt operation portion 75 denoted by “Attempt” for attempting the battle game and a cancel operation portion 76 denoted by “Cancel” for canceling the processing corresponding to the currently displayed screen are displayed.

When the cancel operation portion 76 is operated (tapped), the main quest screen 72 illustrated in FIG. 5A is displayed on the display 26 and the attempt of the selected battle game “1-4” is canceled.

On the other hand, when the attempt operation portion 75 is operated (tapped), the party selection screen 77 illustrated in FIG. 5C is displayed on the display 26. On the party selection screen 77, all the ally characters possessed by the player are displayed and, below that, a selected ally character display area 78 for displaying the selected ally character is displayed.

In addition, on the party selection screen 77, the cancel operation portion 76 and a battle start operation portion 79 denoted by “Start battle” are displayed.

When the player operates (taps) the displayed ally character on the party selection screen 77, the operated (tapped) ally character is displayed in the selected ally character display area 78. That is, here, an ally character ID to be used in the battle game (to determine a party) is selected from among a plurality of ally character IDs associated with the player ID. When the player selects a plurality of ally characters, a party is formed. In the party formation, the same ally character cannot be set more than once.

When the party formation is completed and the battle start operation portion 79 is operated (tapped), the battle game is started and a battle game screen 80 is displayed on the display 26.

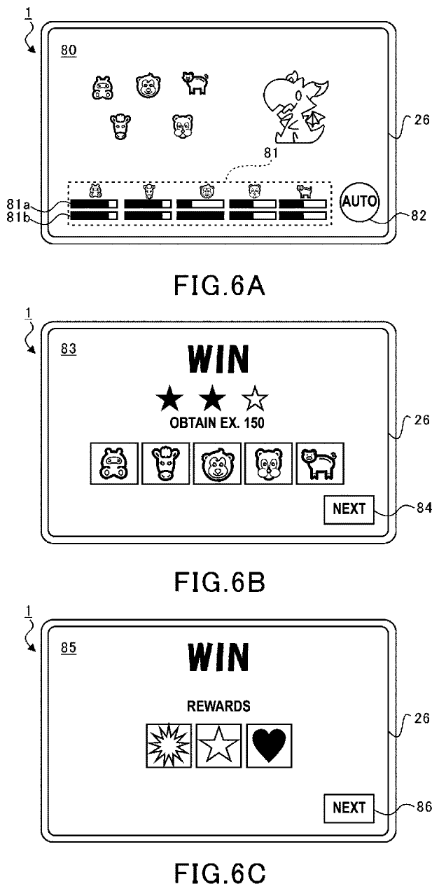

FIG. 6A is a diagram for describing an example of the battle game screen 80. FIG. 6B is a diagram for describing an example of a first result screen 83. FIG. 6C is a diagram for describing an example of a second result screen 85. During the battle game, as illustrated in FIG. 6A, the battle game screen 80 is displayed. In the battle game screen 80, the ally character and the enemy character are displayed on the display 26. The ally characters are operated under computer control to damage the enemy character and receive damage from the enemy character. The enemy character operates under computer control to damage the ally characters or receive damage from the ally characters.

When damage points are given to the enemy character, the damage points are subtracted from the life points of the enemy character. Similarly, when damage points are given to the ally character, the damage points are subtracted from the life points of the ally character. When the life points of all the enemy characters become 0, the player wins (clears), and when the life points of all the ally characters become 0 (loses), the player loses.

Here, at a lower portion of the battle game screen 80, as illustrated in FIG. 6A, an ally character display area 81 is provided. In the ally character display area 81, life points 81a and a special skill gauge 81b for each ally character are displayed. The special skill gauge 81b rises when the ally character receives damage from the enemy character and when the ally character causes damage to the enemy character. When the special skill gauge 81b reaches a predetermined maximum value, the ally character can use the special skill. With the special skill, the damage points given to the enemy character are larger than that of a normal attack, life points of the ally character are recovered, or a special effect is given to the enemy character.

Here, two patterns are provided for a method of using the special skill. One is a method in which the player operates (taps) the ally character displayed in the ally character display area 81 with the special skill gauge 81b at a maximum value. The other is a method in which the ally character uses the special skill under computer control when the special skill gauge 81b reaches the maximum value in an automatic activation state. An automatic selection operation portion 82 is displayed on the battle game screen 80, and the player can switch between the automatic activation state and a manual activation state by operating the automatic selection operation portion 82. When the automatic selection operation portion 82 is operated (tapped) in the manual activation state, the automatic activation state in which the special skill is automatically used is set. In addition, when the automatic selection operation portion 82 is operated (tapped) in the automatic activation state, the manual activation state in which the special skill is manually used is set. Even in the automatic activation state, when the player operates (taps) the ally character in a state where the special skill gauge 81b has reached the maximum value and the special skill has not been used by computer control, the special skill can be used.

When the battle game ends normally (normal end), the first result screen 83 is displayed on the display 26 as illustrated in FIG. 6B. As an example, FIG. 6B illustrates the first result screen 83 when the ally characters win.

At least a portion of game result information of the battle game is displayed on the first result screen 83. Further, on the first result screen 83, a next operation portion 84 denoted by “Next” is displayed.

When the next operation portion 84 is operated (tapped), the second result screen 85 illustrated in FIG. 6C is displayed on the display 26.

At least a portion of the game result information of the battle game is displayed on the second result screen 85. In addition, on the second result screen 85, a next operation portion 86 denoted by “Next” is displayed. When the next operation portion 86 is operated (tapped), the display of the display 26 is switched from the battle screen to the normal screen. That is, the first result screen 83 and the second result screen 85 are a part of the battle screen. In the present embodiment, when the next operation portion 86 is operated (tapped), the main quest screen 72 illustrated in FIG. 5A is displayed on the display 26.

The game result information includes the ally character ID (party) of the ally characters. The game result information includes the enemy character ID of the enemy character. In addition, the game result information includes remaining status information of the ally characters and the enemy character of the end of the battle (whether the life points are 0 at the end of the battle game). In addition, the game result information includes the given damage points (total value). The game result information includes player operation information (manual activation state or automatic activation state). The game result information includes a battle log ID. The game result information includes type information (main quest, guild battle, and the like) of the battle game. In addition, the game result information includes information associated with each type of the battle game (clear information, battle game stages, and the like). In addition, the game result information includes granted item information and the like.

When the battle game is in the automatic activation state from the start to the end of the battle game and the player does not manually use the special skill, the battle game is in the automatic activation state. Otherwise, the battle game is in the manual activation state. Further, the battle log ID is uniquely assigned to each battle game. The information associated with each type of the battle game has different content for each type of the battle game.

Next, an expedition game according to the present embodiment will be described. The expedition game according to the present embodiment has the following game properties. First, the player selects at least one dispatch destination from among any dispatch destination set in advance. Further, the player selects one or more ally characters from among the ally characters owned by the player to form a party. Then, the player dispatches the formed party to the selected dispatch destination. Then, when the required time set for each dispatch destination elapses, the expedition game is completed (cleared), and the player can obtain a reward.

As described above, when the player operates (taps) the expedition selection operation portion 71e of the quest screen 70 (FIG. 4B), the expedition top screen 90 (FIG. 7A) is displayed on the display 26. FIG. 7A is a diagram for describing an example of the expedition top screen 90. In the present embodiment, the expedition game is provided with a plurality of stages to which a plurality of dispatch destinations belong. Specifically, the plurality of stages include four stages, “Stage A”, “Stage B”, “Stage C”, and “Stage D”. However, the number of stages is not limited thereto.

As illustrated in FIG. 7A, a plurality of expedition stage selection operation portions 91 corresponding to the plurality of stages are displayed at a central portion of the expedition top screen 90. Specifically, as illustrated in FIG. 7A, four operation portions are displayed: a first expedition stage selection operation portion 91a denoted by “Stage A”, a second expedition stage selection operation portion 91b denoted by “Stage B”, a third expedition stage selection operation portion 91c denoted by “Stage C”, and a fourth expedition stage selection operation portion 91d denoted by “Stage D”.

When the player operates (taps) any one of the first expedition stage selection operation portion 91a to the fourth expedition stage selection operation portion 91d, a corresponding dispatch destination selection screen 100 (FIG. 7B) described below is displayed on the display 26.

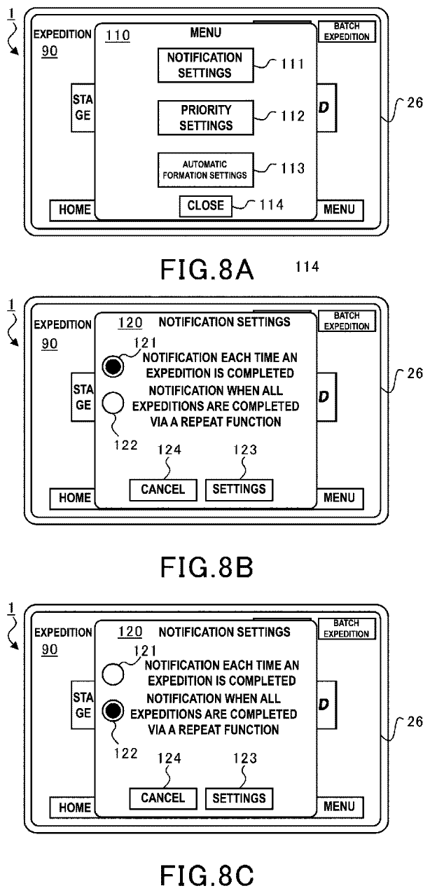

In addition, a menu screen selection operation portion 92 for displaying a menu screen 110 (FIG. 8A) described below is displayed in an upper portion of the expedition top screen 90.

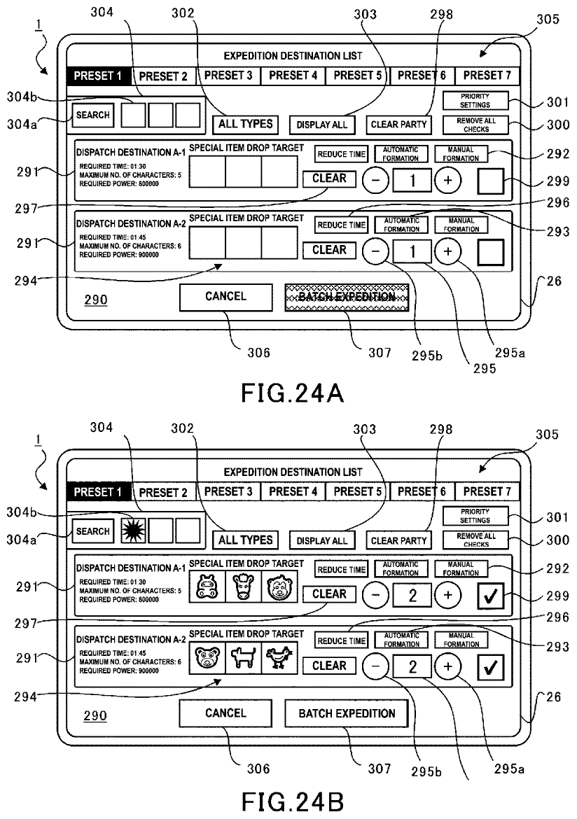

In addition, in the upper portion of the expedition top screen 90, a batch expedition selection operation portion 93 displaying a batch expedition screen 290 (FIG. 24A), which will be described below, is displayed.

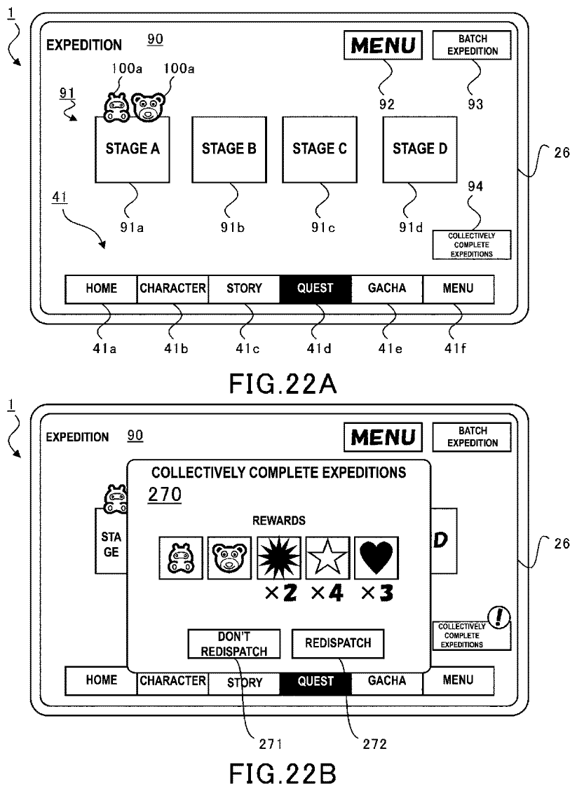

In addition, in a lower portion of the expedition top screen 90, an expedition collective completion operation portion 94 for displaying an expedition collective completion screen 270 (FIG. 22B) described below is displayed.

As described above, when the player operates (taps) the expedition stage selection operation portion 91 of the expedition top screen 90, the corresponding dispatch destination selection screen 100 (FIG. 7B) is displayed on the display 26. FIG. 7B is a diagram for describing an example of the dispatch destination selection screen 100. Note that FIG. 7B illustrates the dispatch destination selection screen 100 displayed on the display 26 when the player operates (taps) the first expedition stage selection operation portion 91a of the expedition top screen 90 (FIG. 7A).

In the present embodiment, the dispatch destinations belonging to “Stage A” include four dispatch destinations: “Dispatch destination A-1”, “Dispatch destination A-2”, “Dispatch destination A-3”, and “Dispatch destination A-4”. Similarly, “Stage B” to “Stage D” also each include four dispatch destinations. However, the number of dispatch destinations belonging to each stage is not limited thereto, and the number of dispatch destinations belonging to each stage may be the same or different.

As illustrated in FIG. 7B, a plurality of dispatch destination selection operation portions 101 corresponding to the plurality of dispatch destinations are displayed at a central portion of the dispatch destination selection screen 100. Specifically, as illustrated in FIG. 7B, four operation portions are displayed: a first dispatch destination selection operation portion denoted by “Dispatch destination A-1”, a second dispatch destination selection operation portion 101b denoted by “Dispatch destination A-2”, a third dispatch destination selection operation portion 101c denoted by “Dispatch destination A-3”, and a fourth dispatch destination selection operation portion 101d denoted by “Dispatch destination A-4”.

In the present embodiment, a difficulty level is set in advance for each dispatch destination in the expedition game. In the present embodiment, three play conditions, namely required power, maximum number of characters, and required time are set in advance for each dispatch destination.

The required power indicates a minimum condition of the power of the party, that is, a total value of the power of the ally characters forming the party. That is, when the power of the party is equal to or greater than the required power, the party can be dispatched to the dispatch destination. On the other hand, if the power of the party is less than the required power, the party cannot be dispatched to the dispatch destination. That is, it can be considered that the higher the required power, the higher the difficulty level.

In other words, it can be considered that when set formation information (party formation) satisfies the minimum condition (required power), progression to specific content (expedition game) is allowed, and when the set formation information (party formation) does not satisfy the minimum condition (required power), progression to the specific content (expedition game) is not allowed.

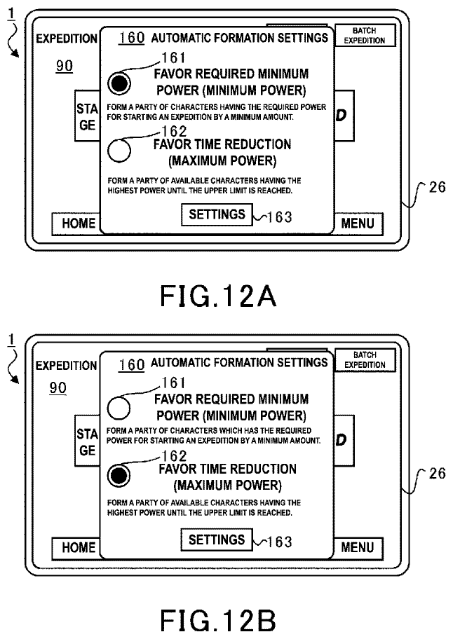

The required time indicates the time required for completion (clearing) when the party is dispatched to the dispatch destination. In the present embodiment, the required time is reduced as the power of the party dispatched to the dispatch destination increases. That is, it is possible to increase the power of the party and reduce the required time by forming a party of ally characters having relatively high power among the possessed ally characters. However, the conditions for reducing the required time are not limited to the above. For example, the required time may be reduced by the number of party members, the level of the ally characters, or the like instead of the power. These may be set as setting targets in an automatic formation setting screen 160 (FIG. 12A) described below.

In other words, formation information including one or more game media (ally characters) and with a predetermined parameter (power) calculated based on the game medium (ally characters) that satisfies the minimum condition is required, and the formation information (party formation) is set based on a player operation relating to the specific content (expedition game) with the degree of advantage increasing (required time decreasing) the further the predetermined parameter (power) exceeds the minimum condition. In addition, it is possible to reduce an amount of time until the progress of the specific content (the expedition game) ends in accordance with a degree of the predetermined parameter (power of the party) exceeding the minimum condition (required power).

The maximum number of characters indicates the maximum number of ally characters that can be put into a party to be dispatched to the dispatch destination. It can be considered that the difficulty level increases as the maximum number of characters decreases. The minimum number of ally characters formed into a party to be dispatched to the dispatch destination may be further set as a play condition.

Specifically, for “Dispatch destination A-1”, the required time is set to 1 hour and 30 minutes, the maximum number of characters is set to 5, and the required power is set to 800000 as the play conditions, as illustrated in FIG. 7B for example. For “Dispatch destination A-2”, the required time is set to 1 hour and 45 minutes, the maximum number of characters is set to 6, and the required power is set to 900000 as the play conditions. For “Dispatch destination A-3”, the required time is set to 1 hour and 40 minutes, the maximum number of characters is set to 2, and the required power is set to 700000 as the play conditions. For “Dispatch destination A-4”, the required time is set to 4 hours, the maximum number of characters is set to 12, and the required power is set to 950000 as the play conditions.

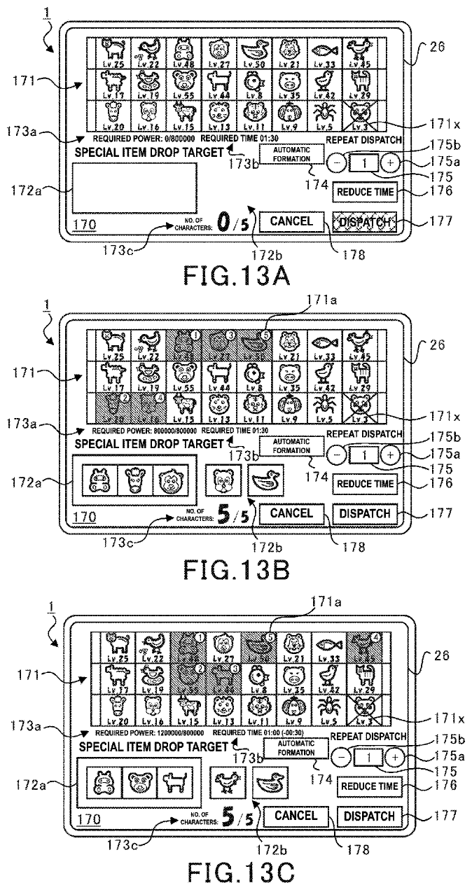

When any one of the first dispatch destination selection operation portion 101a to the fourth dispatch destination selection operation portion 101d is operated (tapped) by the player, a formation screen 170 (FIG. 13A) described below for forming a party to be dispatched to the corresponding type of dispatch destination is displayed on the display 26.

Further, as illustrated in FIG. 7B, a cancel operation portion 102 denoted by “Cancel” is displayed in a lower portion of the dispatch destination selection screen 100. When the player operates (taps) the cancel operation portion 102, the display of the dispatch destination selection screen 100 is ended, and the expedition top screen 90 (FIG. 7A) is displayed on the display 26.

As described above, when the player operates (taps) the menu screen selection operation portion 92 of the expedition top screen 90 (FIG. 7A), the menu screen 110 (FIG. 8A) is displayed on the display 26. FIG. 8A is a diagram for describing an example of the menu screen 110.

As illustrated in FIG. 8A, a notification setting operation portion 111 denoted by “Notification settings” is displayed on the menu screen 110. When the notification setting operation portion 111 is operated (tapped) by the player, a notification setting screen 120 (FIG. 8B) described below is displayed.

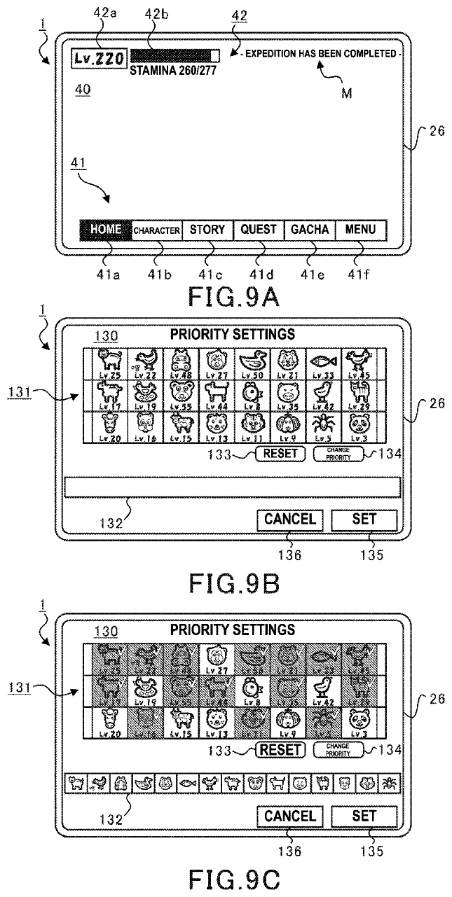

Further, as illustrated in FIG. 8A, a priority setting operation portion 112 denoted by “Priority settings” is displayed on the menu screen 110. When the priority setting operation portion 112 is operated (tapped) by the player, a priority setting screen 130 (FIG. 9B) described below is displayed.

As illustrated in FIG. 8A, an automatic formation setting operation portion 113 denoted by “Automatic formation settings” is displayed in the menu screen 110. When the automatic formation setting operation portion 113 is operated (tapped) by the player, the automatic formation setting screen 160 (FIG. 12A) described below is displayed.

Further, as illustrated in FIG. 8A, a close operation portion 114 denoted by “Close” is displayed on the menu screen 110. When the player operates (taps) the close operation portion 114, the display of the menu screen 110 is ended, and the expedition top screen 90 (FIG. 7A) is displayed on the display 26.

As described above, when the notification setting operation portion 111 is operated (tapped) by the player, the notification setting screen 120 (FIG. 8B) is displayed. FIG. 8B is a first diagram for describing an example of the notification setting screen 120. FIG. 8C is a second diagram for describing an example of the notification setting screen 120. FIG. 9A is a diagram for describing an example of an expedition completion notification.

As will be described in detail below, a repeat dispatch function is provided in the present embodiment. In the repeat dispatch function, the player can designate any number of times that the formed party is dispatched to the dispatch destination (hereinafter referred to as the number of dispatches). In other words, for the expedition game (specific content), the number of times selected by the player from among one time and a predetermined number of two times or more can be set as the number of executions. Thus, it is possible to improve player-friendliness.

Further, in the present embodiment, when the expedition game is completed (cleared), the player can receive a notification indicating that the expedition game has been completed (cleared) (hereinafter referred to as an expedition completion notification). Specifically, in the case illustrated in FIG. 9A, a message M stating “Expedition complete” is displayed in the upper portion of the home screen 40. The text displayed in the expedition completion notification is not limited thereto. Further, the screen where the message M is displayed is not limited to the home screen 40. That is, while the game application is running, the message M is displayed at an upper portion of the display 26 regardless of the type of the screen being displayed. On the notification setting screen 120

illustrated in FIGS. 8B and 8C, the player can set a trigger for executing the expedition completion notification to any trigger. In other words, it is possible to set the execution trigger of the notification indicating that the progress of the expedition game (specific content) has ended based on a player operation.

Specifically, regarding the execution trigger of the expedition completion notification, the player can set the completion of one expedition game as the execution trigger of the expedition completion notification (hereinafter, referred to as a first execution trigger) regardless of the designated number of dispatches.

Also, regarding the execution trigger of the expedition completion notification, the player can set the completion of all of the designated number of dispatches/expedition games as the execution trigger of the expedition completion notification (hereinafter, referred to as a second execution trigger) regardless of the designated number of dispatches.

In other words, it is possible to set, as an execution trigger (second execution trigger), a case where all the progress of the expedition game (specific content) of the set number of executions has ended. In addition, in a case where the second execution trigger is set and the designated number of dispatches the expedition completion notification (notification) is executed based on the progress of one expedition game (specific content) having ended. In addition, in a case where the second execution trigger is set and the designated number of dispatches is a plurality of times (for example, three times), the expedition completion notification (notification) is executed based on the progress of the expedition game (specific content) having been ended a plurality of times (for example, three times). In addition, in a case where the second execution trigger is set and the designated number of dispatches is a plurality of times (for example, three times), the expedition completion notification (notification) is not executed based on the progress of the expedition game (specific content) having been ended less than the designated number of dispatches (for example, one or two times).

As illustrated in FIGS. 8B and 8C, a first execution trigger selection portion 121 corresponding to the first execution trigger and a second execution trigger selection portion 122 corresponding to the second execution trigger are displayed at a central portion of notification setting screen 120. When the player operates (taps) the first execution trigger selection portion 121, the first execution trigger selection portion 121 is highlighted as illustrated in FIG. 8B. When the player operates (taps) the second execution trigger selection portion 122, the second execution trigger selection portion 122 is highlighted as illustrated in FIG. 8C. FIGS. 8B and 8C illustrate a case where a black circle is displayed in the first execution trigger selection portion 121 or the second execution trigger selection portion 122 in accordance with a player operation (tap) as a highlighted display. However, the content of the highlighted display is not limited thereto. For example, a check mark may be displayed in the first execution trigger selection portion 121 or the second execution trigger selection portion 122 in accordance with a player operation (tap) as a highlighted display.

In addition, as illustrated in FIGS. 8B and 8C, a setting operation portion 123 denoted by “Set” is displayed at a lower portion of the notification setting screen 120. When the player operates (taps) the setting operation portion 123 in a case where the first execution trigger selection portion 121 is highlighted (FIG. 8B), the first execution trigger is set as the execution trigger of the expedition completion notification. When the player operates (taps) the setting operation portion 123 in a case where the second execution trigger selection portion 122 is highlighted (FIG. 8C), the second execution trigger is set as the execution trigger of the expedition completion notification.

In addition, as illustrated in FIGS. 8B and 8C, a cancel operation portion 124 denoted by “Cancel” is displayed at the lower portion of the notification setting screen 120. When the player operates (taps) the cancel operation portion 124, the display of the notification setting screen 120 is ended, and the menu screen 110 (FIG. 8A) is displayed on the display 26.

Although the case where the message M is displayed when the home screen 40 is displayed on the display 26 is illustrated in FIG. 9A, the message M is displayed when the execution trigger set by the player is established while the game application is running.

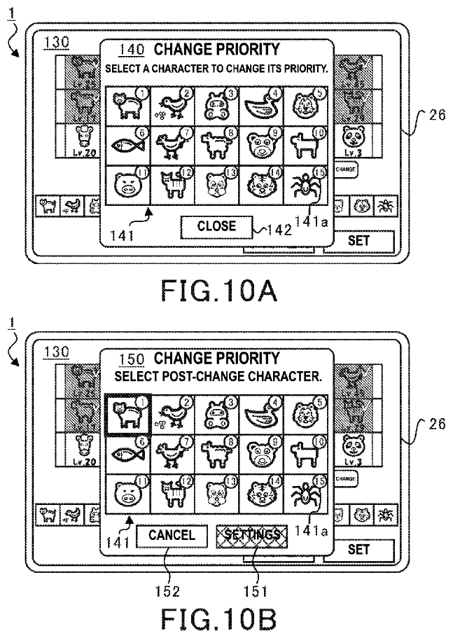

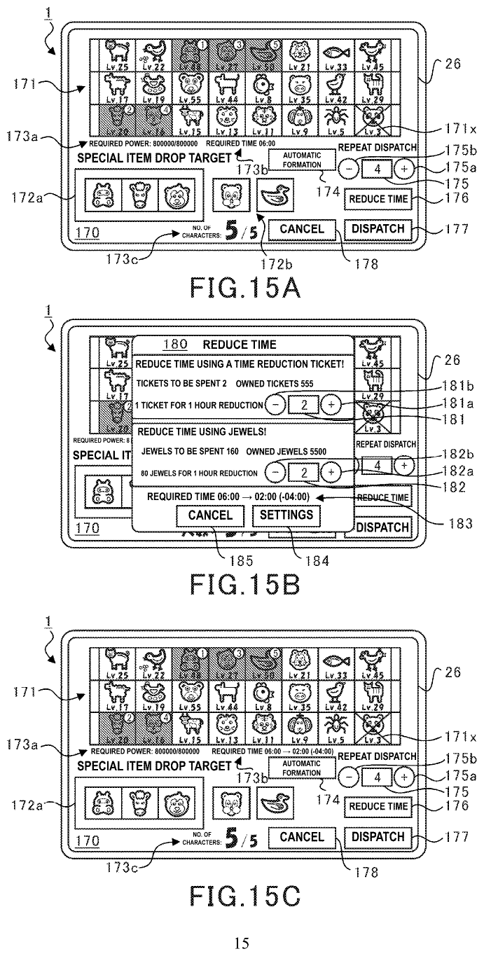

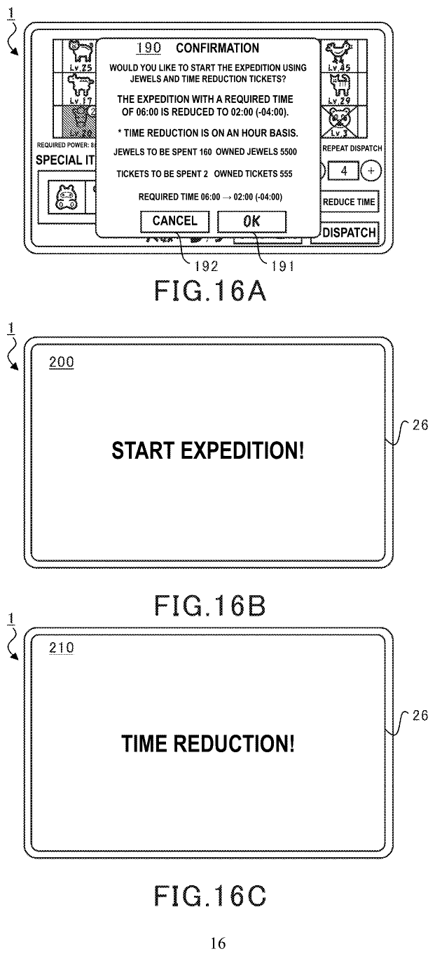

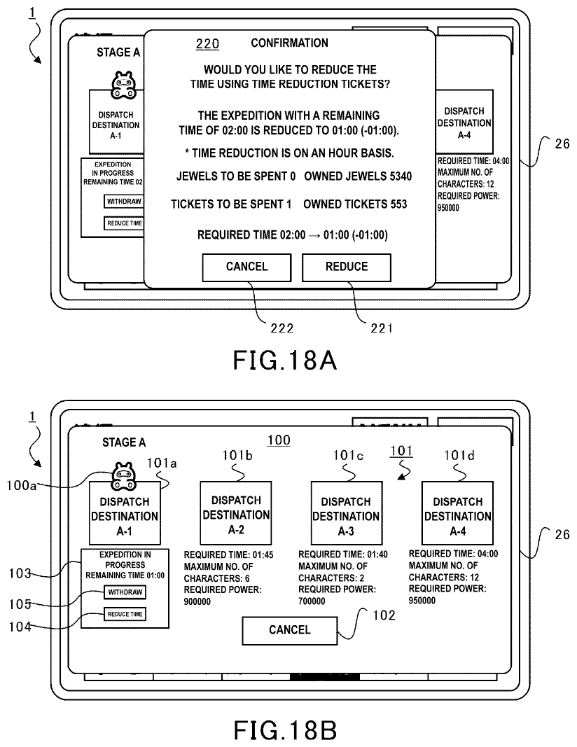

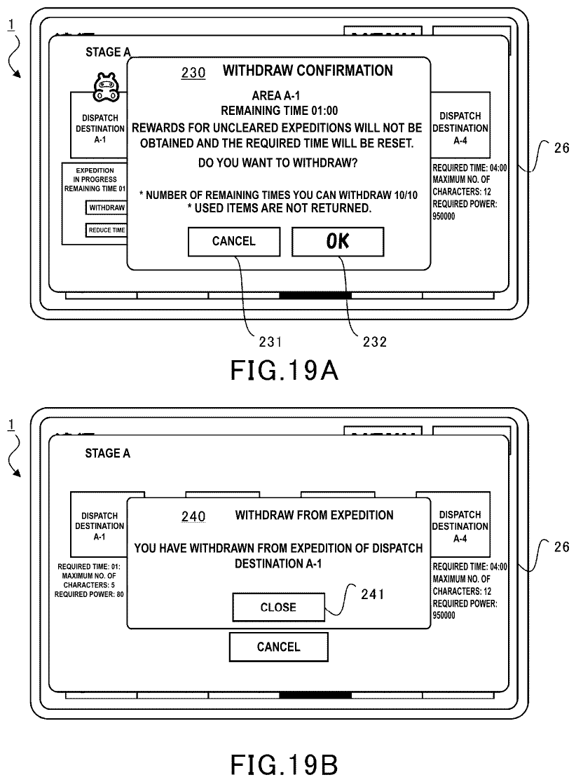

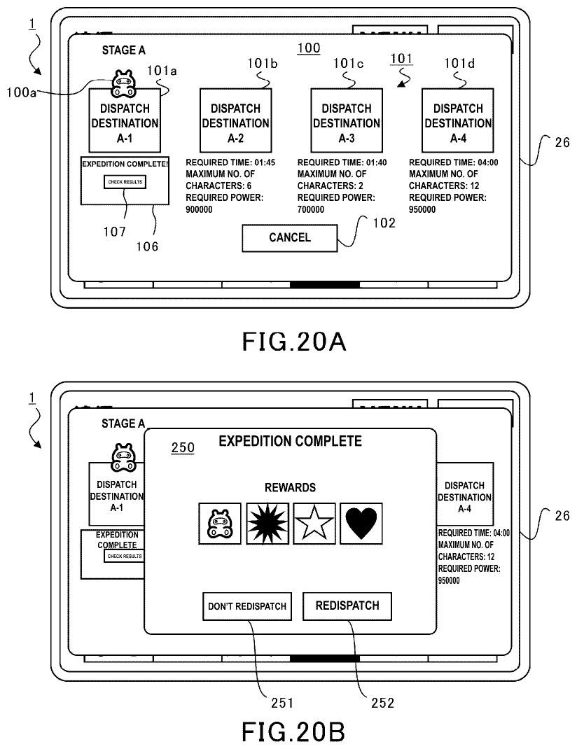

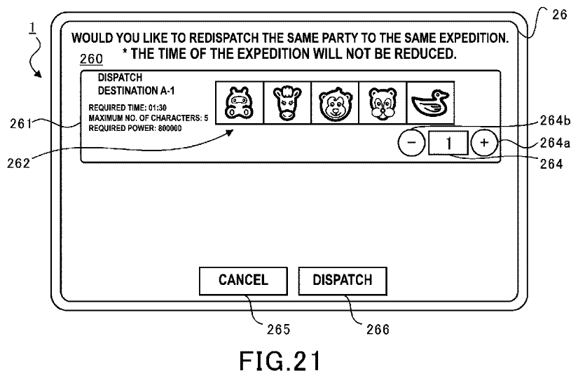

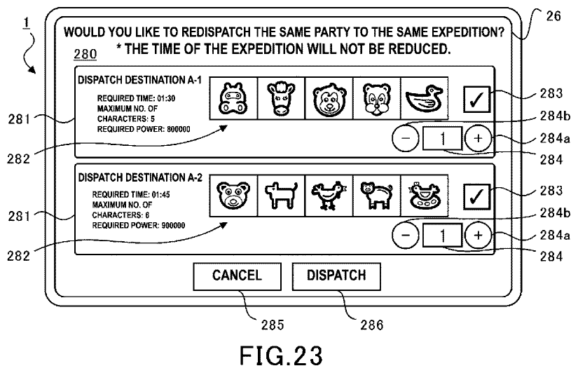

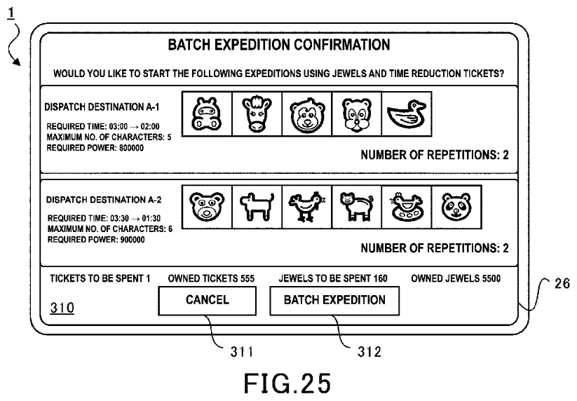

That is, when the execution trigger set by the player is established while the game application is running, the message M is displayed at the upper portion of the display 26 regardless of the type of the screen being displayed. For example, when the ally character confirmation screen 50 (FIG. 3B) is displayed on the display 26, the message M is displayed at a top portion of the ally character confirmation screen 50 if the execution trigger set by the player is established. Similarly, when the story screen 60 (FIG. 4A), the quest screen 70 (FIG. 4B), the main quest screen 72 (FIG. 5A), the main quest selection screen 74 (FIG. 5B), the party selection screen 77 (FIG. 5C), the battle game screen 80 (FIG. 6A), the first result screen 83 (FIG. 6B), the second result screen 85 (FIG. 6C), the expedition top screen 90 (FIG. 7A), the dispatch destination selection screen 100 (FIG. 7B), the menu screen 110 (FIG. 8A), the notification setting screen 120 (FIG. 8B), the priority setting screen 130 (FIG. 9B), a first change priority screen 140 (FIG. 10A), a second change priority screen 150 (FIG. 10B), the automatic formation setting screen 160 (FIG. 12A), the formation screen 170 (FIG. 13A), a time reduction screen 180 (FIG. 15B), a confirmation screen 190 (FIG. 16A), an expedition start animation screen 200 (FIG. 16B), time reduction animation screen 210 (FIG. 16C), a confirmation screen 220 (FIG. 18A), a withdraw confirmation screen 230 (FIG. 19A), an expedition withdraw screen 240 (FIG. 19B), an expedition completion screen 250 (FIG. 20B), a redispatch screen 260 (FIG. 21), the expedition collective completion screen 270 (FIG. 22B), a redispatch screen 280 (FIG. 23), the batch expedition screen 290 (FIG. 24A), or a batch expedition confirmation screen 310 (FIG. 25) are displayed on display 26, the message M is displayed at the top portion of each screen being displayed if the execution trigger set by the player is established.

In a case where the execution trigger set by the player is established while the game application is not running the message M may be displayed when the game application is run for the first time after the execution trigger set by the player has been established.

Further, the message M may be displayed when the execution trigger set by the player is established while the game application is not running. In this case, the message M may be displayed in a predetermined notification area on the display 26 of the player terminal 1.

As described above, when the priority setting operation portion 112 of the menu screen 110 (FIG. 8A) is operated (tapped) by the player, the priority setting screen 130 is displayed on the display 26. FIG. 9B is a first diagram for describing an example of the priority setting screen 130. FIG. 9C is a second diagram for describing an example of the priority setting screen 130.

As described above, in the present embodiment, it is possible to obtain a special item as a reward when completing (clearing) an expedition game. Specifically, it is possible to obtain a special item corresponding to an ally character who, from among the ally characters forming the party dispatched to a completed (cleared) expedition game, is set as the special item drop target that can obtain the special item at a predetermined probability.

In addition, in the present embodiment, a normal item that can also be obtained when the battle game is completed (cleared) can be obtained as a reward when the expedition game is completed (cleared). In the present embodiment, special equipment that cannot be obtained when the battle game is completed (cleared) can be obtained at a predetermined probability as a reward when the expedition game is completed (cleared). The player can equip (set) a desired ally character with the special equipment. Accordingly, it is possible to motivate the player to play the expedition game.

Note that icon images indicating special equipment that can be obtained at a dispatch destination may be displayed in association with the corresponding dispatch destination selection operation portions 101. This allows the player to visually recognize the special equipment that can be obtained, improving player-friendliness.

In the present embodiment, the player can form a party of ally characters up to a maximum number (for example, five) set for each dispatch destination. Among the ally characters in the party, a predetermined number of ally characters (three in the present embodiment) can be set as special item drop targets.

In other words, in the present embodiment, the player cannot obtain a special item corresponding to an ally character who, from among the ally characters forming the party dispatched to a completed (cleared) expedition game, is not set as the special item drop target. However, the probability of being able to obtain a special item corresponding to an ally character not set as the special item drop target may be set to be lower than the probability of being able to obtain a special item corresponding to an ally character set as the special item drop target.

Further, as will be described in detail below, in the present embodiment, the automatic formation function is provided for automatically forming party to be dispatched to the dispatch destination. On the priority setting screen 130, when the automatic formation function is used, the player can set the type of one or more ally characters (hereinafter referred to as priority targets) to be preferentially set as the special item drop target and the priority (priority order) thereof.

As illustrated in FIGS. 9B and 9C, a list display portion 131 is displayed at a central portion of the priority setting screen 130. All ally characters possessed by the player are displayed in the list display portion 131. The player can set desired ally characters (up to 15 characters in the present embodiment) as priority targets by operating (tapping) the ally characters displayed in the list display portion 131.

FIGS. 9B and 9C illustrate an example in which the levels of the ally characters displayed in the list display portion 131 are displayed. However, the power of each ally character displayed in the list display portion 131 may be displayed.

As illustrated in FIGS. 9B and 9C, a priority target display portion 132 for displaying a list of ally characters set as priority targets is displayed in a lower portion of the priority setting screen 130. When the player operates (taps) an ally character displayed in the list display portion 131, the operated (tapped) ally character is highlighted as illustrated in FIG. 9C.

FIG. 9C illustrates an example in which the ally character operated (tapped) by the player is grayed out as a highlighted display. However, the content of the highlighted display is not limited thereto. For example, as the highlighted display, the border of the ally character operated (tapped) by the player may be thickened.

The ally characters are displayed in a left-aligned manner in the priority target display portion 132 in the operated (tapped) order. At this time, the priority of the ally character displayed on the left side of the priority target display portion 132 is set to be the highest, and the priority of the ally character displayed on the right side of the priority target display portion 132 is set to be the lowest.

As illustrated in FIGS. 9B and 9C, a reset operation portion 133 denoted by “Reset” is displayed at the central portion of the priority setting screen 130. When the reset operation portion 133 is operated (tapped) by the player, the ally character set as the priority target is reset, and the ally character is highlighted in the list display portion 131 illustrated in FIG. 9C and the ally character displayed in the priority target display portion 132 is hidden.

Further, as illustrated in FIGS. 9B and 9C, a setting operation portion 135 denoted by “Set” and a cancel operation portion 136 denoted by “Cancel” are displayed in a lower right portion of the priority setting screen 130.

When the cancel operation portion 136 is operated (tapped) by the player, the content displayed on the priority setting screen 130 immediately before the cancel operation portion 136 is operated (tapped) is discarded. In addition, the display of the priority setting screen 130 ends, and the menu screen 110 (FIG. 8A) is displayed on the display 26.

In addition, when the setting operation portion 135 is operated (tapped) by the player, the priority of the ally character is set to the content displayed on the priority setting screen 130 immediately before the operation (tap). In addition, the display of the priority setting screen 130 ends, and the menu screen 110 (FIG. 8A) is displayed on the display 26.

As illustrated in FIGS. 9B and 9C, a priority change operation portion 134 denoted by “Change priority” is displayed at the central portion of the priority setting screen 130. When the player operates (taps) the priority change operation portion 134, the first change priority screen 140 (FIG. 10A) described below is displayed on the display 26.

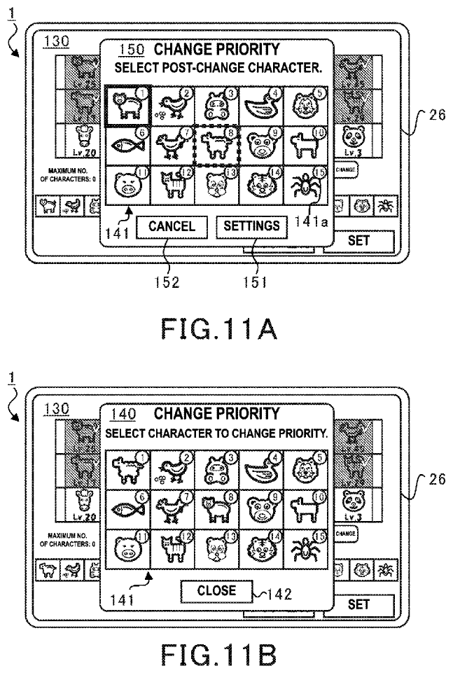

The player can change the priority of priority target ally character by performing a predetermined operation on the first change priority screen 140 (FIG. 10A) and the second change priority screen 150 (FIGS. 10B and 11A) described below. Specifically, the priority of the priority target ally character can be changed by switching the priorities of two ally characters (hereinafter referred to as a pre-change ally character and a post-change ally character) selected by the player from among the priority target ally characters.

FIG. 10A is a first diagram for describing an example of the first change priority screen 140. FIG. 10B is a first diagram for describing an example of the second change priority screen 150. FIG. 11A is a second diagram for describing an example of the second change priority screen 150. FIG. 11B is a second diagram for describing an example of the first change priority screen 140.

As illustrated in FIG. 10A, a priority target display portion 141 is displayed in a central portion of the first change priority screen 140. In the priority target display portion 141, the ally characters set as the priority targets, that is, the ally characters displayed in the priority target display portion 132, are listed in descending order of priority. Further, as illustrated in FIG. 10A, in the priority target display portion 141, an identification display 141a that enables identification of the priority is attached to each ally character set as a priority target. FIG. 10A illustrates an example in which numbers (“1” to “15”) corresponding to the priority are attached as the identification display 141a. That is, smaller numerical values represent a higher priority. However, the content of the identification display 141a is not limited thereto. For example, a symbol corresponding to the priority may be displayed.

Further, as illustrated in FIG. 10A, a close operation portion 142 denoted by “Close” is displayed on the first change priority screen 140. When the player operates (taps) the close operation portion 142, the first change priority screen 140 is hidden, and the priority setting screen 130 is displayed on the display 26.

Further, as illustrated in FIG. 10A, an explanatory display stating “Select a character to change its priority” for prompting the player to perform an operation to select a pre-change ally character to be targeted for priority change is displayed at an upper portion of the first change priority screen 140.

When the player operates (taps) any one of the ally characters displayed in the priority target display portion 141 of the first change priority screen 140, the operated (tapped) ally character is set as the pre-change ally character. Further, on the display 26, the display is switched to the second change priority screen 150 illustrated in FIG. 10B.

As illustrated in FIG. 10B, the priority target display portion 141 is continuously displayed on the second change priority screen 150. As illustrated in FIG. 10B, the pre-change ally character is highlighted in the priority target display portion 141 of the second change priority screen 150. FIG. 10B illustrates an example in which the border of the pre-change ally character is thickened as the highlighted display. However, the content of the highlighted display is not limited thereto. For example, as the highlighted display, the display size of the pre-change ally character may be increased.

Further, as illustrated in FIG. 10B, an explanatory display stating “Select a post-change character” for prompting the player to perform an operation to select a post-change ally character to be targeted for priority change is displayed at the upper portion of the second change priority screen 150.

When the player operates (taps) any one of the ally characters other than the pre-change ally characters displayed in the priority target display portion 141 of the second change priority screen 150, the operated (tapped) ally character is set as the post-change ally character. Further, on the display 26, the display of the second change priority screen 150 is updated as illustrated in FIG. 11A.

Note that although FIG. 9C illustrates a case where the maximum number (15) of ally characters that can be set are set as priority targets, a number (for example, 3) of ally characters equal to or less than the maximum number (15) that can be set may be set as priority targets. Further, in the present embodiment, it is not essential to set an ally character as the priority target. That is, the player is allowed to not particularly set an ally character as the priority target.

As illustrated in FIG. 11A, in the priority target display portion 141 of the second change priority screen 150, both the pre-change ally character and the post-change ally character are distinguishably highlighted. In FIG. 11A, as the highlighted display, the border of the pre-change ally character is thickened and the border of the post-change ally character is thickened and displayed with a broken line. However, the content of the highlighted display is not limited thereto. For example, as the highlighted display, the display size of the pre-change ally character and the post-change ally character may be increased.

As illustrated in FIGS. 10B and 11A, a setting operation portion 151 denoted by “Set” is displayed in a lower portion of the second change priority screen 150. As illustrated in FIG. 10B, before the post-change ally character is set, the setting operation portion 151 is displayed in an inoperable state. On the other hand, as illustrated in FIG. 11A, after the post-change ally character is set, the setting operation portion 151 is displayed in an operable state.

As illustrated in FIGS. 10B and 11A, a cancel operation portion 152 denoted by “Cancel” is displayed in the lower portion of the second change priority screen 150. When the player operates (taps) the cancel operation portion 152, the second change priority screen 150 is hidden, and the first change priority screen 140 is displayed on the display 26.

When the player operates the setting operation portion 151, the priority of the ally character set as the pre-change ally character and the priority of the ally character set as the post-change ally character are switched. In addition, on the display 26, the display is switched to the first change priority screen 140 illustrated in FIG. 11B, and the player is notified that the priority of the ally character set as the pre-change ally character and the priority of the ally character set as the post-change ally character have been switched.

As described above, the difficulty level is set in advance for the expedition game. In the present embodiment, three conditions of required power, maximum number of characters, and required time are set in advance for each dispatch destination as the difficulty level.

In the present embodiment, parties can be dispatched to a plurality of dispatch destinations. At this time, the same ally character cannot be put in parties dispatched to different dispatch destinations.

For example, when the player intends to simultaneously dispatch parties to many dispatch destinations, the player needs to distribute ally characters having relatively high power to many parties so that the power of each party satisfies the required power by a minimum amount. In this case, although a significant reduction in the time required for each dispatch destination cannot be expected, parties can be simultaneously dispatched to many dispatch destinations.

Further, for example, in a case where the purpose is to reduce the required time at a dispatch destination, the player concentrates ally characters having relatively high power into a small number of parties. Accordingly, the power of each party greatly exceeds the required power. In this case, instead of narrowing down the dispatch destinations to be simultaneously dispatched to, the required time for each dispatch destination can be reduced.

As described above, when the automatic formation setting operation portion 113 of the menu screen 110 (FIG. 8A) is operated (tapped) by the player, the automatic formation setting screen 160 (FIG. 12A) is displayed. FIG. 12A is a first diagram for describing an example of the automatic formation setting screen 160. FIG. 12B is a second diagram for describing an example of the automatic formation setting screen 160.

As described above, the automatic formation function is provided for automatically forming a party of ally characters to be dispatched to a dispatch destination selected by a player. In the present embodiment, a first automatic formation function and a second automatic formation function are provided as automatic formation functions.

The first automatic formation function is a function of automatically forming a party of the ally characters with priority given to satisfying the required power with the power of the party by a minimum amount. The player can simultaneously dispatch parties to a relatively large number of dispatch destinations by using the first automatic formation function.

The second automatic formation function is function of automatically forming a party of the ally characters with priority given to making the power of the party the highest possible. The player can reduce the required time at the dispatch destination by using the second automatic formation function.

In other words, the formation information (party formation) can be generated based on the automatic formation function selected by the player from among the first automatic formation function that prioritizes satisfying the minimum condition (party power minimum condition) by the minimum amount and the second automatic formation function that prioritizing satisfying the minimum condition (the party power being equal to or greater than the required power) and increasing the degree of advantage (making the party power greater than the required power to reduce the required time at the dispatch destination), which are automatic formation functions of automatically generating the formation information (party formation).

On the automatic formation setting screen 160, the player can set which of the first automatic formation function and the second automatic formation function is to be used as the automatic formation function. As illustrated in FIGS. 12A and 12B, a first automatic formation function selection portion 161 corresponding to the first automatic formation function and a second automatic formation function selection portion 162 corresponding to the second automatic formation function are displayed at a central portion of the automatic formation setting screen 160. When the player operates (taps) the first automatic formation function selection portion 161, the first automatic formation function selection portion 161 is highlighted as illustrated in FIG. 12A. When the player operates (taps) the second automatic formation function selection portion 162, the second automatic formation function selection portion 162 is highlighted as illustrated in FIG. 12B. FIGS. 12A and 12B illustrate a case where a black circle is displayed in the first automatic formation function selection portion 161 or the second automatic formation function selection portion 162 in accordance with a player operation (tap) as a highlighted display. However, the content of the highlighted display is not limited thereto. For example, a check mark may be displayed in the first automatic formation function selection portion 161 or the second automatic formation function selection portion 162 in accordance with a player operation (tap) as a highlighted display.

In addition, as illustrated in FIGS. 12A and 12B, a setting operation portion 163 denoted by “Set” is displayed at a lower portion of the automatic formation setting screen 160. When the setting operation portion 163 is operated (tapped) by the player in the case where the first automatic formation function selection portion 161 is highlighted (FIG. 12A), the first automatic formation function is set as the automatic formation function. When the setting operation portion 163 is operated (tapped) by the player in the case where the second automatic formation function selection portion 162 is highlighted (FIG. 12B), the second automatic formation function is set as the automatic formation function. When the player operates (taps) the setting operation portion 163, the display of the automatic formation setting screen 160 is ended, and the menu screen 110 (FIG. 8A) is displayed on the display 26.

When any one of the dispatch destination selection operation portions 101 of the dispatch destination selection screen 100 (FIG. 7B) is operated (tapped) by the player, the formation screen 170 (FIG. 13A) for forming a party to be dispatched to the corresponding type of dispatch destination is displayed on the display 26.

FIG. 13A is a first diagram for describing an example of the formation screen 170. FIG. 13B is a second diagram for describing an example of the formation screen 170. Note that FIG. 13B illustrates a case where the power of the party formed by the player is the same as the required power. FIG. 13C is a third diagram for describing an example of the formation screen 170. Note that FIG. 13C illustrates a case where the power of the party formed by the player is greater than the required power.

Hereinafter, a case where the first dispatch destination selection operation portion 101a corresponding to “Dispatch destination A-1” is operated (tapped) and the formation screen 170 is displayed will be described. For “Dispatch destination A-1” the required time is set to 1 hour and 30 minutes, the maximum number of characters is set to 5, and the required power is set to 800000 as the play conditions, as described above.

As illustrated in FIG. 13A, a list display portion 171 in which ally characters that can be put in the party are displayed in a list in the formation screen 170. The player can form a party of the desired ally characters by operating (tapping) the ally characters displayed in the list display portion 171.

FIG. 13A illustrates an example in which the levels of the ally characters displayed in the list display portion 171 are displayed. However, the power of each ally character displayed in the list display portion 171 may be displayed.

As described above, in the present embodiment, the same ally character cannot be put in a party for a plurality of dispatch destinations. Thus, in a case where an ally character (hereinafter referred to as an unavailable character) is already in a party dispatched to another dispatch destination, an unavailable display 171x is attached to the unavailable character. In other words, it is possible to notify the player of an unavailable character via the unavailable display 171x.

Further, as illustrated in FIG. 13A, a drop target display portion 172a and a non-drop target display portion 172b are displayed on the formation screen 170. In the drop target display portion 172a, ally characters in the party as special item drop targets that can obtain special items are displayed. In the non-drop target display portion 172b, ally characters in the party that are not special item drop targets that can obtain special items are displayed.

When the player operates (taps) an ally character displayed in the list display portion 171, the operated (tapped) ally character is highlighted as illustrated in FIGS. 13B and 13C. FIGS. 13B and 13C illustrate an example in which the ally character operated (tapped) by the player is grayed out as a highlighted display. However, the content of the highlighted display is not limited thereto. For example, as the highlighted display, the border of the ally character operated (tapped) by the player may be thickened.

The ally characters are displayed in a left-aligned manner in the drop target display portion 172a and the non-drop target display portion 172b in the operated (tapped) order.

In addition, as illustrated in FIGS. 13B and 13C, an identification display 171a that enables identification of the operated (tapped) order is attached to the ally characters of the list t display portion 171 that are highlighted. In FIGS. 13B and 13C, numbers (“1” to “15”) corresponding to the operated (tapped) order are assigned as the identification display 171a. That is, smaller numerical values represent an earlier operated (tapped) order. However, the content of the identification display 171a is not limited thereto. For example, a symbol corresponding to the operated (tapped) order may be displayed.

In addition, the player can exclude the operated (tapped) ally character from the party being formed by operating (tapping) the ally character in the highlighted list display portion 171 again.

Further, a required power display portion 173a is displayed on the formation screen 170. In the required power display portion 173a, the required power set for the dispatch destination (here, “Dispatch destination A-1”) is displayed as the denominator, and the power of the party being formed is displayed as the numerator. Specifically in the case of FIG. 13B, 800000 is the power of the party formed by the player displayed as the numerator in the required power display portion 173a, and 800000 is the required power displayed as the denominator in the required power display portion 173a, for example. In the case of FIG. 13C, 1200000 is the power of the party formed by the player displayed as the numerator in the required power display portion 173a, and 800000 is the required power displayed as the denominator in the required power display portion 173a.

Further, a required time display portion 173b is displayed on the formation screen 170. In the required time display portion 173b, the required time set for the dispatch destination (here, “Dispatch destination A-1”) is displayed. Specifically in the case of FIG. 13B, a required time of 1 hour 30 minutes is displayed in the required time display portion 173b, for example. When the required time is reduced according to the power of the formed party, the post-reduction required time (for example, one hour) and the amount of time reduced from the pre-reduction required time (for example, −30 minutes) are displayed in the required time display portion 173b as illustrated in FIG. 13C.

Further, a maximum number of characters display portion 173c is displayed on the formation screen 170. In the maximum number of characters display portion 173c, the maximum number of characters set for the dispatch destination (here, “Dispatch destination A-1”) is displayed as the denominator, and the number of characters in the party being formed is displayed as the numerator. Specifically, before the player forms a party of the ally characters, as illustrated in FIG. 13A, “0” is the number of ally characters put in the party by the player displayed as the numerator in the maximum number of characters display portion 173c, and “5” is the maximum number of characters displayed as the denominator in the maximum number of characters display portion 173c, for example. Also, when the player has formed a party of five ally characters, as illustrated in FIGS. 13B and 13C, “5” is the number of ally characters put in the party by the player displayed as the numerator in the maximum number of characters display portion 173c, and “5” is the maximum number of characters displayed as the denominator in the maximum number of characters display portion 173c.

As described above, in the present embodiment, the automatic formation function is provided for automatically forming a party to be dispatched to the dispatch destination. As illustrated in FIG. 13A, an automatic formation operation portion 174 for using the automatic formation function is displayed on the formation screen 170. When the automatic formation operation portion 174 is operated (tapped) by the player, the automatic formation function (the first automatic formation function or the second automatic formation function) of the type set by the player on the automatic formation setting screen 160 (FIGS. 12A and 12B) is used, and the party is automatically formed.

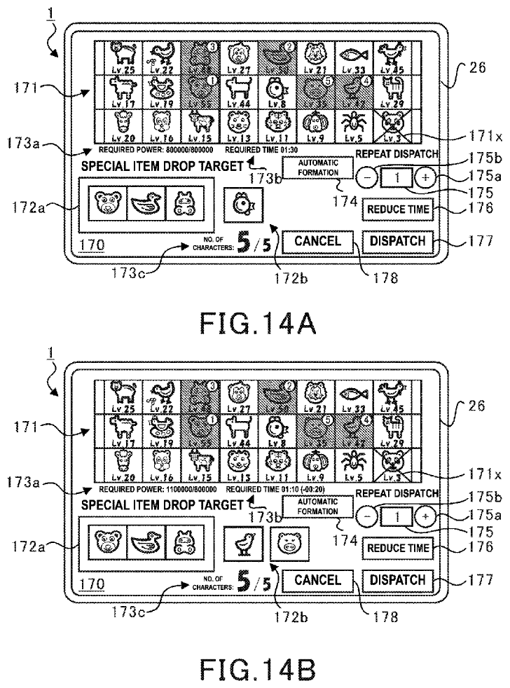

FIG. 14A is a diagram for describing an example of the formation screen 170 when the first automatic formation function is used. When the first automatic formation function is used, as illustrated in FIG. 14A three ally characters with high priority are preferentially put into the party and displayed in the drop target display portion 172a from among the ally characters set as priority targets by the player. When there is a party that has already been dispatched to another dispatch destination, three ally characters with high priority excluding the unavailable characters are preferentially put into the party from among the ally characters set as priority targets.

Further, as illustrated in FIG. 14A, the ally characters not set as the priority targets are put in the party so that the power of the party satisfies the required power by a minimum amount and are displayed in the non-drop target display portion 172b. When there is a party that has already been dispatched to another dispatch destination, the priority targets and the ally characters other than the unavailable characters are put into the party so that the power of the party satisfies the required power by a minimum amount.

In the case illustrated in FIG. 14A, a party is formed of three ally characters displayed in the drop target display portion 172a and one ally character displayed in the non-drop target display portion 172b.

In the present embodiment, specifically, three ally characters with high priority excluding unavailable characters are first preferentially put into a party, when the first automatic formation function is used. In a case where the total power of the three ally characters is equal to or greater than the required power, the party formed by the first automatic formation function includes only these three ally characters.

On the other hand, in a case where the total power of the three ally characters is less than the required power, ally characters not set as priority targets are further put into the party. Specifically, from among the ally characters that are not set as priority targets and that are available, the ally characters having a high power are put into the party in order until the power of the party satisfies the required power. That is, the total number of ally characters put into the party using the first automatic formation function corresponds to an indeterminate value (a value between three and the maximum number of characters).

However, the present invention is not limited thereto, and in a case where the first automatic formation function is used ally characters with high priority excluding unavailable characters may be put in the party in order until the power of the party satisfies the required power. That is, when the required power is reached with one or two characters as a result of putting ally characters with high priority excluding unavailable characters into the party in order, a party may be formed of only one or two ally characters.

FIG. 14B is a diagram for describing an example of the formation screen 170 when the second automatic formation function is used. When the second automatic formation function is used, as illustrated in FIG. 14B three ally characters with high priority are preferentially put into the party and displayed in the drop target display portion 172a from among the ally characters set as priority targets by the player. When there is a party that has already been dispatched to another dispatch destination, three ally characters with high priority excluding the unavailable characters are preferentially put into the party from among the ally characters set as priority targets.

Further, as illustrated in FIG. 14B, the ally characters not set as the priority targets are put in the party so that the power of the party is the highest possible and are displayed in the non-drop target display portion 172b. When there is a party that has already been dispatched to another dispatch destination, the priority targets and the ally characters other than the unavailable characters are put into the party so that making the power of the party greater than the required power is prioritized.

In other words, in the case illustrated in FIG. 14B, a party is formed of three ally characters displayed in the drop target display portion 172a and two ally character displayed in the non-drop target display portion 172b.

In the present embodiment, specifically three ally characters with high priority excluding unavailable characters are first preferentially put into a party, when the second automatic formation function is used. Further, ally characters not set as priority targets are further put into the party. Specifically, from among the ally characters that are not set as priority targets and that are available, the ally characters having a high power are put into the party until the maximum number of characters that can fit in the party is reached. In other words, by forming a party using the second automatic formation function, a party of the maximum number of ally characters is formed.

As described above, in the present embodiment, it is not essential to set an ally character as the priority target. In a case where the ally character is not set as the priority target, when the first automatic formation function is used, a party of the ally characters is formed such that the power of the party satisfies the required power by a minimum amount. Specifically, from among the available ally characters the ally characters having a high power may be put into the party in order until the power of the party satisfies the required power, for example. In this case, the total number of ally characters in the party is an indeterminate value. In a case where the power of the party is equal to or greater than the required power at the stage where three ally characters with high power have been put in the party from among the available ally characters, the party formed by the first automatic formation function includes only these three ally characters.

In a case where the ally character is not set as the priority target, a party of the ally characters is formed such that making the power of the party as high as possible is prioritized, when the second automatic formation function is used. Specifically, from among the ally characters that are available, the ally characters having a high power are put into the party until the maximum number of characters that can fit in the party is reached. In other words, by forming a party using the second automatic formation function, a party of the maximum number of ally characters is formed.

As described above, in the present embodiment, a repeat dispatch function is provided which enables the player to freely designate the number of times to dispatch the formed party to the dispatch destination. FIG. 15A is a fourth diagram for describing an example of the formation screen 170. As illustrated in FIG. 15A, a number of repeated dispatches display portion 175, an increase number of repeated dispatches operation portion 175a, and a decrease number of repeated dispatches operation portion 175b are displayed in the formation screen 170.

The currently set number of dispatches is displayed in the number of repeated dispatches display portion 175. When the player operates (taps) the increase number of repeated dispatches operation portion 175a, the number of dispatches is increased by one, and the display of the number of repeated dispatches display portion 175 is updated. When the player operates (taps) the decrease number of repeated dispatches operation portion 175b, the number of dispatches is decreased by one, and the display of the number of repeated dispatches display portion 175 is updated. In the present embodiment, the minimum value of the number of dispatches displayed in the number of repeated dispatches display portion 175 is one.

When the number of dispatches is set to a plurality of times, the required time displayed in the required time display portion 173b is updated according to the set number of dispatches as illustrated in FIG. 15A. For example, in the case where the required time required for one dispatch is 1 hour and 30 minutes, when the number of dispatches is set to 4, the display is updated to 6 hours as illustrated in FIG. 15A.

As described above, in the expedition game, the required time required for one dispatch is set to be relatively longer than the time required for one battle game. Thus, in the present embodiment, a time reduction function is provided for reducing the required time for the expedition game in addition to increasing the power of the party and reducing the required time. That is, in the present embodiment, it is possible to simultaneously use both the time reduction function and the reducing of the required time by increasing the power of the party.

As illustrated in FIG. 15A, a time reduction operation portion 176 is displayed on the formation screen 170. When the player operates (taps) the time reduction operation portion 176, the time reduction screen 180 described below is displayed on the display 26.

FIG. 15B is a first diagram for describing an example of the time reduction screen 180. In the present embodiment, a first time reduction function is provided as a time reduction function of reducing the required time by using a predetermined item (time reduction ticket) owned by the player. Specifically, the player can reduce the required time by one hour by spending one time reduction ticket. Note that a limit may be placed on the number of time reduction tickets that can be spent within a preset period. For example, up to 99 time reduction tickets may be spent per day. In this case, in one day, the required time can be reduced up to a maximum of 99 hours by spending time reduction tickets.

As illustrated in FIG. 15B, a reduction number display portion 181, an increase reduction number operation portion 181a, and a decrease reduction number operation portion 181b relating to the first time reduction function are displayed on the time reduction screen 180.

The number of time reduction tickets to be spent is displayed in the reduction number display portion 181. When the player operates (taps) the increase reduction number operation portion 181a, the number of time reduction tickets to be spent increases by one, and the display of the reduction number display portion 181 is updated. When the player operates (taps) the decrease reduction number operation portion 181b, the number of time reduction tickets to be spent decreases by one, and the display of the reduction number display portion 181 is updated. In the present embodiment, the minimum value of the number of time reduction tickets to be spent displayed in the reduction number display portion 181 is 0.

In the present embodiment, a second time reduction function is provided as a time reduction function of reducing the required time by using predetermined in-game currency (jewels) owned by the player. Specifically, the player can reduce the required time by one hour by spending a predetermined number of jewels at one time. The number of jewels required for one hour reduction is not a fixed value and may be varied. For example, the number of required jewels may be increased as the number of times used increases, such as 80 jewels for the first time, 100 jewels for the second time, and 120 jewels for the third time.

Note that a limit may be placed on the number of times that the required time can be reduced by spending a predetermined number of jewels within a preset period. For example, up to 99 times per day, a predetermined number of jewels may be spent to reduce the required time. In this case, in one day, the required time can be reduced up to a maximum of 99 hours by spending jewels.

As illustrated in FIG. 15B, a reduction number display portion 182, an increase reduction number operation portion 182a, and a decrease reduction number operation portion 182b relating to the second time reduction function are displayed on the time reduction screen 180.

The number of times a predetermined number of jewels is to be spent is displayed in the reduction number display portion 182. When the player operates (taps) the increase reduction number operation portion 182a, the number of times a predetermined number of jewels is to be spent increases by one, and the display of the reduction number display portion 182 is updated. When the player operates (taps) the decrease reduction number operation portion 182b, the number of times a predetermined number of jewels is to be spent decreases by one, and the display of the reduction number display portion 182 is updated. In the present embodiment, the number of times a predetermined number of jewels is to be spent displayed in the reduction number display portion 182 is 0.

A required time display portion 183 is displayed on the time reduction screen 180. As illustrated in FIG. 15B, when the player has input to spend two time reduction tickets and to spend the predetermined number of jewels twice, the pre-reduction required time (for example, 6 hours), the post-reduction required time (for example, 2 hours), and the amount of time reduced from the pre-reduction required time (for example, −4 hours) are displayed on the required time display portion 183.

Further, as illustrated in FIG. 15B, a setting operation portion 184 denoted by “Set” and a cancel operation portion 185 denoted by “Cancel” are displayed in the time reduction screen 180.

When the cancel operation portion 185 of the time reduction screen 180 is operated (tapped) by the player, the content displayed on the time reduction screen 180 immediately before the operation (tapping) is discarded. In addition, the display of the time reduction screen 180 ends, and the formation screen 170 (FIG. 15A) displayed immediately before the operation (tapping) of the time reduction operation portion 176 is displayed on the display 26.

When the setting operation portion 184 is operated (tapped) by the player, the time reduction function is set with the content displayed on the time reduction screen 180 immediately before the operation (tapping). In addition, the display of the time reduction screen 180 ends, and the formation screen 170 (FIG. 15C) is displayed on the display 26.

FIG. 15C is a fifth diagram for describing an example of the formation screen 170. FIG. 15C illustrates the formation screen 170 displayed on the display 26 when the player operates (taps) the setting operation portion 184 of the time reduction screen 180 illustrated in FIG. 15B. As illustrated in FIG. 15C, in the required time display portion 173b of the formation screen 170, the pre-reduction required time (for example, 6 hours), the post-reduction required time (for example, 2 hours), and the amount of time reduced from the pre-reduction required time (for example, −4 hours) are displayed according to the content of the time reduction function set as described above.

Further, as illustrated in FIG. 15C, a dispatch operation portion 177 denoted by “Dispatch” and a cancel operation portion 178 denoted by “Cancel” are displayed in the formation screen 170.

When the cancel operation portion 178 is operated (tapped) by the player, the content displayed on the formation screen 170 immediately before the operation (tapping) is discarded. In addition, the display of the formation screen 170 ends, and the dispatch destination selection screen 100 (FIG. 7B) is displayed on the display 26.

When the power of the party is less than the required power, the dispatch operation portion 177 is displayed in an inoperable state on the formation screen 170 as illustrated in FIG. 13A. On the other hand, when the power of the party is equal to or greater than the required power, the dispatch operation portion 177 is displayed in an operable state on the formation screen 170 as illustrated in FIGS. 13B, 13C, 14A, 14B, 15A, and 15C.

As illustrated in FIG. 15C, when the use of the time reduction function is set and the dispatch operation portion 177 in an operable state in the formation screen 170 is operated (tapped) by the player, the confirmation screen 190 (FIG. 16A) is displayed on the display 26. In a case where the use of the time reduction function is not set and the dispatch operation portion 177 in an operable state in the formation screen 170 is operated (tapped) by the player, the confirmation screen 190 (FIG. 16A) is not displayed on the display 26, and the expedition start animation screen 200 (FIG. 16B) described below is displayed on the display 26 for a predetermined amount of time to notify the player of the start of the expedition game.

FIG. 16A is a diagram for describing an example of the confirmation screen 190. As illustrated in FIG. 16A, on the confirmation screen 190, the player is notified that time reduction tickets and jewels will be spent by using the time reduction function.

In the case illustrated in FIG. 16A, the required time required for one dispatch to the “Dispatch destination A-1” is 1 hour and 30 minutes and the number of dispatches is set to 4, making the total required time displayed 6 hours. The expedition time being reduced by 4 hours by using the time reduction function is displayed. When the expedition game is started under this condition, the first two dispatches are immediately completed (cleared) by the time reduction function. Then, the third dispatch is reduced by 1 hour, and the remaining required time becomes 30 minutes. In addition, the required time for the fourth dispatch is not reduced and is 1 hour and 30 minutes. That is, when the time reduction function is used, the time is reduced in ascending order of the order the dispatches that are repeatedly executed.

Further, as illustrated in FIG. 16A, an OK operation portion 191 denoted by “OK” and a cancel operation portion 192 denoted by “Cancel” are displayed in the confirmation screen 190. When the cancel operation portion 192 is operated (tapped) by the player, the display of the confirmation screen 190 is finished, and the formation screen 170 (FIG. 15C) displayed immediately before the operation (tapping) of the dispatch operation portion 177 is displayed on the display 26.

When the OK operation portion 191 is operated (tapped) by the player, the expedition game is started. Then, the expedition start animation screen 200 (FIG. 16B) described below is displayed on the display 26 for a predetermined amount of time, and the player is notified of the start of the expedition game.

FIG. 16B is a diagram for describing an example of the expedition start animation screen 200. As illustrated in FIG. 16B, a predetermined animation image for notifying the player that the expedition game has started is displayed for a predetermined amount of time (for example, 3 seconds) on the expedition start animation screen 200. The ally characters to be dispatched in the expedition are displayed on the expedition start animation screen 200. Specifically, for example, all of the ally characters in the party or a predetermined number of ally characters from among the ally characters in the party are displayed on the expedition start animation screen 200.

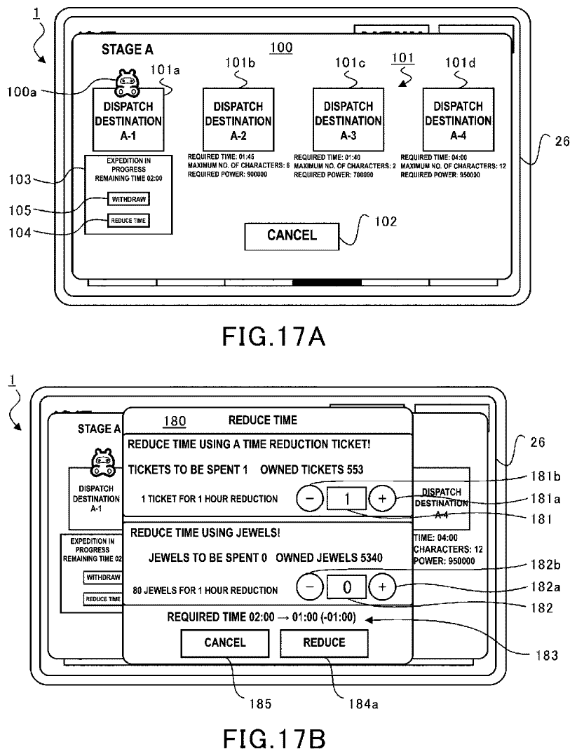

When a predetermined amount of time (for example, 3 seconds) has elapsed, the display of the expedition start animation screen 200 on the display 26 ends. Then, in a case where use of the time reduction function is set for the started expedition game, the time reduction animation screen 210 illustrated in FIG. 16C described below is displayed on the display 26 for a predetermined amount of time. In a case where use of the time reduction function is not set for the started expedition game, the dispatch destination selection screen 100 illustrated in FIG. 17A described below is displayed on the display 26.

FIG. 16C is a diagram for describing an example of the time reduction animation screen 210. As illustrated in FIG. 16C, a predetermined animation image for notifying the player that the time reduction function has been used for the started expedition game is displayed on the time reduction animation screen 210 for a predetermined amount of time (for example, 3 seconds).

When a predetermined amount of time (for example, 3 seconds) has elapsed, the display of the time reduction animation screen 210 on the display 26 ends. Then, the dispatch destination selection screen 100 illustrated in FIG. 17A described below is displayed on the display 26.

FIG. 17A is a diagram for describing an example of the dispatch destination selection screen 100 during execution of the expedition game. FIG. 17B is a diagram illustrating an example of the time reduction screen 180 during execution of the expedition game. As illustrated in FIG. 17A an in-expedition display 103 is displayed on the dispatch destination selection screen 100 during execution of the expedition game at a lower portion of the dispatch destination selection operation portion 101 corresponding to the dispatch destination during execution of the expedition game.

Also, as illustrated in FIG. 17A a representative character 100a is displayed on the dispatch destination selection screen 100 during execution of the expedition game in the dispatch destination selection operation portion 101 corresponding to the dispatch destination during execution of the expedition game. In the present embodiment, when the party to be dispatched to a dispatch destination is formed, an ally character is displayed on the formation screen 170 as the representative character 100a. However, the present invention is not limited thereto, and when a party to be dispatched to a dispatch destination is formed, the ally character having the highest power from among the ally characters in the party may be displayed as the representative character 100a.

FIG. 17A illustrates a case where a party is dispatched to “Dispatch destination A-1” and an expedition game is executed. In this case, the in-expedition display 103 is displayed at a lower portion of the first dispatch destination selection operation portion 101a.

As illustrated in FIG. 17A, the remaining time until completion (clearing) of the “Dispatch destination A-1” during execution of the expedition game is displayed in the in-expedition display 103. In the illustrated example, the remaining time displayed is 2 hours.

As addition, as illustrated in FIG. 17A, a time reduction operation portion 104 denoted by “Reduce time” and a withdraw operation portion 105 denoted by “Withdraw” are displayed in the in-expedition display 103. As described above, in the present embodiment, the player can reduce the remaining time of the required time by using the time reduction function when dispatching a party to the dispatch destination. Further, in the present embodiment, the time reduction function can be used even after the start of execution of the expedition game. When the time reduction operation portion 104 is tapped by the player, the time reduction screen 180 (FIG. 17B) is displayed on the display 26. The time reduction screen 180 of FIG. 17B has the same function as the time reduction screen 180 of FIG. 15B described above.

In other words, as illustrated in FIG. 17B, the reduction number display portion 181, the increase reduction number operation portion 181a, and the decrease reduction number operation portion 181b are displayed on the time reduction screen 180, the reduction number display portion 181, the increase reduction number operation portion 181a, and the decrease reduction number operation portion 181b relating to the first time reduction function of reducing the remaining time of the required time of the expedition game after the start of execution using a time reduction ticket owned by the player.

The number of time reduction ticket to be spent is displayed in the reduction number display portion 181. When the player operates (taps) the increase reduction number operation portion 181a, the number of time reduction tickets to be spent increases by one, and the display of the reduction number display portion 181 is updated. When the player operates (taps) the decrease reduction number operation portion 181b, the number of time reduction tickets to be spent decreases by one, and the display of the reduction number display portion 181 is updated.

Also, as illustrated in FIG. 17B, the reduction number display portion 182, the increase reduction number operation portion 182a, and the decrease reduction number operation portion 182b relating to the second time reduction function of reducing the remaining time of the required time of the expedition game after the start of execution using jewels owned by the player are displayed on the time reduction screen 180.

The number of times a predetermined number of jewels is to be spent is displayed in the reduction number display portion 182. When the player operates (taps) the increase reduction number operation portion 182a, the number of times a predetermined number of jewels is to be spent increases by one, and the display of the reduction number display portion 182 is updated. When the player operates (taps) the decrease reduction number operation portion 182b, the number of times a predetermined number of jewels is to be spent decreases by one, and the display of the reduction number display portion 182 is updated.

A required time display portion 183 is displayed on the time reduction screen 180. As illustrated in FIG. 17B, when the player has input to spend a time reduction ticket and not spend the predetermined number of jewels, the remaining time of the pre-reduction required time (for example, 2 hours), the remaining time of the post-reduction required time (for example, 1 hour), and the amount of time reduced from the remaining time of the pre-reduction required time (for example, −1 hour) are displayed on the required time display portion 183.

Further, as illustrated in FIG. 17B, a reduction operation portion 184a denoted by “Reduce” and the cancel operation portion 185 denoted by “Cancel” are displayed in the time reduction screen 180.

When the cancel operation portion 185 of the time reduction screen 180 is operated (tapped) by the player, the content displayed on the time reduction screen 180 immediately before the operation (tapping) is discarded. In addition, the display of the time reduction screen 180 ends, and the dispatch destination selection screen 100 (FIG. 17A) is displayed on the display 26.

When the reduction operation portion 184a is operated (tapped) by the player, the confirmation screen 220 (FIG. 18A) for the player to confirm use of the time reduction function is displayed with the content displayed on the time reduction screen 180 immediately before the operation (tapping). FIG. 18A is a diagram for describing an example of the confirmation screen 220 for the player to confirm use of the reduction function during execution of the expedition game.

As illustrated in FIG. 18A, on the confirmation screen 220, the player is notified that time reduction tickets and jewels will be spent by using the time reduction function.

Further, as illustrated in FIG. 18A, a reduction operation portion 221 denoted by “Reduce” and a cancel operation portion 222 denoted by “Cancel” are displayed in the confirmation 220. When the cancel operation portion 222 is operated (tapped) by the player, the display of the confirmation screen 190 is finished, and time reduction screen 180 (FIG. 17B) displayed immediately before the operation (tapping) of the reduction operation portion 184a is displayed on the display 26.

In addition, when the player operates (taps) the reduction operation portion 221, the reduction function is used, and the time reduction animation screen 210 illustrated in the above-described FIG. 16C is displayed on the display 26 for a predetermined amount of time. When a predetermined amount of time has elapsed, the display of the time reduction animation screen 210 on the display 26 ends. Then, the dispatch destination selection screen 100 illustrated in FIG. 18B described below is displayed on the display 26.

FIG. 18B is a diagram for describing an example of the dispatch destination selection screen 100 in a case where the reduction function is used during execution of the expedition game. As illustrated in FIG. 18B, the remaining time until completion (clearing) of the “Dispatch destination A-1” during execution of the expedition game is displayed in the in-expedition display 103 of the dispatch destination selection screen 100. In the illustrated example, the remaining time is reduced by 1 hour by the reduction function and the remaining time displayed is 1 hour.

As described above, in the present embodiment, the same ally character cannot be put in a party for a plurality of dispatch destinations. That is, in a case where character is dispatched to the a predetermined ally expedition game being executed, the predetermined ally character cannot be dispatched to another dispatch destination. Thus, in the present embodiment, a withdraw function is provided that allows the player to withdraw the party from the expedition game being executed and cancel the expedition game being executed. By using the withdraw function, a predetermined ally character desired by the player can be dispatched to another dispatch destination.

As illustrated in FIG. 18B, the withdraw operation portion 105 denoted by “Withdraw” is displayed in the in-expedition display 103 of the dispatch destination selection screen 100. When the player operates (taps) the withdraw operation portion 105, the withdraw confirmation screen 230 (FIG. 19A) for the player to confirm use of the withdraw function is displayed on the display 26.

FIG. 19A is a diagram for describing an example of the withdraw confirmation screen 230. As illustrated in FIG. 19A, in a case where the withdraw function is used, the player is notified in the withdraw confirmation screen 230 that the reward of the uncompleted (not cleared) expedition game cannot be obtained, the remaining time of the required time will be reset, and the time reduction ticket or jewels used for time reduction will not be returned. In a case where the withdraw function is used when the repeat dispatch function has been used and a plurality of dispatches to the dispatch destination has been set, the player can receive a reward relating to the expedition game for the number of completed (cleared) dispatches from among the plurality of dispatches.

As illustrated in FIG. 19A, on the withdraw confirmation screen 230, a cancel operation portion 231 denoted by “Cancel” and an OK operation portion 232 denoted by “OK” are displayed. When the cancel operation portion 231 is operated (tapped) by the player, the withdraw function is not used and the display of the withdraw confirmation screen 230 is ended. Then, the dispatch destination selection screen 100 (FIG. 18B) is displayed again on the display 26.

When the OK operation portion 232 is operated (tapped) by the player, the withdraw function is used, and the expedition withdraw screen 240 (FIG. 19B) is displayed on the display 26.

FIG. 19B is a diagram for describing an example of the expedition withdraw screen 240. As illustrated in FIG. 19B the player is notified in the expedition withdraw screen 240 that the player has withdrawn from the dispatch destination of the type corresponding to the withdraw operation portion 105 (FIG. 18B) operated by the player. In FIG. 19B, the player is notified of the withdrawal from “Dispatch destination A-1”.

Further, as illustrated in FIG. 19B, a close operation portion 241 denoted by “Close” is displayed on the expedition withdraw screen 240. When the player operates (taps) the close operation portion 241, the display of the expedition withdraw screen 240 is ended, and the dispatch destination selection screen 100 (FIG. 7B) is displayed on the display 26. On the dispatch destination selection screen 100 displayed at this time, the in-expedition display 103 (FIG. 17A) corresponding to the withdrawn dispatch destination is not displayed.

In addition, when the required time elapses without use of the withdraw function, the expedition game is completed (cleared). FIG. 20A is a diagram for describing an example of the dispatch destination selection screen 100 when an expedition is completed. FIG. 20A illustrates a case where “Dispatch destination A-1” is completed (cleared).

As illustrated in FIG. 20A, on the dispatch destination selection screen 100, an expedition completion display 106 is displayed at the lower portion of the dispatch destination selection operation portion 101 corresponding to the completed (cleared) dispatch destination. In addition, as illustrated in FIG. 20A, a result confirmation operation portion 107 denoted by “Check results” is displayed in the expedition completion display 106. When the result confirmation operation portion 107 is operated (tapped) by the player, the expedition completion screen 250 (FIG. 20B) is displayed on the display 26.

FIG. 20B is a diagram for describing an example of the expedition completion screen 250. As illustrated in FIG. 20B, a list of rewards obtained at the dispatch destination of the type corresponding to the result confirmation operation portion 107 (FIG. 20A) operated (tapped) by the player is displayed on the expedition completion screen 250. In addition, when the expedition completion screen 250 is displayed, the player can complete reception of the reward obtained at the dispatch destination. FIG. 20B illustrates a case where a list of the rewards obtained by completion (clearing) of “Dispatch destination A-1” are displayed.

In addition, as illustrated in FIG. 20B, a non-redispatch operation portion 251 denoted by “No redispatch” and a redispatch operation portion 252 denoted by “Redispatch” are displayed on the expedition completion screen 250. When the player taps the non-redispatch operation portion 251, the display of the expedition completion screen 250 is ended, and the dispatch destination selection screen 100 (FIG. 7B) is displayed on the display 26. That is, since the player has received the reward obtained by completing (clearing) “Dispatch destination A-1”, t the expedition completion display 106 (FIG. 20A) is hidden.

When the player operates (taps) the redispatch operation portion 252, the redispatch screen 260 (FIG. 21) for redispatching a party of the same formation to the same dispatch destination is displayed on the display 26.

FIG. 21 is a diagram for describing an example of the redispatch screen 260. As illustrated in FIG. 21, a dispatch destination display portion 261 is displayed on the redispatch screen 260. In the dispatch destination display portion 261, the type of dispatch destination (here, Dispatch destination A-1″) and the play conditions (required power, maximum number of characters, required time) corresponding to the type of dispatch destination are displayed.

As illustrated in FIG. 21, a party display portion 262 is displayed in the dispatch destination display portion 261. In the party display portion 262, the same formation of ally characters as the party previously dispatched to the dispatch destination is displayed. Note that the party display portion 262 may display at least a part of all of the ally characters in the party.

Further, in the present embodiment, the repeat dispatch function can be used on the redispatch screen 260. In the present embodiment, in the case illustrated on the redispatch screen 260, the repeat dispatch function can be used but the time reduction function cannot be used. However, the present invention is not limited thereto, and both the repeat dispatch function and the time reduction function may be enabled on the redispatch screen 260.

As illustrated in FIG. 21, a number of repeated dispatches display portion 264, an increase number of repeated dispatches operation portion 264a, and a decrease number of repeated dispatches operation portion 264b are displayed in the dispatch destination display portion 261.

The currently set number dispatches is displayed in the number of repeated dispatches display portion 264. When the player operates (taps) the increase number of repeated dispatches operation portion 264a, the number of dispatches is increased by one, and the display of the number of repeated dispatches display portion 264 is updated. When the player operates (taps) the decrease number of repeated dispatches operation portion 264b, the number of dispatches is decreased by one, and the display of the number of repeated dispatches display portion 264 is updated. In the present embodiment, the minimum value of the number of dispatches displayed in the number of repeated dispatches display portion 264 is one.

As illustrated in FIG. 21, on the redispatch screen 260, a cancel operation portion 265 denoted by “Cancel” and a dispatch operation portion 266 denoted by “Dispatch” are displayed. When the cancel operation portion 265 is operated (tapped) by the player, the content displayed on the redispatch screen 260 immediately before the operation (tapping) is discarded. In addition, the display of the redispatch screen 260 is ended, and the expedition completion screen 250 (FIG. 20B) displayed immediately before the operation (tapping) of the redispatch operation portion 252 (FIG. 20B) is displayed on the display 26.

When the dispatch operation portion 266 is operated (tapped) by the player, the expedition game is started. Then, the expedition start animation screen 200 (FIG. 16B) described above is displayed on the display 26 for a predetermined amount of time, and the player is notified of the start of the expedition game. When the predetermined amount of time has elapsed, the display of the expedition start animation screen 200 (FIG. 16B) on the display 26 ends, and the dispatch destination selection screen 100 (FIG. 17A) is displayed on the display 26.

FIG. 22A is a diagram for describing an example of the expedition top screen 90 when an expedition is completed. As illustrated in FIG. 22A, when there is an expedition game for which reception of a reward has not been completed or an expedition game that is being executed, the representative character 100a is displayed in the expedition stage selection operation portion 91 corresponding to the stage to which the dispatch destination belongs. It should be noted that an operation portion for displaying a list of parties formed for the expedition games for which reception of a reward has not been completed or the expedition games being executed may be displayed on the expedition top screen 90. In addition, from the displayed list of the parties, it may be possible to confirm the result of the expedition game corresponding to each dispatch destination, that is, to receive a reward.

FIG. 22A illustrates a case where “Dispatch destination A-1” and “Dispatch destination A-2” is completed (cleared). When the expedition collective completion operation portion 94 is operated (tapped) by the player, the expedition collective completion screen 270 (FIG. 22B) is displayed on the display 26. When there are one or more expedition games for which the reception of a reward has not been completed, an identification display indicating that there are one or more expedition games for which the reception of a reward has not been completed may be displayed in the expedition collective completion operation portion 94. Specifically, a number indicating the number of expedition games for which the reception of a reward has not been completed may be displayed as the identification display. Alternatively, specifically, a symbol indicating that there is an expedition game for which the reception of a reward has not been completed may be displayed as the identification display.

As described above, when the expedition collective completion operation portion 94 is operated (tapped) by the player, the expedition collective completion screen 270 (FIG. 22B) is displayed on the display 26. FIG. 22B is a diagram for describing an example of the expedition collective completion screen 270. As illustrated in FIG. 22B, in the expedition collective completion screen 270, a list of rewards obtained at all dispatch destinations for which the required time has elapsed, the expedition game has been completed, and reception of a reward has not been completed is displayed.

In addition, when the expedition collective completion screen 270 is displayed, the player can complete reception of the rewards obtained at the dispatch destinations. FIG. 22B illustrates a case where a list of the rewards obtained by completion (clearing) of “Dispatch destination A-1” and destination “Dispatch A-2” are displayed.

In addition, as illustrated in FIG. 22B, a non-redispatch operation portion 271 denoted by “No redispatch” and a redispatch operation portion 272 denoted by “Redispatch” are displayed on the expedition collective completion screen 270. When the player taps the non-redispatch operation portion 271, the display of the expedition completion screen 250 is ended, and the expedition top screen 90 (FIG. 7A) is displayed on the display 26. That is, since the player has received the reward obtained by completing (clearing) “Dispatch destination A-1” and “Dispatch destination A-2”, the representative character 100a (FIG. 22A) is hidden.

When the player operates (taps) the redispatch operation portion 272, the redispatch screen 280 (FIG. 23) for redispatching a party of the same formation to the same dispatch destination is displayed on the display 26.

FIG. 23 is a diagram for describing an example of the redispatch screen 280. As illustrated in FIG. 23, a dispatch destination display portion 281 is displayed for each dispatch destination type on the redispatch screen 280. In the dispatch destination display portion 281, the type of dispatch destination and the play conditions (required power, maximum number of characters, required time) corresponding to the type of dispatch destination are displayed.

As illustrated in FIG. 23, a party display portion 282 is displayed in the dispatch destination display portion 281. In the party display portion 282, the same formation of ally characters as the party previously dispatched to the dispatch destination is displayed. Note that the party display portion 282 may display at least a part of all of the ally characters in the party.

As illustrated in FIG. 23, a check box 283 is displayed in the dispatch destination display portion 281. By operating (tapping) the check box 283, the player can switch whether to redispatch to the dispatch destination of the type corresponding to the check box 283.

Further, in the present embodiment, the repeat dispatch function can be used on the redispatch screen 280. In the present embodiment, in the case illustrated on the redispatch screen 280, the repeat dispatch function can be used but the time reduction function cannot be used. However, while not limited thereto, both the repeat dispatch function and the time reduction function may be enabled on the redispatch screen 280.

As illustrated in FIG. 23, a number of repeated dispatches display portion 284, an increase number of repeated dispatches operation portion 284a, and a decrease number of repeated dispatches operation portion 284b are displayed in the dispatch destination display portion 281.

The currently set number of dispatches is displayed in the number of repeated dispatches display portion 284. When the player operates (taps) the increase number of repeated dispatches operation portion 284a, the number of dispatches is increased by one, and the display of the number of repeated dispatches display portion 284 is updated. When the player operates (taps) the decrease number of repeated dispatches operation portion 284b, the number of dispatches is decreased by one, and the display of the number of repeated dispatches display portion 284 is updated. In the present embodiment, the minimum value of the number of dispatches displayed in the number of repeated dispatches display portion 284 is one.

As illustrated in FIG. 23, on the redispatch screen 280, a cancel operation portion 285 denoted by “Cancel” and a dispatch operation portion 286 denoted by “Dispatch” are displayed. When the cancel operation portion 285 is operated (tapped) by the player, the content displayed on the redispatch screen 280 immediately before the operation (tapping) is discarded. In addition, the display of the redispatch screen 280 is ended, and the expedition collective completion screen 270 (FIG. 22B) displayed immediately before the operation (tapping) of the redispatch operation portion 272 (FIG. 22B) is displayed on the display 26.

When the dispatch operation portion 286 is operated (tapped) by the player, the expedition game is started. Then, the expedition start animation screen 200 (FIG. 16B) described above is displayed on the display 26 for a predetermined amount of time, and the player is notified of the start of the expedition game. When the predetermined amount of time has elapsed, the display of the expedition start animation screen 200 (FIG. 16B) on the display 26 ends, and the expedition top screen 90 (FIG. 22A) is displayed on the display 26.

As described above, in the present embodiment, parties can be dispatched to a plurality of dispatch destinations. Specifically, by repeating a series of operations including selecting a desired dispatch destination on the dispatch destination selection screen 100 (FIG. 7B), forming a party on the formation screen 170 (FIGS. 13A and 13B), and operating the dispatch operation portion 177, a party can be dispatched to each one of a plurality of dispatch destinations. However, with the above-described method, when dispatching a party to each one of a large number of dispatch destinations, the player operations become complicated. Thus, player-friendliness may be reduced.

In the present embodiment, a batch expedition function is provided as a function for facilitating the dispatch of parties to each one of a plurality of dispatch destinations. In the upper portion of the expedition top screen 90 (FIG. 7A), the batch expedition selection operation portion 93 is displayed. When the player operates (taps) the batch expedition selection operation portion 93, the batch expedition (FIG. 24A) for using the batch expedition function is displayed on the display 26.

FIG. 24A is a first diagram for describing an example of the batch expedition screen 290. Also, FIG. 24B is a second diagram for describing an example of the batch expedition screen 290. As illustrated in FIG. 24A, one or more dispatch destination display portions 291 corresponding to the types of dispatch destinations are displayed in a central portion of the batch expedition screen 290. In the initial state, the dispatch destination display portions 291 corresponding to all the dispatch destination types are displayed on the batch expedition screen 290.

In the dispatch destination display portion 291, the player can form a party to be dispatched to each dispatch destination. A manual formation operation portion 292 denoted by “Form manually” and an automatic formation operation portion 293 denoted by “Form automatically” are displayed in the dispatch destination display portion 291. When the player operates (taps) the manual formation operation portion 292, a formation screen (not illustrated) for the batch expedition is displayed on the display 26. On the formation screen (not illustrated) for the batch expedition, the party formation can be set based on a player operation. The displayed content and functions of the formation screen (not illustrated) for the batch expedition can be similar to those of the formation screen 170.

When the automatic formation operation portion 293 is operated (tapped) by the player, the automatic formation function (the first automatic formation function or the second automatic formation function) of the type set by the player on the automatic formation setting screen 160 (FIGS. 12A and 12B) is used, and the party is automatically formed.

The dispatch destination display portion 291 is provided with a special drop item target display portion 294. When the party is formed as described above, the ally character set as the special item drop target that can obtain a special item is displayed in the special drop item target display portion 294 as illustrated in FIG. 24B.

Further, in the present embodiment, the repeat dispatch function can be used on the batch expedition screen 290. As illustrated in FIG. 24A, a number of repeated dispatches display portion 295, an increase number of repeated dispatches operation portion 295a, and a decrease number of repeated dispatches operation portion 295b are displayed in the dispatch destination display portion 291. The currently set number of dispatches is

displayed in the number of repeated dispatches display portion 295. When the player operates (taps) the increase number of repeated dispatches operation portion 295a, the number of dispatches is increased by one, and the display of the number of repeated dispatches display portion 295 is updated. When the player operates (taps) the decrease number of repeated dispatches operation portion 295b, the number of dispatches is decreased by one, and the display of the number of repeated dispatches display portion 295 is updated. In the present embodiment, the minimum value of the number of dispatches displayed in the number of repeated dispatches display portion 295 is one.

Further, in the present embodiment, the time reduction function can be used on the batch expedition screen 290. As illustrated in FIG. 24A, a time reduction operation portion 296 denoted by “Reduce time” is displayed in the dispatch destination display portion 291.

When the player operates (taps) the time reduction operation portion 296, a time reduction screen (not illustrated) for the batch expedition is displayed on the display 26. On the time reduction screen (not illustrated) for the batch expedition, it is possible to set the details of the time reduction function based on a player operation. The displayed content and functions of the time reduction screen (not illustrated) for the batch expedition can be similar to those of the time reduction screen 180.

As illustrated in FIG. 24A, a clear operation portion 297 denoted by “Clear” is displayed in the dispatch destination display portion 291. When the player operates (taps) the clear operation portion 297, the party content for the dispatch destination of the type corresponding to the operated (tapped) clear operation portion 297 is discarded. Further, the ally characters displayed in the special drop item target display portion 294 are hidden.

As illustrated in FIG. 24A, a party clear operation portion 298 denoted by “Clear parties” is displayed in the batch expedition screen 290. When the party clear operation portion 298 is operated (tapped) by the player, the party content for all the dispatch destinations being displayed on the batch expedition screen 290 is discarded. Further, the ally characters displayed in the special drop item target display portion 294 are hidden.

As illustrated in FIG. 24A, a check box 299 is displayed in the dispatch destination display portion 291. By operating (tapping) the check box 299, the player can switch whether to dispatch to the dispatch destination of the type corresponding to the check box 299.

As addition, as illustrated in FIG. 24A, a remove all checks operation portion 300 denoted by “Remove all checks” is displayed in the batch expedition screen 290. When the player operates (taps) the remove all checks operation portion 300, all the checks in the check boxes 299 displayed on the batch expedition screen 290 are removed.

Further, as illustrated in FIG. 24A, a priority setting operation portion 301 denoted by “Priority settings” is displayed on the batch expedition screen 290. When the priority setting operation portion 301 is operated (tapped) by the player, the priority setting screen 130 (FIG. 9B) described above is displayed on the display 26. When the priority is set on the priority setting screen 130, the display of the priority setting screen 130 ends, and the batch expedition screen 290 is displayed on the display 26.

Further, as illustrated in FIG. 24A, a first filter display operation portion 302 for filtering the dispatch destination display portions 291 displayed on the batch expedition screen 290 is displayed on the batch expedition screen 290.

When the first filter display operation portion 302 is tapped by the player, filtering according to the type of dispatch destination can be performed. For example, a filtered display may be performed for each stage to which the dispatch destinations belong. Further, for example, the types of dispatch destinations include a normal dispatch destination which can be always selected by the player and a first special dispatch destination and a second special dispatch destination which can be selected only when a preset appearance condition is satisfied, as described above. For example, for the first special dispatch destination, when a predetermined item set in advance is used, the appearance condition is satisfied and the player can dispatch a party. In addition, for the second special dispatch destination, when the player completes (clears) the expedition game and receives a reward, a lottery is executed. If the lottery is a success, the appearance condition is satisfied and the player can dispatch a party. In addition, only the normal dispatch destinations being displayed after filtering, only the first special dispatch destinations being displayed after filtering, and only the second special dispatch destinations being displayed after filtering may be switchable.

Further, as illustrated in FIG. 24A, a second filter display operation portion 303 for filtering the dispatch destination display portions 291 displayed on the batch expedition screen 290 is displayed on the batch expedition screen 290.

By tapping the second filter display operation portion 303, the player can switch between a filtered display of displaying only the dispatch destinations with the check box 299 checked and a display of all types of dispatch destinations regardless of whether the check box 299 is checked.

In addition, as illustrated in FIG. 24A, a search tab 304 is displayed on the batch expedition screen 290. In the search tab 304, a search operation portion 304a denoted by “Search” and three item selection fields 304b are displayed. When any one of the item selection fields 304b is operated (tapped) by the player, an item selection screen (not illustrated) is displayed on the display 26. On the item selection screen (not illustrated), the player can select up to three desired items (special equipment and normal items).

In addition, for example, in the expedition game, when a campaign is active, only the dispatch destinations corresponding to the active campaign may be displayed via filtering. The campaign may be held over a preset period (for example, 10 days). In addition, a predetermined icon indicating that the dispatch destination is applicable to the campaign may be displayed on the dispatch destination display portion 291 of the dispatch destination applicable to the campaign. Note that the content of the campaign is not particularly limited. For example, the campaign may be a campaign that gives a bonus to the required time reduced when the party exceeds the required power or a campaign that increases the reward given to the player when the expedition game is completed (cleared). For example, in a case where a plurality of types of campaigns are held at the same time, a plurality of icons corresponding to the respective campaigns may be displayed in the dispatch destination display portions 291.

On the item selection screen (not illustrated), the item selected by the player is displayed in the item selection field 304b. When the player operates (taps) the search operation portion 304a in a state where an item is displayed in the item selection field 304b, the dispatch destination display portions 291 corresponding to the dispatch destinations where the item displayed in the item selection field 304b can be obtained are displayed in a list on the batch expedition screen 290.

Further, in the present embodiment, the content being displayed on the batch expedition screen 290 is stored in association with a preset. As illustrated in FIG. 24A, a preset switching operation portion 305 is displayed in an upper portion of the batch expedition screen 290. In the present embodiment, nine presets are prepared in total. When the preset switching operation portion 305 is operated (tapped) by the player, the batch expedition screen 290 with the content stored in association with the operated (tapped) preset is displayed on the display 26. Thus, it is possible to improve player-friendliness.

In addition, as illustrated in FIG. 24A, a cancel operation portion 306 denoted by “Cancel” is displayed on the batch expedition screen 290. When the player operates (taps) the cancel operation portion 306, the display of the batch expedition screen 290 is ended, and the expedition top screen 90 (FIG. 7A) is displayed on the display 26.

In addition, as illustrated in FIGS. 24A and 24B, a batch expedition operation portion 307 denoted by “Batch expedition” is displayed on the batch expedition screen 290. As illustrated in FIG. 24A, in a case where none of the check boxes 299 of the dispatch destination display portions 291 displayed on the batch expedition screen 290 are checked, the batch expedition operation portion 307 is displayed in an inoperable state. Also, when the power of the party formed in the dispatch destination display portion 291 in which a check is input in the check box 299 is less than the required power set for the corresponding dispatch destination, the batch expedition operation portion 307 is displayed in an inoperable state.

On the other hand, when the power of the party formed in the dispatch destination display portion 291 in which a check is input in the check box 299 is equal to or greater than the required power set for the corresponding dispatch destination, the batch expedition operation portion 307 is displayed in an operable state as illustrated in FIG. 24B. Then, when the player operates (taps) the batch expedition operation portion 307 in an operable state, the batch expedition confirmation screen 310 (FIG. 25) is displayed on the display 26.

FIG. 25 is a diagram for describing an example of the batch expedition confirmation screen 310. On the batch expedition confirmation screen 310, when the use of the time reduction function is set on the batch expedition screen 290, the player is notified that the time reduction ticket or jewels will be spent. In addition, the batch expedition confirmation screen 310 notifies the player of various setting content for each dispatch destination for which a check is input in the check box 299 of the batch expedition screen 290. Note that in a case where the use of the time reduction function is not set, the batch expedition screen 290 notifies the player of only various setting content for each dispatch destination for which a check is input in the check box 299 of the batch expedition screen 290, since a time reduction ticket and jewels will not be spent.

In addition, as illustrated in FIG. 25, a cancel operation portion 311 denoted by “Cancel” is displayed on the batch expedition confirmation screen 310. When the cancel operation portion 311 is operated (tapped) by the player, the display of the batch expedition confirmation screen 310 is ended, and the batch expedition screen 290 (FIG. 24B) displayed immediately before the batch expedition confirmation screen 310 is displayed on the display 26.

In addition, as illustrated in FIG. 25, a batch portion 312 denoted by “Batch expedition operation expedition” is displayed on the batch expedition confirmation screen 310. When the batch expedition operation portion 312 is operated (tapped) by the player, the expedition game is started. Then, the expedition start animation screen 200 (FIG. 16B) is displayed on the display 26 for a predetermined amount of time, and the player is notified of the start of the expedition game. The ally characters to be dispatched in the expedition are displayed on the expedition start animation screen 200. Specifically, for example, all of the ally characters in the party or a predetermined number of ally characters from among the ally characters in the party are displayed on the expedition start animation screen 200. For example, in a case where a party is dispatched to each of five dispatch destinations using the batch expedition function, one or more or all of the ally characters belonging to the five parties are displayed on the expedition start animation screen 200. That is, it can be said that the number of predetermined characters displayed on the expedition start animation screen 200 increases as the number of dispatch destinations selected with the batch expedition function increases.

When a predetermined amount of time has elapsed, the display of the expedition start animation screen 200 on the display 26 ends.

Then, in a case where use of the time reduction function is set for the started expedition game, the time reduction animation screen 210 is displayed on the display 26 for a predetermined amount of time. In a case where use of the time reduction function is not set for the started expedition game, the expedition top screen 90 (FIG. 22A) is displayed on the display 26. Also, when a predetermined amount of time has elapsed, the display of the time reduction animation screen 210 on the display 26 ends. Then, the expedition top screen 90 (FIG. 22A) is displayed on the display 26.

In this manner, the player can recognize the dispatch destination at which the item desired by the player can be obtained by simply selecting the desired item and using the search operation portion 304a. For each displayed dispatch destination, by simply forming a party, selecting the number of dispatches, and checking the check box 299, it is possible to collectively start execution of the expedition game of the selected number of dispatches for the one or more checked dispatch destinations. Accordingly, it is possible to facilitate the collection of items and to save players trouble.

Next, the functional configuration of the player terminal 1 and the server 1000 for executing the above-described expedition game will be described. The functional configuration of the player terminal 1 and the server 1000 relating to the battle game will not be described.

### Control Processing in Player Terminal 1 and Server 1000

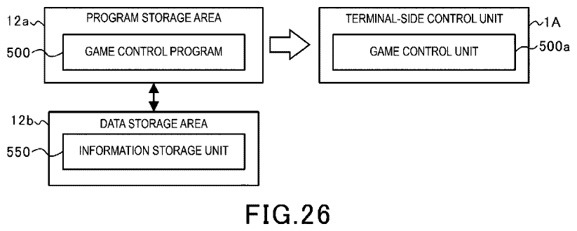

FIG. 26 is a diagram for describing the configuration of the memory 12 in the player terminal 1 and the function thereof as a computer. A game control program 500 is stored in a program storage area 12a. The above-described program stored in the program storage area 12a is merely an example, and many other programs are also provided in the program storage area 12a.

A data storage area 12b is provided with an information storage unit 550 for storing various types of information for the expedition game. The above-described storage unit provided in the data storage area 12b is merely an example, and many other storage units may be provided in the data storage area 12b.

The CPU 10 runs each program stored in the program storage area 12a and updates the data in each storage unit of the data storage area 12b. The CPU 10 causes the player terminal 1 (computer) to function as a terminal-side control unit 1A by operating each program stored in the program storage area 12a. The terminal-side control unit 1A includes a game control unit 500a.

Specifically, the CPU 10 operates the game control program 500 to cause the computer to function as the game control unit 500a.

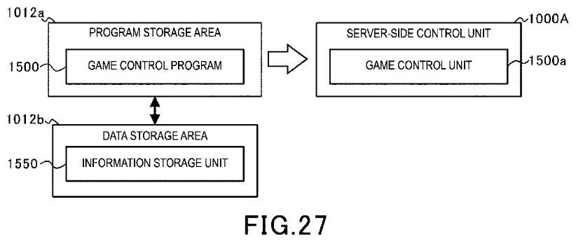

FIG. 27 is a diagram for describing the configuration of the memory 1012 in the server 1000 and the function thereof as a computer. A game control program 1500 is stored in a program storage area 1012a. The above-described program stored in the program storage area 1012a is merely an example, and many other programs are also provided in the program storage area 1012a.

A data storage area 1012b is provided with an information storage unit 1550 for storing various types of information for the expedition game. The above-described storage unit provided in the data storage area 1012b is merely an example, and many other storage units may be provided in the data storage area 1012b.

The CPU 1010 runs each program stored in the program storage area 1012a and updates the data in each storage unit of the data storage area 1012b. The CPU 1010 causes the server 1000 (computer) to function as a server-side control unit 1000A by operating each program stored in the program storage area 1012a. The server-side control unit 1000A includes a game control unit 1500a.

Specifically, the CPU 1010 operates the game control program 1500 to cause the computer to function as the game control unit 1500a. Hereinafter, a part of the processing relating to the expedition game executed by the terminal-side control unit 1A and the server-side control unit 1000A will be described. Note that the processing relating to the battle game executed by the terminal-side control unit 1A and the server-side control unit 1000A will not be described.

Communication Processing between Player Terminal 1 and Server 1000

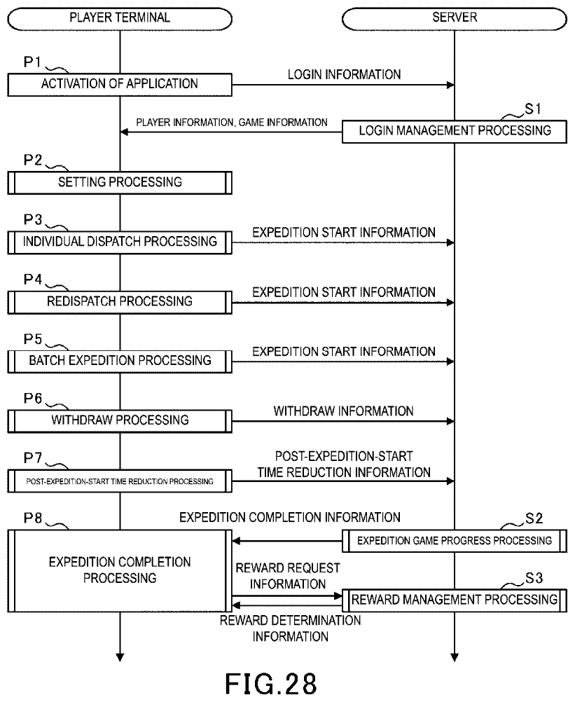

FIG. 28 is a sequence diagram for describing basic processing of the player terminal 1 and the server 1000. In the following description, the processing in the player terminal 1 is denoted by Pn (n is an arbitrary integer). Processing in the server 1000 is denoted by Sn (n is an arbitrary integer).

When the player performs a login operation such as activating a game application in the player terminal 1, the terminal-side control unit 1A transmits login information to the server 1000 (P1).

In the server 1000, when the login information is received, the server-side control unit 1000A executes login management processing of causing the player terminal 1 to receive (obtain) player information and game information stored in the server 1000 (S1).

When the player terminal 1 receives (obtains) the player information from the server 1000, the terminal-side control unit 1A stores the received player information and game information in the information storage unit 550.

In addition, in the player terminal 1, setting processing (P2) of receiving various settings for the expedition game is executed.

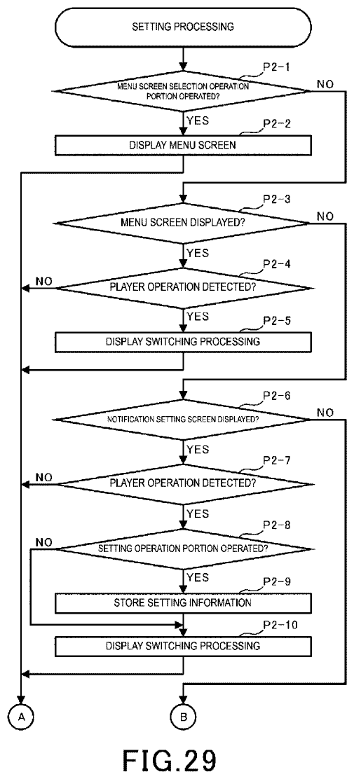

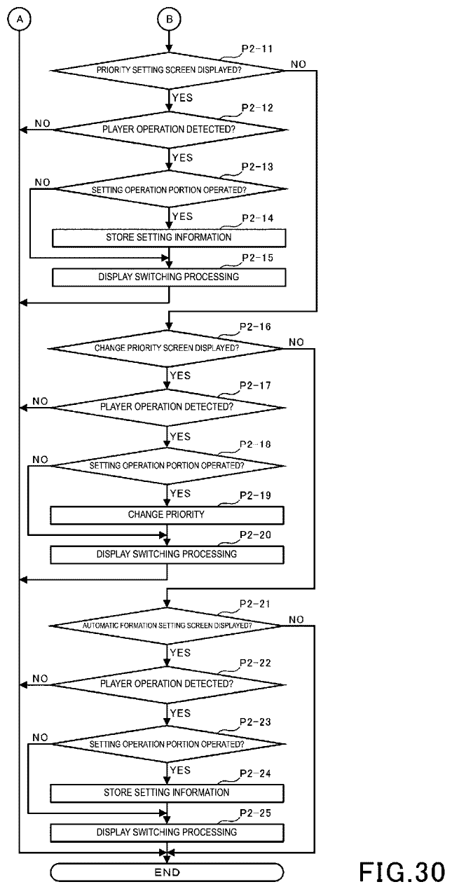

FIG. 29 is a first flowchart for describing the setting processing (P2) in the player terminal 1. FIG. 30 is a second flowchart for describing the setting processing (P2) in the player terminal 1. As illustrated in FIG. 29, the game control unit 500a determines whether the menu screen selection operation portion 92 of the expedition top screen 90 (FIG. 7A) has been operated (tapped) by the player (P2-1).

In a case where the menu screen selection operation portion 92 has been operated (tapped) (YES in P2-1), the game control unit 500a displays the menu screen 110 (FIG. 8A) on the display 26 (P2-2) and ends the setting processing.

In a case where the menu screen selection operation portion 92 has not been operated (tapped) (NO in P2-1), the game control unit 500a determines whether the menu screen 110 is displayed on the display 26 (P2-3).

In a case where the menu screen 110 is displayed on the display 26 (YES in P2-3), the game control unit 500a determines whether a player operation (tap) has been detected (P2-4).

In a case where a player operation (tap) on the menu screen 110 has not been detected (NO in P2-4), the game control unit 500a ends the setting processing.

In a case where a player operation (tap) on the menu screen 110 has been detected (YES in P2-4), the game control unit 500a executes display switching processing (P2-5) of switching the display on the display 26 in accordance with the player operation (tap) and ends the setting processing.

Specifically, when an operation (tap) of the notification setting operation portion 111 of the menu screen 110 is detected, the game control unit 500a displays the notification setting screen 120 (FIG. 8B) on the display 26. In addition, when an operation (tap) of the priority setting operation portion 112 of the menu screen 110 is detected, the game control unit 500a displays the priority setting screen 130 (FIG. 9B) on the display 26. When an operation (tap) of the automatic formation setting operation portion 113 of the menu screen 110 is detected, the game control unit 500a displays the automatic formation setting screen 160 on the display 26. When an operation (tap) of the close operation portion 114 of the menu screen 110 is detected, the game control unit 500a ends the display of the menu screen 110 on the display 26.

In a case where the menu screen 110 is not displayed on the display 26 (NO in P2-3), the game control unit 500a determines whether the notification setting screen 120 is displayed on the display 26 (P2-6).

In a case where the notification setting screen 120 is displayed on the display 26 (YES in P2-6), the game control unit 500a determines whether a player operation (tap) has been detected (P2-7).

In a case where a player operation (tap) on the notification setting screen 120 has not been detected (NO in P2-7), the game control unit 500a ends the setting processing.

In a case where a player operation (tap) on the notification setting screen 120 has been detected (YES in P2-7), the game control unit 500a determines whether the player operation (tap) detected in step P2-7 described above is an operation on the setting operation portion 123 of the notification setting screen 120 (P2-8).

In a case where the operation is not an operation on the setting operation portion 123 of the notification setting screen 120 (NO in P2-8), the game control unit 500a transitions the processing to step P2-10 described below.

In addition, in a case where the operation is an operation on the setting operation portion 123 of the notification setting screen 120 (YES in P2-8), the game control unit 500a stores the execution trigger of the expedition completion notification set by the player in the information storage unit 550 as setting information (P2-9).

In addition, the game control unit 500a executes display switching processing (P2-10) of switching the display of the display 26 in accordance with a player operation (tap) on the notification setting screen 120 and ends the setting processing.

Specifically, when an operation (tap) is performed on the first execution trigger selection portion 121 of the notification setting screen 120, the game control unit 500a performs a highlighted display of the first execution trigger selection portion 121. Also, when an operation (tap) is performed on the second execution trigger selection portion 122 of the notification setting screen 120, the game control unit 500a performs a highlighted display of the second execution trigger selection portion 122. When an operation (tap) is performed on the cancel operation portion 124 of the notification setting screen 120, the game control unit 500a ends the display of the notification setting screen 120.

In a case where the notification setting screen 120 is not displayed on the display 26 (NO in P2-6), the game control unit 500a determines whether the priority setting screen 130 (FIG. 9B) is displayed on the display 26 as illustrated in FIG. 30 (P2-11).

In a case where the priority setting screen 130 is displayed on the display 26 (YES in P2-11), the game control unit 500a determines whether a player operation (tap) has been detected (P2-12).

In a case where a player operation (tap) on the priority setting screen 130 has not been detected (NO in P2-12), the game control unit 500a ends the setting processing.

In a case where a player operation (tap) on the priority setting screen 130 has been detected (YES in P2-12), the game control unit 500a determines whether the player operation (tap) detected in step P2-12 described above is an operation on the setting operation portion 135 of the priority setting screen 130 (P2-13).

In a case where the operation is not an operation on the setting operation portion 135 of the priority setting screen 130 (NO in P2-13), the game control unit 500a transitions the processing to step P2-15 described below.

In addition, in a case where the operation is an operation on the setting operation portion 135 of the priority setting screen 130 (YES in P2-13), the game control unit 500a stores the content of the priority settings set by the player in the information storage unit 550 as setting information (P2-14).

In addition, the game control unit 500a executes display switching processing (P2-15) of switching the display of the display 26 in accordance with a player operation (tap) on the priority setting screen 130 and ends the setting processing.

Specifically, when an operation (tap) is performed on an ally character displayed on the list display portion 131 of the priority setting screen 130, the game control unit 500a highlights the operated (tapped) ally character. The game control unit 500a displays the ally characters in a left-aligned manner in the priority target display portion 132 in the operated (tapped) order. In a case where an operation (tap) on the reset operation portion 133 of the priority setting screen 130 is performed, the game control unit 500a resets the ally character set as the priority target, highlights the ally character in the list display portion 131, and hides the ally character displayed in the priority target display portion 132. In addition, when an operation (tap) on the priority change operation portion 134 of the priority setting screen 130 is performed, the game control unit 500a displays the first change priority screen 140 (FIG. 10A) on the display 26. When the cancel operation portion 136 or the setting operation portion 135 of the priority setting screen 130 is operated (tapped), the game control unit 500a ends the display of the priority setting screen 130.

In a case where the priority setting screen 130 is not displayed on the display 26 (NO in P2-11), the game control unit 500a determines whether the first change priority screen 140 (FIG. 10B) or the second change priority screen 150 (FIG. 10B) is displayed on the display 26 (P2-16).

In a case where the first change priority screen 140 or the second change priority screen 150 is displayed on the display 26 (YES in P2-16), the game control unit 500a determines whether a player operation (tap) has been detected (P2-17).

In a case where a player operation (tap) on the first change priority screen 140 or the second change priority screen 150 has not been detected (NO in P2-17), the game control unit 500a ends the setting processing.

In a case where a player operation (tap) on the first change priority screen 140 or the second change priority screen 150 has been detected (YES in P2-17), the game control unit 500a determines whether the operation (tap) by the player detected in step P2-17 described above is an operation on the setting operation portion 151 of the second change priority screen 150 (P2-18).

In a case where the operation is not an operation on the setting operation portion 151 of the second change priority screen 150 (NO in P2-18), the game control unit 500a transitions the processing to step P2-20 described below.

In a case where the operation is an operation on the setting operation portion 151 of the second change priority screen 150 (YES in P2-18), the game control unit 500a switches the priority of the ally character set as the pre-change ally character with the priority of the ally character set as the post-change ally character (P2-19).

In addition, the game control unit 500a executes display switching processing (P2-20) of switching the display of the display 26 in accordance with a player operation (tap) on the first change priority screen 140 or the second change priority screen 150 and ends the setting processing.

Specifically, when the close operation portion 142 of the first change priority screen 140 is operated (tapped), the game control unit 500a ends the display of the first change priority screen 140. When an operation (tap) is performed on an ally character displayed in the priority target display portion 141 of the first change priority screen 140, the game control unit 500a displays the second change priority screen 150 on the display 26. Further, when displaying the second change priority screen 150, the game control unit 500a highlights the ally character operated (tapped) on the first change priority screen 140. Also, when an operation (tap) is performed on an ally character displayed on the priority target display portion 141 of the second change priority screen 150, the game control unit 500a highlights the operated (tapped) ally character. When the cancel operation portion 152 is operated (tapped), the game control unit 500a ends the display of the second change priority screen 150 and displays the first change priority screen 140 on the display 26.

In a case where the first change priority screen 140 or the second change priority screen 150 is not displayed on the display 26 (NO in P2-16), the game control unit 500a determines whether the automatic formation setting screen 160 is displayed on the display 26 (P2-21).

In a case where the automatic formation setting screen 160 is displayed on the display 26 (YES in P2-21), the game control unit 500a determines whether a player operation (tap) has been detected (P2-22).

In a case where a player operation (tap) on the automatic formation setting screen 160 has not been detected (NO in P2-22), the game control unit 500a ends the setting processing.

In a case where a player operation (tap) on the automatic formation setting screen 160 has been detected (YES in P2-22), the game control unit 500a determines whether the operation (tap) by the player detected in step P2-22 described above is an operation on the setting operation portion 163 of the automatic formation setting screen 160 (P2-23).

In a case where the operation is not an operation on the setting operation portion 163 of the automatic formation setting screen 160 (NO in P2-23), the game control unit 500a transitions the processing to step P2-25 described below.

When the operation is an operation on the setting operation portion 163 of the automatic formation setting screen 160 (YES in P2-23), the game control unit 500a stores setting information indicating which of the first automatic formation function and the second automatic formation function is set as the automatic formation function by the player in the information storage unit 550 (P2-24).

In addition, the game control unit 500a executes display switching processing (P2-25) of switching the display of the display 26 in accordance with a player operation (tap) on the automatic formation setting screen 160 and ends the setting processing.

Specifically, when an operation (tap) is performed on the first automatic formation function selection portion 161 of the automatic formation setting screen 160, the game control unit 500a performs a highlighted display of the first automatic formation function selection portion 161. Also, when an operation (tap) is performed on the second automatic formation function selection portion 162 of the automatic formation setting screen 160, the game control unit 500a performs a highlighted display of the second automatic formation function selection portion 162. When an operation (tap) is performed on the setting operation portion 163 of the automatic formation setting screen 160, the game control unit 500a ends the display of the automatic formation setting screen 160.

Returning to FIG. 28, in the player terminal 1, individual dispatch processing (P3) is executed in which the player selects a desired dispatch destination on the dispatch destination selection screen 100 (FIG. 7B), dispatches a party to the dispatch destination, and starts execution of an expedition game.

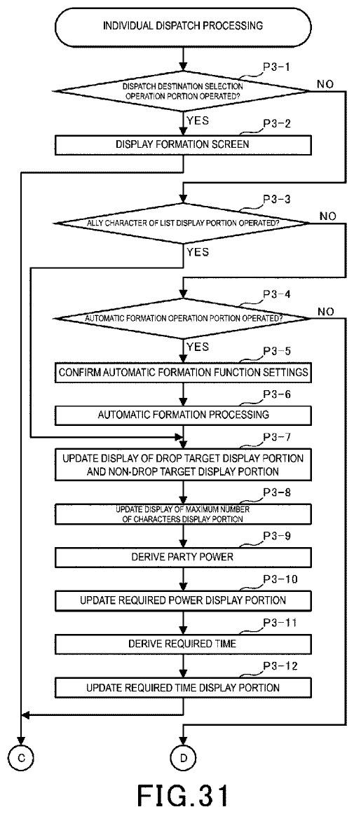

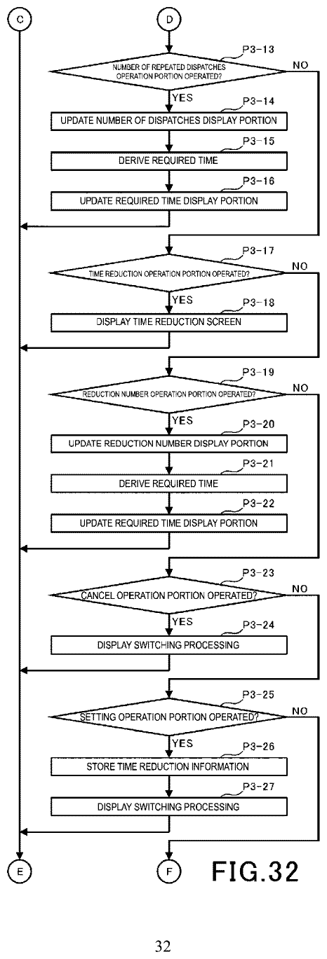

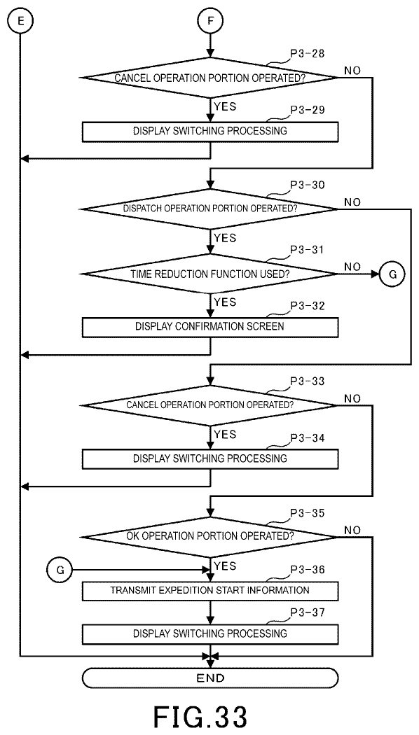

FIG. 31 is a first flowchart for describing the individual dispatch processing (P3) in the player terminal 1. FIG. 32 is a second flowchart for describing the individual dispatch processing (P3) in the player terminal 1. FIG. 33 is a third flowchart for describing the individual dispatch processing (P3) in the player terminal 1. As illustrated in FIG. 31, the game control unit 500a determines whether any of the dispatch destination selection operation portions 101 on the dispatch destination selection screen 100 (FIG. 7B) have been operated (tapped) (P3-1).

In a case where any one of the dispatch destination selection operation portions 101 on the dispatch destination selection screen 100 has been operated (tapped) (YES in P3-1), the game control unit 500a displays the formation screen 170 corresponding to the operated (tapped) dispatch destination selection operation portion 101 on the and ends the individual display 26 (P3-2) dispatch processing.

In a case where the dispatch destination selection operation portion 101 has not been operated (tapped) (NO in P3-1), the game control unit 500a determines whether an ally character displayed in the list display portion 171 of the formation screen 170 has been operated (tapped), that is, whether the player has manually formed a party (P3-3).

In a case where the ally character displayed in the list display portion 171 of the formation screen 170 has been operated (tapped) (YES in P3-3), the game control unit 500a transitions the processing to step P3-7 described below.

In a case where the ally character displayed in the list display portion 171 of the formation screen 170 has not been operated (tapped) (NO in P3-3), the game control unit 500a determines whether the automatic formation operation portion 174 of the formation screen 170 has been operated (tapped) (P3-4).

In a case where the automatic formation operation portion 174 of the formation screen 170 has been operated (tapped) (YES in P3-4), the game control unit 500a checks the setting information relating to the automatic formation function stored in the information storage unit 550 (P3-5).

Further, the game control unit 500a executes automatic formation processing of automatically forming a party by using the automatic formation function (the first automatic formation function or the second automatic formation function) of the type set by the player based on the setting information relating to the automatic formation function confirmed in step P3-5 described above (P3-6).

Specifically, the game control unit 500a first forms a party prioritizing three ally characters with high priority excluding unavailable characters, when the first automatic formation function is used. In a case where the total power of the three ally characters is equal to or greater the required power, the game control unit 500a ends the party formation. On the other hand, in a case where the total power of the three ally characters is less than the required power, the game control unit 500a further puts an ally character not set as a priority target into the party. Specifically, from among the ally characters that are not set as priority targets and that are available, the ally characters having a high power are put into the party in order until the power of the party satisfies the required power.

Also, when the second automatic formation function is used, the game control unit 500a forms a party prioritizing three ally characters with high priority excluding unavailable characters. Further, the game control unit 500a, from among the ally characters that are not set as priority targets and that are available, puts ally characters having a high power into the party until the maximum number of characters that can fit in the party is reached.

In addition, in a case where an ally character has not been set as a priority target, when the first automatic formation function is used, the game control unit 500a sequentially puts the ally characters having greater power from among the available ally characters into the party until the power of the party satisfies the required power.

In addition, in a case where an ally character has not been set as a priority target, when the second automatic formation function is used, the game control unit 500a puts ally characters, from among the available ally characters, into the party until the maximum number of characters that can be put into the party is reached.

In addition, the game control unit 500a updates the display of the drop target display portion 172a and the non-drop target display portion 172b on the formation screen 170 in accordance with the party formation manually formed by the player or the party formation automatically formed using the automatic formation function (P3-7).

Further, the game control unit 500a updates the display of the maximum number of characters display portion 173c of the formation screen 170 based on the displayed content of the drop target display portion 172a and the non-drop target display portion 172b of the formation screen 170 updated in step P3-7 described above (P3-8).

Further, the game control unit 500a derives the power of the formed party based on the displayed content of the drop target display portion 172a and the non-drop target display portion 172b of the formation screen 170 updated in step P3-7 described above (P3-9).

Further, the game control unit 500a updates the display of the required power display portion 173a based on the power of the party derived in step P3-9 described above (P3-10).

Further, the game control unit 500a derives the reduced required time based on the power of the party derived in step P3-9 described above (P3-11). Here, the higher the power of the formed party, the larger the value of the reduction in the required time.

Further, the game control unit 500a updates the display of the required time display portion 173b in accordance with the reduced required time derived in step P3-11 described above (P3-12) and ends the individual dispatch processing.

In a case where the automatic formation operation portion 174 of the formation screen 170 has not been operated (tapped) (NO in P3-4), as illustrated in FIG. 32, the game control unit 500a determines whether the increase number of repeated dispatches operation portion 175a or the decrease number of repeated dispatches operation portion 175b of the formation screen 170 has been operated (tapped) (P3-13).

In a case where the increase number of repeated dispatches operation portion 175a or the decrease number of repeated dispatches operation portion 175b of the formation screen 170 has been operated (tapped) (YES in P3-13), the game control unit 500a updates the display of the number of repeated dispatches display portion 175 according to the operated (tapped) increase number of repeated dispatches operation portion 175a or the decrease number of repeated dispatches operation portion 175b (P3-14).

Specifically, in a case where the increase number of repeated dispatches operation portion 175a has been operated (tapped), the game control unit 500a increases the number of dispatches displayed on the number of repeated dispatches display portion 175 by one. In a case where the decrease number of repeated dispatches operation portion 175b has been operated (tapped), the game control unit 500a decreases the number of dispatches displayed on the number of repeated dispatches display portion 175 by one.

Further, the game control unit 500a derives the required time based on the number of dispatches displayed on the number of repeated dispatches display portion 175 updated in step P3-14 described above (P3-15). Here, for example, in the case where the required time required for one dispatch is 1 hour and 30 minutes and the number of dispatches is set to 4, the game control unit 500a derives a required time of 6 hours.

Further, the game control unit 500a updates the display of the required time display portion 173b based on the required time derived in step P3-15 described above (P3-16) and ends the individual dispatch processing.

In a case where the increase number of repeated dispatches operation portion 175a or the decrease number of repeated dispatches operation portion 175b of the formation screen 170 has not been operated (tapped) (NO in P3-13), the game control unit 500a determines whether the time reduction operation portion 176 of the formation screen 170 has been operated (tapped) (P3-17).

In a case where the time reduction operation portion 176 of the formation screen 170 has been operated (tapped) (YES in P3-17), the game control unit 500a displays the time reduction screen 180 on the display 26 (P3-18) and ends the individual dispatch processing.

In a case where the time reduction operation portion 176 of the time reduction screen 180 has not been operated (tapped) (NO in P3-17), the game control unit 500a determines whether the increase reduction number operation portion 181a, the decrease reduction number operation portion 181b, the increase reduction number operation portion 182a, or the decrease reduction number operation portion 182b of the time reduction screen 180 has been operated (tapped) (P3-19).

In a case where the increase reduction number operation portion 181a, the decrease reduction number operation portion 181b, the increase reduction number operation portion 182a, or the decrease reduction number operation portion 182b of the time reduction screen 180 has been operated (tapped) (YES in P3-19), the game control unit 500a updates the display of the reduction number display portion 181 or the reduction number display portion 182 according to the operated (tapped) operation portion (P3-20).

Specifically, in a case where the increase reduction number operation portion 181a or the increase reduction number operation portion 182a has been operated (tapped), the game control unit 500a increases the reduction number displayed on the reduction number display portion 181 or the reduction number display portion 182 by one.

Also, in a case where the decrease reduction number operation portion 181b or the decrease reduction number operation portion 182b has been operated (tapped), the game control unit 500a decreases the reduction number displayed on the reduction number display portion 181 or the reduction number display portion 182 by one.

Further, the game control unit 500a derives the required time based on the reduction number displayed on the reduction number display portion 181 or the reduction number display portion 182 updated in step P3-20 described above (P3-21). The game control unit 500a derives the required time so that the required time is reduced by one hour per one reduction number. For example, in a case where the required time is 6 hours and the total of the reduction times displayed in the reduction number display portion 181 or the reduction number display portion 182 is 4, the game control unit 500a reduces the required time by 4 hours and derives a required time of 2 hours.

Further, the game control unit 500a updates the display of the required time display portion 183 based on the required time derived in step P3-21 described above (P3-22) and ends the individual dispatch processing.

In addition, in a case where the increase 181a, the decrease reduction number operation portion reduction number operation portion 181b, the increase reduction number operation portion 182a, or the decrease reduction number operation portion 182b of the time reduction screen 180 has not been operated (tapped) (NO in P3-19), the game control unit 500a determines whether the cancel operation portion 185 of the time reduction screen 180 has been operated (tapped) (P3-23).

In a case where the cancel operation portion 185 of the time reduction screen 180 has been operated (tapped) (YES in P3-17), the game control unit 500a executes display switching processing of ending the display of the time reduction screen 180 on the display 26 (P3-24) and ends the individual dispatch processing.

In addition, in a case where the cancel operation portion 185 of the time reduction screen 180 has not been operated (tapped) (NO in P3-17), the game control unit 500a determines whether the setting operation portion 184 of the time reduction screen 180 has been operated (tapped) (P3-25).

In a case where the setting operation portion 184 of the time reduction screen 180 is operated (tapped) (YES in P3-25), the game control unit 500a stores the content displayed on the time reduction screen 180 in the information storage unit 550 as time reduction information relating to the time reduction function (P3-26). For example, the time reduction information includes the number of spent time reduction tickets and the number of times the predetermined number of jewels have been spent.

Further, the game control unit 500a ends the display of the time reduction screen 180, executes display switching processing of displaying the formation screen 170 (FIG. 15C) on the display 26 (P3-27), and ends the individual dispatch processing. At this time, the pre-reduction required time (for example, 6 hours), the post-reduction required time (for example, 2 hours), and the amount of time reduced from the pre-reduction required time (for example, −4 hours) are displayed by the game control unit 500a according to the content of the time reduction function set as described above on the required time display portion 173b of the formation screen 170.

In addition, in a case where the setting operation portion 184 of the time reduction screen 180 has not been operated (tapped) (NO in P3-25), as illustrated in FIG. 33, the game control unit 500a determines whether the cancel operation portion 178 of the formation screen 170 has been operated (tapped) (P3-28).

In a case where the cancel operation portion 178 of the formation screen 170 has been operated (tapped) (YES in P3-28), the game control unit 500a executes display switching processing of ending the display of the formation screen 170 on the display 26 (P3-29) and ends the individual dispatch processing.

In addition, in a case where the cancel operation portion 178 of the formation screen 170 has not been operated (tapped) (NO in P3-28), the game control unit 500a determines whether the dispatch operation portion 177 of the formation screen 170 has been operated (tapped) (P3-30).

When the dispatch operation portion 177 of the formation screen 170 is operated (tapped) (YES in P3-30), the game control unit 500a determines whether the time reduction function has been used, that is, whether time reduction information relating to the time reduction function was stored in step P3-26 described above (P3-31).

In a case where the time reduction function has been used (YES in P3-31), the game control unit 500a displays the confirmation screen 190 of the display 26 (P3-32) and ends the individual dispatch processing.

In a case where the time reduction function has not been used (NO in P3-31), the game control unit 500a transitions the processing to step P3-36 described below.

In addition, in a case where the dispatch operation portion 177 of the formation screen 170 has not been operated (tapped) (NO in P3-30), the game control unit 500a determines whether the cancel operation portion 192 of the confirmation screen 190 has been operated (tapped) (P3-33).

In a case where the cancel operation portion 192 of the confirmation screen 190 has been operated (tapped) (YES in P3-33), the game control unit 500a executes display switching processing of ending the display of the confirmation screen 190 on the display 26 (P3-34) and ends the individual dispatch processing.

In addition, in a case where the cancel operation portion 192 of the confirmation screen 190 has not been operated (tapped) (NO in P3-33), the game control unit 500a determines whether the OK operation portion 191 of the confirmation screen 190 has been operated (tapped) (P3-35).

In a case where the OK operation portion 191 of the confirmation screen 190 has been operated (tapped) (YES in P3-35), the game control unit 500a transitions the processing to step P3-36 described below.

Also, in a case where the OK operation portion 191 of the confirmation screen 190 has not been operated (tapped) (NO in P3-35), the game control unit 500a ends the individual dispatch processing.

The game control unit 500a transmits the expedition start information to the server 1000 (P3-36). The expedition start information includes, for example, dispatch destination information relating to dispatch destinations, repetition number information relating to the number of repetitions, party formation information relating to the type of ally characters in the party, whether the time reduction function has been used, time reduction information when the use of the time reduction function is set, and the like.

Further, the game control unit 500a executes display switching processing of switching the display of the display 26 (P3-37) and ends the individual dispatch processing. Specifically, the game control unit 500a displays the expedition start animation screen 200 (FIG. 16B) on the display 26 for a predetermined amount of time. In a case where use of the time reduction function is set, after the display of the expedition start animation screen 200 is ended, the time reduction animation screen 210 (FIG. 16C) is displayed on the display 26 for a predetermined amount of time. Thereafter, the game control unit 500a displays the dispatch destination selection screen 100 (FIG. 17A) on the display 26.

Returning to FIG. 28, in the player terminal 1, on the redispatch screen 260 (FIG. 21) or the redispatch screen 280 (FIG. 23), redispatch processing (P4) for redispatching a party of the same formation to the same dispatch destination is executed for the completed (cleared) expedition game.

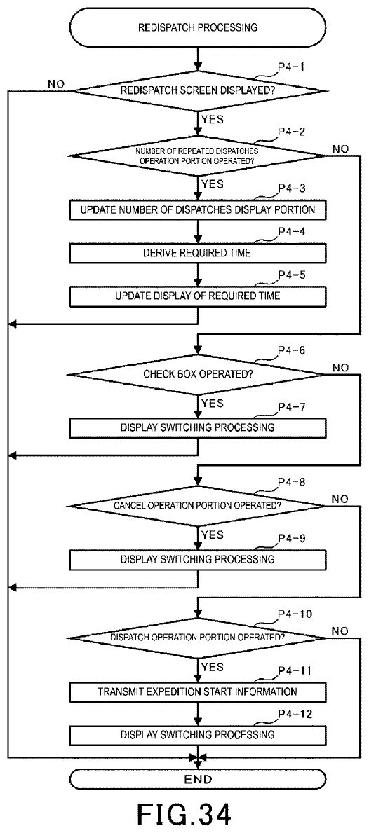

FIG. 34 is a flowchart for describing the redispatch processing (P4) in the player terminal 1. As illustrated in FIG. 34, the game control unit 500a determines whether the redispatch screen 260 or the redispatch screen 280 is displayed on the display 26 (P4-1).

In a case where the redispatch screen 260 or the redispatch screen 280 is not displayed on the display 26 (NO in P4-1), the game control unit 500a ends the redispatch processing.

In a case where the redispatch screen 260 or the redispatch screen 280 is displayed on the display 26 (YES in P4-1), the game control unit 500a determines whether the increase number of repeated dispatches operation portion 264a or the decrease number of repeated dispatches operation portion 264b of the redispatch screen 260 or the increase number of repeated dispatches operation portion 284a or the decrease number of repeated dispatches operation portion 284b of the redispatch screen 280 has been operated (tapped) (P4-2).

In a case where the increase number of repeated dispatches operation portion 264a or the decrease number of repeated dispatches operation portion 264b of the redispatch screen 260 or the increase number of repeated dispatches operation portion 284a or the decrease number of repeated dispatches operation portion 284b of the redispatch screen 280 has been operated (tapped) (YES in P4-2), the game control unit 500a updates the display of the number of repeated dispatches display portion 264 of the redispatch screen 260 or the number of repeated dispatches display portion 284 of the redispatch screen 280 according to the operated (tapped) operation portion (P4-3).

Further, the game control unit 500a derives the required time based on the number of dispatches displayed on the number of repeated dispatches display portion 264 of the redispatch screen 260 or the number of repeated dispatches display portion 284 of the redispatch screen 280 updated in step P4-3 described above (P4-4).

Further, the game control unit 500a updates the display of the required time in the dispatch destination display portion 261 of the redispatch screen 260 or the dispatch destination display portion 281 of the redispatch screen 280 based on the required time derived in step P4-4 described above (P4-5) and ends the redispatch processing.

In a case where the increase number of repeated dispatches operation portion 264a or the decrease number of repeated dispatches operation portion 264b of the redispatch screen 260 or the increase number of repeated dispatches operation portion 284a or the decrease number of repeated dispatches operation portion 284b of the redispatch screen 280 has not been operated (tapped) (NO in P4-2), the game control unit 500a determines whether the check box 283 of the redispatch screen 280 has been operated (tapped) (P4-6).

In a case where the check box 283 of the redispatch screen 280 has been operated (tapped) (YES in P4-6), the game control unit 500a executes display switching processing of switching the display of a check mark on or off in the operated (tapped) check box 283 (P4-7) and ends the redispatch processing.

In addition, the game control unit 500a determines whether the cancel operation portion 265 of the redispatch screen 260 or the cancel operation portion 285 of the redispatch screen 280 has been operated (tapped) (P4-8).

In a case where the cancel operation portion 265 of the redispatch screen 260 or the cancel operation portion 285 of the redispatch screen 280 has been operated (tapped) (YES in P4-8), the game control unit 500a executes display switching processing of ending the display of the redispatch screen 260 or the redispatch screen 280 on the display 26 (P4-9) and ends the redispatch processing.

In addition, the game control unit 500a determines whether the dispatch operation portion 266 of the redispatch screen 260 or the dispatch operation portion 286 of the redispatch screen 280 has been tapped (P4-10).

In a case where the dispatch operation portion 266 or the dispatch operation portion 286 has been tapped (YES in P4-10), the game control unit 500a transmits the expedition start information to the server 1000 (P4-11).

Further, the game control unit 500a executes display switching processing of switching the display of the display 26 (P4-12) and ends the redispatch processing. In the display switching processing, specifically, the game control unit 500a displays the expedition start animation screen 200 (FIG. 16B) on the display 26 for a predetermined amount of time.

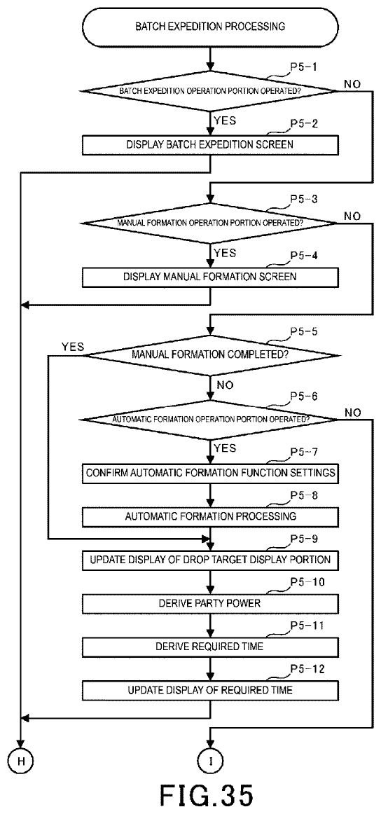

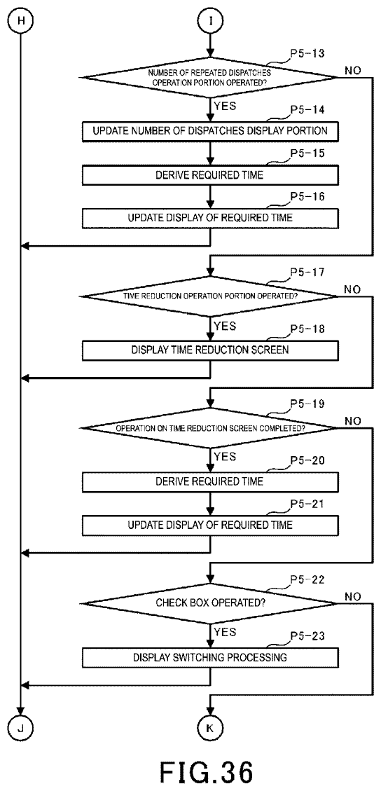

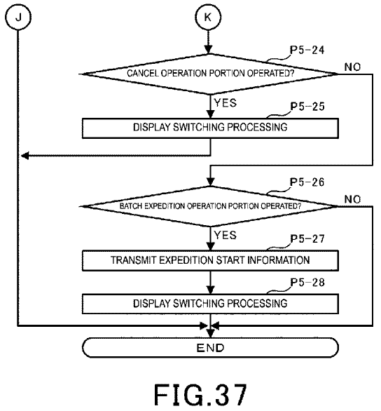

Returning to FIG. 28, in the player terminal 1, batch expedition processing (P5) for using the batch expedition function is executed. FIG. 35 is a first flowchart for describing the batch expedition processing (P5) in the player terminal 1. FIG. 36 is a second flowchart for describing the batch expedition processing (P5) in the player terminal 1. FIG. 37 is a third flowchart for describing the batch expedition processing (P5) in the player terminal 1. As illustrated in FIG. 35, the game control unit 500a determines whether the batch expedition selection operation portion 93 of the expedition top screen 90 (FIG. 7A) has been operated (tapped) (P5-1).

In a case where the batch expedition selection operation portion 93 has been operated (tapped) (YES in P5-1), the game control unit 500a displays the batch expedition screen 290 (FIG. 24A) on the display 26 and ends the batch expedition processing.

In addition, in a case where the batch expedition selection operation portion 93 has not been operated (tapped) (NO in P5-1), the game control unit 500a determines whether the manual formation operation portion 292 of the batch expedition screen 290 has been operated (P5-3).

In a case where the manual formation operation portion 292 of the batch expedition screen 290 has been operated (tapped) (YES in P5-3), the game control unit 500a displays a manual formation screen (not illustrated) on the display 26 (P5-4) and ends the batch expedition processing.

In addition, in a case where the manual formation operation portion 292 of the batch expedition screen 290 has not been operated (NO in P5-3), the game control unit 500a determines whether a complete operation on the manual formation screen (not illustrated) described above has been performed (P5-5).

In a case where a complete operation on the manual formation screen (not illustrated) described above has been performed (YES in P5-5), the game control unit 500a transitions the processing to step P5-9 described below.

In addition, in a case where a complete operation on the manual formation screen (not illustrated) described above has not been performed (NO in P5-5), the game control unit 500a determines whether the automatic formation operation portion 293 of the batch expedition screen 290 has been operated (tapped) (P5-6).

In a case where the automatic formation operation portion 293 of the batch expedition screen 290 has been operated (tapped) (YES in P5-6), the game control unit 500a checks the setting information relating to the automatic formation function stored in the information storage unit 550 (P5-7).

Further, the game control unit 500a executes automatic formation processing of automatically forming a party by using the automatic formation function (the first automatic formation function or the second automatic formation function) of the type set by the player based on the setting information relating to the automatic formation function confirmed in step P5-7 described above (P5-8).

In addition, the game control unit 500a updates the display of the special drop item target display portion 294 of the batch expedition screen 290 in accordance with the party formation manually formed by the player or the party formation automatically formed using the automatic formation function (P5-9).

In addition, the game control unit 500a derives the power of the formed party based on the party formation manually formed by the player or the party formation automatically formed using the automatic formation function (P5-10).

Further, the game control unit 500a derives the reduced required time based on the power of the party derived in step P5-10 described above (P5-11). Here, the higher the power of the formed party, the larger the value of the reduction in the required time.

Further, the game control unit 500a updates the display of the required time displayed on the dispatch destination display portion 291 of the batch expedition screen 290 in accordance with the reduced required time derived in step P5-11 described above (P5-12) and ends the batch expedition processing.

In a case where the automatic formation operation portion 293 of the batch expedition screen 290 has not been operated (tapped) (NO in P5-6), as illustrated in FIG. 36, the game control unit 500a determines whether the increase number of repeated dispatches operation portion 295a or the decrease number of repeated dispatches operation portion 295b of the batch expedition screen 290 has been operated (tapped) (P5-13).

In a case where the increase number of repeated dispatches operation portion 295a or the decrease number of repeated dispatches operation portion 295b of the batch expedition screen 290 has been operated (tapped) (YES in P5-13), the game control unit 500a updates the number of repeated dispatches display portion 295 according to the operated (tapped) increase number of repeated dispatches operation portion 295a or the decrease number of repeated dispatches operation portion 295b of the batch expedition screen 290 (P5-14).

Further, the game control unit 500a derives the required time based on the number of dispatches displayed on the number of repeated dispatches display portion 295 updated in step P5-14 described above (P5-15).

Further, the game control unit 500a updates the display of the required time of the dispatch destination display portion 291 of the batch expedition screen 290 based on the required time derived in step P5-15 described above (P5-16) and ends the batch expedition processing.

In a case where the increase number of repeated dispatches operation portion 295a or the decrease number of repeated dispatches operation portion 295b of the batch expedition screen 290 has not been operated (tapped) (NO in P5-13), the game control unit 500a determines whether the time reduction operation portion 296 of the batch expedition screen 290 has been operated (tapped) (P5-17).

In a case where the time reduction operation portion 296 has been operated (tapped) (YES in P5-17), the game control unit 500a displays a time reduction screen (not illustrated) for the batch expedition (P5-18) on the display 26 and ends the batch expedition processing.

The game control unit 500a determines whether a complete operation on the time reduction screen (not illustrated) for the batch expedition described above has been performed (P5-19).

In a case where a complete operation on the time reduction screen (not illustrated) for the batch expedition has been performed (YES in P5-19), the game control unit 500a derives the required time based on the use of the set time reduction function (P5-20).

The game control unit 500a derives the required time so that the required time is reduced by one hour per one reduction number. For example, in a case where the required time is 6 hours and the total of the reduction times displayed in the reduction number display portion 181 or the reduction number display portion 182 is 4, the game control unit 500a reduces the required time by 4 hours and derives a required time of 2 hours.

Further, the game control unit 500a updates the display of the required time of the dispatch destination display portion 291 of the batch expedition screen 290 based on the required time derived in step P5-20 described above (P5-21) and ends the batch expedition processing.

In addition, in a case where a complete operation on the time reduction screen (not illustrated) the for batch expedition described above has not been performed (NO in P5-19), the game control unit 500a determines whether check box 299 of the batch expedition screen 290 has been operated (tapped) (P5-22).

In a case where the check box 299 of the batch expedition screen 290 has been operated (tapped) (YES in P5-22), the game control unit 500a executes display switching processing of switching the display of the check mark on or off in the operated (tapped) check box 299 of the batch expedition screen 290 (P5-23) and ends the batch expedition processing.

In addition, in a case where the check box 299 of the batch expedition screen 290 has not been operated (tapped) (NO in P5-22), as illustrated in FIG. 37, the game control unit 500a determines whether the cancel operation portion 306 of the batch expedition screen 290 has been operated (tapped) (P5-24).

In a case where the cancel operation portion 306 of the batch expedition screen 290 has been operated (tapped) (YES in P5-24), the game control unit 500a executes display switching processing of ending the display of the batch expedition screen 290 on the display 26 (P5-25) and ends the batch expedition processing.

In addition, in a case where the cancel operation portion 306 of the batch expedition screen 290 has not been operated (tapped) (NO in P5-24), the game control unit 500a determines whether the batch expedition operation portion 307 of the batch expedition screen 290 has been operated (tapped) (P5-26).

In a case where the batch expedition operation portion 307 of the batch expedition screen 290 has been tapped (YES in P5-26), the game control unit 500a transmits the expedition start information to the server 1000 (P5-27). The expedition start information includes, for example, dispatch destination information relating to each dispatch destination, repetition number information relating to the number of repetitions for each dispatch destination, party formation information relating to the type of ally characters in the party for each dispatch destination, whether the time reduction function has been used relating to each dispatch destination, time reduction information when the use of the time reduction function is set for each dispatch destination, and the like.

Further, the game control unit 500a executes display switching processing of switching the display of the display 26 (P5-28) and ends the batch expedition processing. In the display switching processing, specifically, the game control unit 500a displays the expedition start animation screen 200 (FIG. 16B) on the display 26 for a predetermined amount of time. In a case where use of the time reduction function is set, after the display of the expedition start animation screen 200 is ended, the time reduction animation screen 210 (FIG. 16C) is displayed on the display 26 for a predetermined amount of time. Thereafter, the game control unit 500a displays the expedition top screen 90 (FIG. 7A) on the display 26.

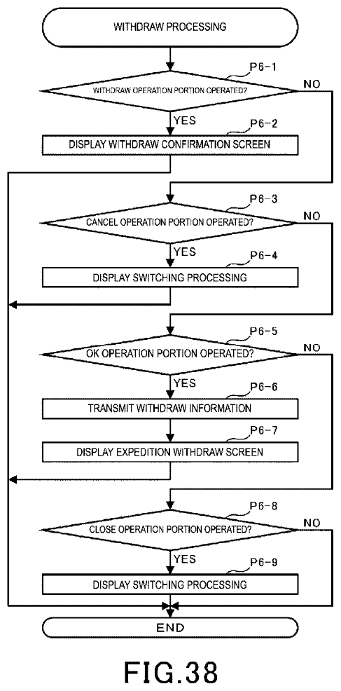

Returning to FIG. 28, in the player terminal 1, withdraw processing (P6) for using the withdraw function is executed. FIG. 38 is a flowchart for describing the withdraw processing (P6) in the player terminal 1. As illustrated in FIG. 38, the game control unit 500a determines whether the withdraw operation portion 105 of the dispatch destination selection screen 100 (FIG. 17A) has been operated (tapped) (P6-1).

In a case where the withdraw operation portion 105 of the dispatch destination selection screen 100 has been operated (tapped) (YES in P6-1), the game control unit 500a displays the withdraw confirmation screen 230 on the display 26 (P6-2) and ends the withdraw processing.

In addition, in a case where the withdraw operation portion 105 of the dispatch destination selection screen 100 has not been operated (tapped) (NO in P6-1), the game control unit 500a determines whether the cancel operation portion 231 of the withdraw confirmation screen 230 has been operated (tapped) (P6-3).

In a case where the cancel operation portion 231 of the withdraw confirmation screen 230 has been operated (tapped) (YES in P6-3), the game control unit 500a executes display switching processing of ending the display of the withdraw confirmation screen 230 on the display 26 (P6-4) and ends the withdraw processing.

In addition, in a case where the cancel operation portion 231 of the withdraw confirmation screen 230 has not been operated (tapped) (NO in P6-3), the game control unit 500a determines whether the OK operation portion 232 of the withdraw confirmation screen 230 has been operated (tapped) (P6-5).

In a case where the OK operation portion 232 of the withdraw confirmation screen 230 has been tapped (YES in P6-5), the game control unit 500a transmits the withdraw information to the server 1000 (P6-7). The withdraw information includes, for example, dispatch destination information relating to the dispatch destination to be withdrawn from.

In addition, the game control unit 500a displays the expedition withdraw screen 240 on the display 26 (P6-7) and ends the withdraw processing.

In addition, in a case where the OK operation portion 232 of the withdraw confirmation screen 230 has not been operated (tapped) (NO in P6-5), the game control unit 500a determines whether the close operation portion 241 of the expedition withdraw screen 240 has been operated (tapped) (P6-8).

In a case where the close operation portion 241 of the expedition withdraw screen 240 has been operated (tapped) (YES in P6-8), the game control unit 500a executes display switching processing of ending the display of the expedition withdraw screen 240 (P6-9) and ends the withdraw processing.

Also, in a case where the close operation portion 241 of the expedition withdraw screen 240 has not been operated (tapped) (NO in P6-8), the game control unit 500a ends the withdraw processing.

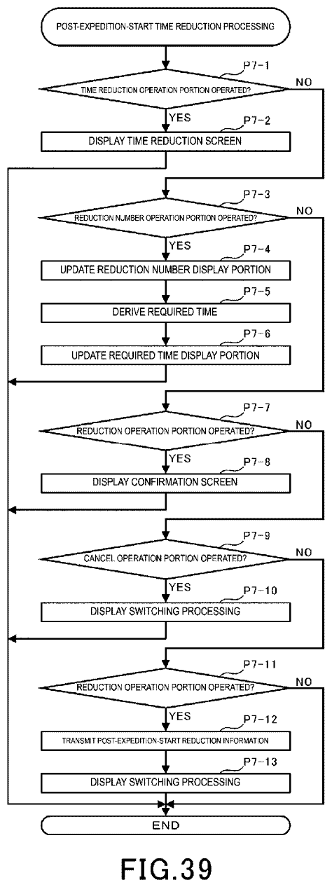

Returning to FIG. 28, in the player terminal 1, after the start of the execution of the expedition game, post-expedition-start time reduction processing (P7) for using the time reduction function is executed. FIG. 39 is a flowchart for describing the post-expedition-start time reduction processing (P7) in the player terminal 1. As illustrated in FIG. 39, the game control unit 500a determines whether the time reduction operation portion 104 of the dispatch destination selection screen 100 (FIG. 17A) has been operated (tapped) (P7-1).

In a case where the time reduction operation portion 104 of the dispatch destination selection screen 100 has been operated (tapped) (YES in P7-1), the game control unit 500a displays the time reduction screen 180 (FIG. 17B) on the display 26 (P7-2) and ends the post-expedition-start time reduction processing.

In a case where the time reduction operation portion 104 of the dispatch destination selection screen 100 has not been operated (tapped) (NO in P7-1), the game control unit 500a determines whether the increase reduction number operation portion 181a, the decrease reduction number operation portion 181b, the increase reduction number operation portion 182a, or the decrease reduction number operation portion 182b of the time reduction screen 180 (FIG. 17B) has been operated (tapped) (P7-3).

In a case where the increase reduction number operation portion 181a, the decrease reduction number operation portion 181b, the increase reduction number operation portion 182a, or the decrease reduction number operation portion 182b of the time reduction screen 180 (FIG. 17B) has been operated (tapped) (YES in P7-3), the game control unit 500a updates the display of the reduction number display portion 181 or the reduction number display portion 182 according to the operated (tapped) increase reduction number operation portion 181a, decrease reduction number operation portion 181b, increase reduction number operation portion 182a, or decrease reduction number operation portion 182b of the time reduction screen 180 (FIG. 17B) (P7-4).

Further, the game control unit 500a derives the required time based on the reduction number displayed on the reduction number display portion 181 or the reduction number display portion 182 of the time reduction screen 180 (FIG. 17B) updated in step P7-4 described above (P7-5).

Further, the game control unit 500a updates the display of the required time display portion 183 of the time reduction screen 180 (FIG. 17B) based on the required time derived in step P7-5 described above (P7-6) and ends the post-expedition-start time reduction processing.

In addition, in a case where the increase reduction number operation portion 181a, the decrease reduction number operation portion 181b, the increase reduction number operation portion 182a, or the decrease reduction number operation portion 182b of the time reduction screen 180 (FIG. 17B) has not been operated (tapped) (NO in P7-3), the game control unit 500a determines whether the reduction operation portion 184a of the time reduction screen 180 (FIG. 17B) has been operated (tapped) (P7-7).

In a case where the reduction operation portion 184a of the time reduction screen 180 (FIG. 17B) has been operated (tapped) (YES in P7-7), the game control unit 500a displays the confirmation screen 220 on the display 26 (P7-8) and ends the post-expedition-start time reduction processing.

In addition, in a case where the reduction operation portion 184a of the time reduction screen 180 (FIG. 17B) has not been operated (tapped) (NO in P7-7), the game control unit 500a determines whether the cancel operation portion 185 of the time reduction screen 180 (FIG. 17B) or the cancel operation portion 222 of the confirmation screen 220 (FIG. 18A) has been operated (tapped) (P7-9).

In a case where the cancel operation portion 185 of the time reduction screen 180 (FIG. 17B) or the cancel operation portion 222 of the confirmation screen 220 (FIG. 18A) has been operated (tapped) (YES in P7-9), the game control unit 500a executes display switching processing of ending the display of the time reduction screen 180 or the confirmation screen 220 (P7-10) and ends the post-expedition-start time reduction processing.

In addition, in a case where the cancel operation portion 185 of the time reduction screen 180 (FIG. 17B) or the cancel operation portion 222 of the confirmation screen 220 (FIG. 18A) has not been operated (tapped) (NO in P7-9), the game control unit 500a determines whether the reduction operation portion 221 of the confirmation screen 220 (FIG. 18A) has been operated (tapped) (P7-11).

In a case where the reduction operation portion 221 of the confirmation screen 220 (FIG. 18A) has been tapped (YES in P7-11), the game control unit 500a transmits the post-expedition-start time reduction information to the server 1000 (P7-12). For example, the post-expedition-start time reduction information includes, for example, the dispatch destination information relating to the dispatch destination, the time reduction information including the number of spent time reduction tickets and the number of times the predetermined number of jewels have been spent, and the like.

Further, the game control unit 500a executes display switching processing of ending the display of the confirmation screen 220 on the display 26 (P7-13) and ends the post-expedition-start time reduction processing.

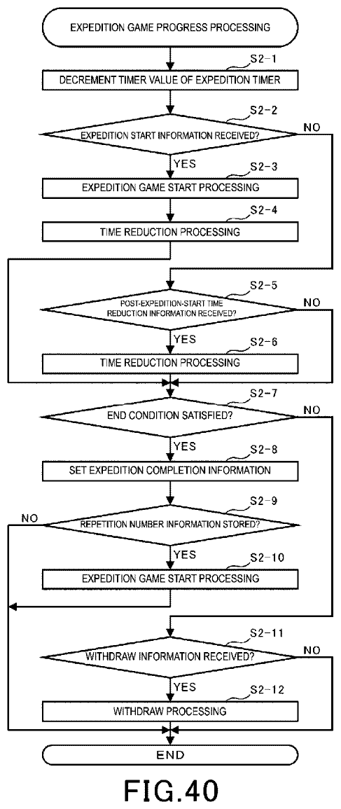

Returning to FIG. 28, in the server 1000, expedition game progress processing (S2) of managing the progress of the expedition game is executed. FIG. 40 is a flowchart for describing the expedition game progress processing (S2) in the server 1000. As illustrated in FIG. 40, the game control unit 1500a of the server 1000 subtracts the timer value of an expedition timer that measures an amount of time until the expedition game being executed is completed (cleared) (S2-1).

Further, the game control unit 1500a of the server 1000 determines whether the expedition start information has been received from the player terminal 1 (S2-2).

In a case where the expedition start information has been received (YES in S2-2), the game control unit 1500a of the server 1000 executes expedition game start processing of starting the progress of the expedition game based on the received expedition start information (S2-3).

Specifically, for example, the game control unit 1500a of the server 1000 derives the required time corresponding to the dispatch destination for each dispatch destination designated by the expedition start information and sets the expedition timer to the required time. That is, the required time corresponding to the dispatch destination is derived based on the power of the party set for the dispatch destination and the required power set for the dispatch destination. In a case where a plurality of dispatch destinations are designated by the expedition start information, the game control unit 1500a of the server 1000 sets an expedition timer for each of the designated plurality of dispatch destinations. In addition, in a case where a plurality of repetition numbers are designated for the dispatch destination by the repetition number information included in the expedition start information, the game control unit 1500a of the server 1000 stores the repetition number information in the information storage unit 1550 of the server 1000 in association with the dispatch destination. Note that the game control unit 1500a of the server 1000 subtracts the repetition number set in the repetition number information every time the expedition game relating to the dispatch destination ends.

Further, the game control unit 1500a of the server 1000 executes the time reduction processing (S2-4) and transitions the processing to step S2-7 described below. Specifically, in a case where the use of the time reduction function is designated for the dispatch destination for which progress of the expedition game has started in step S2-3 described above, the game control unit 1500a of the server 1000 reduces the timer value of the expedition timer corresponding to the dispatch destination based on the time reduction information included in the expedition start information. In a case where a time reduction ticket is used, processing of spending the number of time reduction tickets to be used is executed.

Further, in a case where expedition start information has not been received (NO in S2-2), the game control unit 1500a of the server 1000 determines whether the post-expedition-start time reduction information has been received from the player terminal 1 (S2-5).

Further, in a case where post-expedition-start time reduction information has not been received from the player terminal 1 (YES in S2-5), the game control unit 1500a of the server 1000 executes the time reduction processing (S2-6). Specifically, the game control unit 1500a of the server 1000 reduces the timer value of the expedition timer corresponding to the dispatch destination designated based on the dispatch destination information included in the received post-expedition-start time reduction information based on the time reduction information included in the post-expedition-start time reduction information.

In addition, the game control unit 1500a of the server 1000 determines whether there is an expedition game in which a predetermined end condition set in advance is satisfied (S2-7). Specifically, the game control unit 1500a of the server 1000 determines whether there is an expedition timer with a timer value of 0 as a result of the subtraction in step S2-1 described above or as a result of the time reduction processing in step S2-4 described above or step S2-6 described above.

In a case where there is an expedition game in which predetermined end condition set in advance is satisfied (YES in S2-7), the game control unit 1500a of the server 1000 sets expedition completion information corresponding to the expedition game with the satisfied end condition so that the player terminal 1 can obtain the information (S2-8). The expedition completion information includes dispatch destination information relating to the dispatch destination of the expedition game completed (cleared) when the end condition is satisfied, final expedition information indicating whether the expedition game is the final expedition game of the designated number of repetitions in a case where a plurality of repetition numbers are designated for the dispatch destination, party formation information relating to the type of ally character in the party dispatched to the dispatch destination, and the like.

Further, the game control unit 1500a of the server 1000 determines whether the repetition number information is stored for the dispatch destination with the end condition satisfied in step S2-7 described above (S2-9).

In step S2-7 described above, in a case where the repetition number information is stored for the dispatch destination with the end condition satisfied (YES in S2-9), the game control unit 1500a of the server 1000 executes the expedition game start processing of starting the progress of the expedition game for the dispatch destination (S2-10) and ends the expedition game progress processing. At this time, as described above, the game control unit 1500a of the server 1000 subtracts the repetition number set in the repetition number information in conjunction with the start of the progress of the expedition game relating to the dispatch destination.

Also, in step S2-7 described above, in a case where the repetition number information is not stored for the dispatch destination with the end condition satisfied (NO in S2-9), the game control unit 1500a of the server 1000 ends the expedition game progress processing.

In addition, in a case where there is no expedition game with a predetermined end condition set in advance satisfied (NO in S2-7), the game control unit 1500a of the server 1000 determines whether the withdraw information has been received from the player terminal 1 (S2-11).

In a case where the withdraw information has been received from the player terminal 1 (YES in S2-11), the game control unit 1500a of the server 1000 executes the withdraw processing of canceling the expedition game that is being executed and ends the expedition game progress processing. Specifically, the game control unit 1500a of the server 1000 discards the expedition timer corresponding to the dispatch destination designated by the dispatch destination information included in the withdraw information. Accordingly, the expedition game being executed is canceled.

Also, in a case where the withdraw information has not been received from the player terminal 1 (NO in S2-11), the game control unit 1500a of the server 1000 ends the expedition game progress processing.

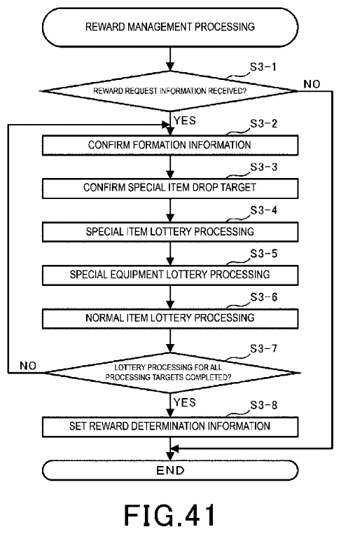

Returning to FIG. 28, the server 1000 executes reward management processing (S3) for determining the content of the reward to be given to the player for completing (clearing) the expedition game. FIG. 41 is a flowchart for describing the reward management processing (S3) in the server 1000. As illustrated in FIG. 41, the game control unit 1500a of the server 1000 determines whether reward request information has been received from the player terminal 1 (S3-1).

In a case where the reward request information has been received from the player terminal 1 (YES in S3-1), the game control unit 1500a of the server 1000 checks the formation information included in the reward request information (S3-2).

The game control unit 1500a of the server 1000 checks the ally character set as the special item drop target based on the formation information checked in step S3-2 described above (S3-3).

The game control unit 1500a of the server 1000 executes special item lottery processing (S3-4). Specifically, the game control unit 1500a of the server 1000 determines through a lottery whether to give a special item corresponding to each of the ally characters set as the special item drop target confirmed in step S3-3 described above based on a predetermined lottery table set in advance.

The game control unit 1500a of the server 1000 executes special equipment lottery processing (S3-5). Specifically, the game control unit 1500a of the server 1000 determines through a lottery whether to give special equipment based on a predetermined lottery table set in advance.

The game control unit 1500a of the server 1000 executes normal item lottery processing (S3-6). Specifically, the game control unit 1500a of the server 1000 determines through a lottery whether to give a normal item based on a predetermined lottery table set in advance.

The game control unit 1500a of the server 1000 determines whether the processing from step S3-2 described above to step S3-6 described above has been completed for all the dispatch destinations (processing targets) designated by the dispatch destination information included in the received reward request information (S3-7).

In a case where the processing has not been completed for all the processing targets (NO in S3-7), the game control unit 1500a of the server 1000 executes the processing from step S3-2 described above to step S3-6 described above for the processing targets for which the processing has not been completed.

In a case where the processing of all the processing targets has been completed (YES in S3-7), the game control unit 1500a of the server 1000 sets reward determination information including at least the execution results of the lottery processing in step described above S3-4 to step S3-6 described above to be obtainable by the player terminal 1 (S3-8) and ends the reward management processing.

Returning to FIG. 28, in the player terminal 1, expedition completion processing (P8) for obtaining a reward for the completed (cleared) expedition game is executed in response to the required time having elapsed. In expedition completion processing (P8), execution of the expedition completion notification is managed.

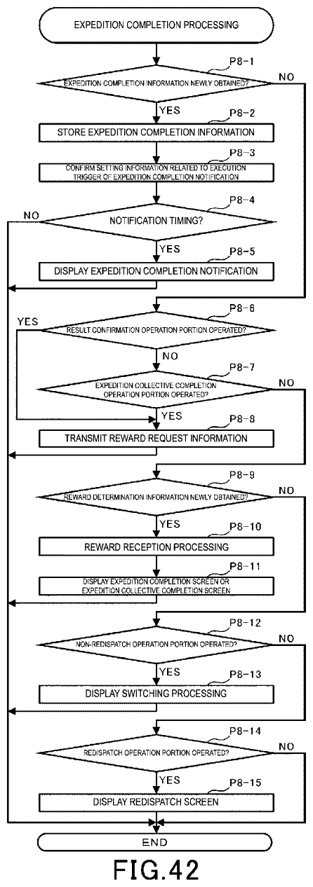

FIG. 42 is a flowchart for describing the expedition completion processing (P8) in the player terminal 1. As illustrated in FIG. 42, the game control unit 500a determines whether the expedition completion information set in the server 1000 has been newly obtained (P8-1).

In a case where the expedition completion information set in the server 1000 has been newly obtained (YES in P8-1), the game control unit 500a stores the obtained expedition completion information in the information storage unit 550 (P8-2).

In addition, the game control unit 500a checks the setting information relating to the execution trigger of the expedition completion notification stored in the information storage unit 550 (P8-3).

The game control unit 500a determines whether the execution trigger is the notification timing of the expedition game corresponding to the expedition completion information stored in step P8-2 described above based on the setting information relating to the execution trigger of the expedition completion notification confirmed in step P8-3 described above (P8-4).

Specifically, in a case where the first execution trigger is set as the execution trigger of the expedition completion notification, the game control unit 500a determines that the execution trigger is the notification timing of the expedition game.

In addition, in a case where the second execution trigger is set as the execution trigger of the expedition completion notification and the expedition completion information includes final expedition information indicating that the expedition game is the final expedition game of the designated repetition number, the game control unit 500a determines that the execution trigger is the notification timing of the expedition game.

In a case where it is determined that the execution trigger is the notification timing (YES in P8-4), the game control unit 500a displays the message M (FIG. 9A) on the upper portion of the display 26 as the expedition completion notification (P8-5) and ends the expedition completion processing. As described above, the screen where the message M is displayed is not limited to the home screen 40, and the game control unit 500a may display the message M on the upper portion of the display 26 while the game application is running regardless of the type of the screen being displayed.

In addition, in a case where the expedition completion information set in the server 1000 is not newly obtained (NO in P8-1), the game control unit 500a determines whether the result confirmation operation portion 107 of the dispatch destination selection screen 100 (FIG. 20A) has been operated (tapped) (P8-6).

In a case where the result confirmation operation portion 107 of the dispatch destination selection screen 100 (FIG. 20A) has been operated (tapped) (YES in P8-6), the game control unit 500a transitions the processing to step P8-8 described below.

In a case where the result confirmation operation portion 107 on the dispatch destination selection screen 100 (FIG. 20A) is not operated (tapped) (NO in P8-6), the game control unit 500a determines whether the expedition collective completion operation portion 94 of the expedition top screen 90 (FIG. 22A) has been operated (tapped) (P8-7).

In a case where the expedition collective completion operation portion 94 of the expedition top screen 90 (FIG. 22A) has been operated (tapped) (YES in P8-7), the game control unit 500a transitions the processing to step P8-8 described below.

The game control unit 500a transmits the reward request information to the server 1000 (P8-8) and ends the expedition completion processing. In a case where the result confirmation operation portion 107 has been operated, the reward request information includes dispatch destination information relating to a dispatch destination corresponding to the result confirmation operation portion 107, formation information set for the dispatch destination, and the like. In addition, in a case where the expedition collective completion operation portion 94 has been operated, the reward request information includes dispatch destination information regarding each dispatch destination for which reception of a reward is not completed, formation information set for each dispatch destination, and the like.

In a case where the expedition collective completion operation portion 94 of the expedition top screen 90 (FIG. 22A) has not been operated (tapped) (NO in P8-7), the game control unit 500a determines whether the reward determination information set in the server 1000 has been newly obtained (P8-9).

In a case where the reward determination information set in the server 1000 has been newly obtained (YES in P8-9), the game control unit 500a stores the obtained reward determination information in the information storage unit 550 and executes reward reception processing of obtaining a reward (P8-10).

In addition, the game control unit 500a displays the expedition completion screen 250 (FIG. 20B) or the expedition collective completion screen 270 (FIG. 22B) on the display 26 (P8-11) and ends the expedition completion processing. Specifically, the game control unit 500a displays a list of the rewards obtained in step P8-10 described above on the expedition completion screen 250 or the expedition collective completion screen 270.

In addition, the game control unit 500a determines whether the non-redispatch operation portion 251 of the expedition completion screen 250 or the non-redispatch operation portion 271 of the expedition collective completion screen 270 has been operated (tapped) (P8-12).

In a case where the non-redispatch operation portion 251 of the expedition completion screen 250 or the non-redispatch operation portion 271 of the expedition collective completion screen 270 has been operated (tapped) (YES in P8-12), the game control unit 500a executes display switching processing of hiding the expedition completion screen 250 or the non-redispatch operation portion 251 (P8-13) and ends the expedition completion processing.

In a case where the non-redispatch operation portion 251 of the expedition completion screen 250 or the non-redispatch operation portion 271 of the expedition collective completion screen 270 has not been operated (tapped) (NO in P8-12), the game control unit 500a determines whether the redispatch operation portion 252 of the expedition completion screen 250 or the redispatch operation portion 272 of the expedition collective completion screen 270 has been operated (tapped) (P8-14).

In a case where the redispatch operation portion 252 of the expedition completion screen 250 or the redispatch operation portion 272 of the expedition collective completion screen 270 has been operated (tapped) (YES in P8-14), the game control unit 500a displays the redispatch screen 260 (FIG. 21) or the redispatch screen 280 (FIG. 23) on the display 26 based on the dispatch destination information included in the expedition completion information and ends the expedition completion processing.

In a case where the redispatch operation portion 252 of the expedition completion screen 250 or the redispatch operation portion 272 of the expedition collective completion screen 270 has not been operated (tapped) (NO in P8-14), the game control unit 500a ends the expedition completion processing.

Here, one aspect of an embodiment has been described with reference to the accompanying drawings. However, it goes without saying that the present invention is not limited to the above-described embodiment. It should be apparent that one skilled in the art can arrive at various modified examples or modified examples within the scope described in the claims, and it should be understood that the modified examples or modified examples also naturally belong in the technical scope of the present invention.

The game properties and the processing in the player terminal 1 and the server 1000 described in the above embodiment are merely examples. In any case, the information processing program causes a computer (in the embodiment, the player terminal 1 and/or the server 1000) to execute the following processing.

### Processing Executed by Computer

Processing (in the embodiment, as an example, steps P3, P4, and P5) of setting, as the number of executions, the number of times selected by the player from among a predetermined number of times that is one time or two times or more for specific content (in the embodiment, as an example, an expedition game) in which the game progresses with the passage of time without requiring a player operation and activation of the game for game progress.

Processing (in the embodiment, as an example, S2) of progressing specific content (in the embodiment, as an example, an expedition game) based on the set number of executions.

Processing (in the embodiment, as an example, P2) of setting an execution trigger of a notification (in the embodiment, as an example, the message M) indicating that the progress of the specific content (in the embodiment, as an example, the expedition game) has ended based on a player operation.

Processing (in the embodiment, as an example, P8) of executing a notification (in the embodiment, as an example, the message M) based on the set execution trigger.

In the processing of setting the notification execution trigger (in the embodiment, as an example, P2), a case where the progress of the specific content (in the embodiment, as an example, the expedition game) for the set number of executions has all ended can be set as the execution trigger (in the embodiment, as an example, the second execution trigger).

In the processing (in the embodiment, as an example, P8) of executing the notification (in the embodiment, as an example, the message M), in a case where the set number of executions is 1, the notification is executed based on the progress of one piece of specific content (in the embodiment, as an example, the expedition game) having ended, and in a case where the set number of executions is 2 or more, the notification is executed based on the progress of two or more pieces of specific content (in the embodiment, as an example, the expedition game) having ended.

In the processing (in the embodiment, as an example, P8) of executing the notification (in the embodiment, as an example, the message M), in a case where the set number of executions is 2 or more and the progress of less than the number of executions of the specific content (in the embodiment, as an example, the expedition game) has ended, the notification is not executed.

Processing (in the embodiment, as an example, steps P3, P4, and P5) of setting formation information (in the embodiment, as an example, the formation of a party) based on a player operation relating to specific content (in the embodiment, as an example, the expedition game) that includes one or more game media (in the embodiment, as an example, an ally character), requires setting of formation information (in the embodiment, as an example, a party formation) with a predetermined parameter (in the embodiment, as an example, power), calculated based on the one or more game media, that satisfies a minimum condition (in the embodiment, as an example, party power minimum condition), and increases in degree of advantage the more the predetermined parameter (in the embodiment, as an example, power) exceeds the minimum condition (in the embodiment, as an example, party power minimum condition).

Processing (in the embodiment, as an example, S2) of progressing specific content (in the embodiment, as an example, an expedition game) based on the set formation information.

Processing (in the embodiment, as an example, steps P3, P4, and P5) of generating formation information based on the automatic formation function selected by the player from among the first automatic formation function that prioritizes satisfying the minimum condition (in the embodiment, as an example, the party power minimum condition) by a minimum amount and the second automatic formation function that prioritizes satisfying the minimum condition (in the embodiment, as an example, the party power minimum condition) and increasing degree of advantage (the party power exceeding the required power to reduce the required time at the dispatch destination), the first automatic formation function and the second automatic formation function automatically generating formation information (in the embodiment, as an example, the party formation).

In the processing (in the embodiment, as an example, S2) of progressing the specific content (in the embodiment, as an example, the expedition game), the specific content (in the embodiment, as an example, the expedition game) is progressed without requiring a player operation or activation of the game for game progress.

Processing (in the embodiment, as an example, steps P3, P4, and P5) of allowing the progress of the specific content (in the embodiment, as an example, the expedition game) in a case where the set formation information (in the embodiment, as an example, the party formation) satisfies the minimum condition (in the embodiment, as an example, the party power minimum condition) and processing of not allowing the progress of the specific content (in the embodiment, as an example, the expedition game) when the set formation information (in the embodiment, as an example, the party formation) does not satisfy the minimum condition (in the embodiment, as an example, the party power minimum condition).

In the processing (in the embodiment, as an example, S2) of progressing the specific content (in the embodiment, as an example, the expedition game), the amount of time until the progress of the specific content (in the embodiment, as an example, the expedition game) ends is reduced in accordance with the degree of the predetermined parameter (in the embodiment, as an example, the power) exceeding the minimum condition (in the embodiment, as an example, the party power minimum condition).

In the above-described embodiment, the degree of advantage for the player is increased by the required time being reduced as the power of the party dispatched to the dispatch destination increases, but the present invention is not limited thereto. For example, when the power of the party dispatched to the dispatch destination exceeds the required power, the reward obtained by the player may be increased. Also, for example, the reward obtained by the player may be increased in accordance with a degree of the power of the party dispatched to the dispatch destination exceeding the required power. In addition, both a reduction of the required time and an increase of the reward may be implemented in accordance with the power of the party. Alternatively, either a reduction of the required time or an increase of the reward may be implemented in accordance with the power of the party.

Also, an upper limit may be placed on the number of parties that can be dispatched to a dispatch destination at the same time. For example, in a case where the total number of the number of parties corresponding to an expedition game for which reception of a reward has not been completed and the number of parties corresponding to an expedition game that is being executed reaches a preset upper limit number, a new party may be made unable to be dispatched. In this case, by using the withdraw function or completing the reception of the reward, a new party is made able to be dispatched.

In addition, in the embodiment described above, the required time for the expedition game can be reduced by spending time reduction tickets, but the time reduction tickets may be able to be used for the battle game. For example, in the main quest selection screen 74 (FIG. 5B), the player is allowed to set whether to use the time reduction tickets and the number of tickets to be used. In this case, when one time reduction ticket is used, execution of one battle game is omitted (skipped). Specifically, on the main quest selection screen 74 (FIG. 5B), when use of a time reduction ticket is set, the display of the party selection screen 77 (FIG. 5C), the battle game screen 80 (FIG. 6A), and the first result screen 83 (FIG. 6B) may be omitted (reduced), and the second result screen 85 (FIG. 6C) may be displayed on the display 26.

Note that the game application may use, for example, a notification mechanism (for example, Notification API) provided by the operating system (OS) of the smartphone to perform a push notification and display the message M stating “Expedition completed” on a notification screen of the smartphone.

Specifically, similar to setting the execution trigger of the expedition completion notification in the embodiment described above, the execution trigger of the push notification can be set at the discretion of the player. That is, the player can freely set, as the execution trigger of the push notification, either an execution trigger of an expedition completion notification of one expedition game being completed (first execution trigger) regardless of the designated number of dispatches or an execution trigger of an expedition completion notification of all of the expedition games of the designated number of dispatches being completed (second execution trigger).

In the embodiment described above, as an example of a game, a case has been described in which an expedition game is provided in which a party of ally characters is dispatched to a dispatch destination desired by a player. However, specific content of the game and the game genre are not limited to the embodiment described above. For example, the present invention can be applied to any game genre such as a role-playing game, a shooting game, a puzzle game, and a rhythm game.

For example, in a case where the game is applied to a role-playing game, the expedition game described above may correspond to a predetermined quest provided in the role-playing game in which a battle game with a predetermined enemy character is executed. In this case, a minimum condition (a minimum power of the party) is provided to accept a predetermined quest, and the degree of advantage for the player in the predetermined quest is increased the more the power of the player's party exceeds the minimum power. Specific methods for increasing the degree of advantage may include the ally characters being powered up, the enemy character being weakened, the reward when the quest is cleared being increased, and the like.

An information processing program for executing the processing in the above-described embodiment and various modified examples may be stored in a non-transitory computer-readable storage medium and provided as a storage medium. Furthermore, a game terminal apparatus including the storage medium may be provided. In addition, the above-described embodiment and various modified examples may correspond to an information processing method for implementing each function and the steps illustrated in the flowcharts.

What is claimed is:

1. A non-transitory computer readable medium storing a program causing a computer to execute:
processing of setting, based on a player operation, formation information relating to specific content that includes one or more game media, requires setting of the formation information including a predetermined parameter that is calculated based on the one or more game media and that satisfies a minimum condition, and increases in degree of advantage the more the predetermined parameter exceeds the minimum condition;
processing of progressing the specific content based on the set formation information; and
processing of generating the formation information based on an automatic formation function selected by a player from among a first automatic formation function that prioritizes satisfying the minimum condition by a minimum amount and a second automatic formation function that prioritizes satisfying the minimum condition and increasing the degree of advantage, the first automatic formation function and the second automatic formation function automatically generating the formation information.

2. The non-transitory computer readable medium according to claim 1, wherein in the processing of progressing the specific content, the specific content is progressed without requiring a player operation and activation of a game for game progress.

3. The non-transitory computer readable medium according to claim 1, wherein the program further causes the computer to execute processing of allowing progress of the specific content in a case where the set formation information satisfies the minimum condition and processing of not allowing progress of the specific content in a case where the set formation information does not satisfy the minimum condition.

4. The non-transitory computer readable medium according to claim 1, wherein in the processing of progressing the specific content, an amount of time until progress of the specific content ends is reduced in accordance with a degree of the predetermined parameter exceeding the minimum condition.

5. An information processing method executed by one or more computers, the one or more computers executing:
processing of setting, based on a player operation, formation information relating to specific content that includes one or more game media, requires setting of the formation information including a predetermined parameter that is calculated based on the one or more game media and that satisfies a minimum condition, and increases in degree of advantage the more the predetermined parameter exceeds the minimum condition;
processing of progressing the specific content based on the set formation information; and
processing of generating the formation information based on an automatic formation function selected by a player from among a first automatic formation function that prioritizes satisfying the minimum condition by a minimum amount and second automatic formation function that prioritizes satisfying the minimum condition and increasing the degree of advantage, the first automatic formation function and the second automatic formation function automatically generating the formation information.

6. An information processing system comprising:
one or more computers, wherein
the one or more computers execute:
processing of setting, based on a player operation, formation information relating to specific content that includes one or more game media, requires setting of the formation information including a predetermined parameter that is calculated based on the one or more game media and that satisfies a minimum condition, and increases in degree of advantage the more the predetermined parameter exceeds the minimum condition;
processing of progressing the specific content based on the set formation information; and
processing of generating the formation information based on an automatic formation function selected by a player from among a first automatic formation function that prioritizes satisfying the minimum condition by a minimum amount and a second automatic formation function that prioritizes satisfying the minimum condition and increasing the degree of advantage, the first automatic formation function and the second automatic formation function automatically generating the formation information.
